(19) United States
(12) Patent Application Publication
(10) Pub. No.: US 2026/0250165 A1
(43) Pub. Date: Aug. 27, 2026

(54) SOLID FORMULATIONS FOR NEUTRALIZING ACIDIC TAILINGS PONDS AND METHODS OF NEUTRALIZING ACIDIC TAILINGS PONDS

(71) Applicant: Mohsen Barkh, Vancouver (CA)

(72) Inventor: Mohsen Barkh, Vancouver (CA)

(21) Appl. No.: 19/159,292

(22) PCT Filed: Oct. 13, 2023
(86) PCT No.: PCT/CA2023/051364

§ 371 Date: Aug. 22, 2025

Related U.S. Application Data
(60) Provisional application No. 63/449,213, filed on Mar. 1, 2023.

(51) Int. Cl. C02F 1/66; C02F 1/52; C02F 101/10; C02F 101/20; C02F 103/10

(52) U.S. Cl. CPC C02F 1/66; C02F 1/52; C02F 2101/103; C02F 2101/20; C02F 2101/203; C02F 2103/10

(57) ABSTRACT

Described herein are solid formulations for neutralizing acidic tailings ponds and methods of neutralizing acidic tailings ponds. The formulations comprise at least 55 wt % magnesium oxide (MgO) and at least 0.5 wt % chitosan salt. The formulations may further comprise a carbonate salt. The methods comprise the steps of (i) providing a solid formulation comprising at least 55 wt % magnesium oxide and at least 0.5 wt % of a chitosan salt, (ii) mixing the solid formulation with a predetermined volume of water to form a suspension; (iii) adding the suspension to the tailings pond; and (iv) allowing neutralization to occur in the tailings pond. The solid formulations may be used in combination with other neutralization reagents, concurrently or consecutively, e.g. in a multi-stage neutralization process.

### FIELD OF INVENTION

The present invention relates to neutralization of tailings ponds. In particular, the present invention relates to solid formulations for neutralizing acidic tailings ponds and methods of neutralizing acidic tailings ponds.

### BACKGROUND OF THE INVENTION

Tailings, the waste material left over from ore extraction processes, are often mixed with water to create a slurry making them easier to transport. One method of storing the slurry is in tailings ponds, which may or may not also include the use of a tailings dam. Tailings ponds can be used for long term storage, as a place to allow the different components of the tailings to settle out of suspension, or for temporary holding until the tailings can be further processed. The composition of the tailings will determine which way the pond is used. Different types of mines produce different types of tailings. For example, the tailings produced by a nickel mine will be quite different from the tailings produced by an oil sands mine.

Neutralizing and discharging water from the low-pH tailings pond is a common practice in poly-metals mines and other mines which use acid leaching as part of the mining process. In those mines, the pH of the tailings pond could be pH 1 or lower. The acidic environment in the tailings pond can maintain high concentrations of heavy metals as dissolved ions in the solution. Since the minimum dischargeable pH is above 6.5, tailings pond neutralization requires a high volume of the neutralization reagent which has to be mixed properly with the acidic water to complete the neutralization reaction. Also, due to changes in the pH of the water, a significant portion of the dissolved metals in the tailings pond water converts to insoluble metal hydroxides and the insoluble hydroxides start forming sludge as soon as the treated water stops moving.

Typically, the steps in tailings pond neutralization treatment include (a) transferring the tailings pond water and neutralization reagent to a reaction vessel, (b) completing the neutralization reaction with sufficient mixing, (c) separating and discharging the treated water, and (d) managing the generated solid wastes (see FIG. 1).

Transferring low-pH water from the tailings pond to the treatment facility, transporting hazardous reagents to the mine site and handling the neutralization reagent on site are some of the common risks in the first step of the treatment process. Building and operating treatment facilities including large clarifiers and reactor tanks are significant financial risks in the second stage of the treatment process. Sludge handling creates both operational and financial risks in the third stage of the treatment process.

Thus, there remains a need for neutralization treatments of acidic tailings ponds that can be performed onsite and using lower-risk reagents.

### SUMMARY OF THE INVENTION

The present invention relates to formulations and methods for neutralizing tailings ponds. In particular, the present invention provides solid formulations for neutralizing acidic tailings pond water and methods of neutralizing acidic tailings ponds.

The presently claimed solid formulations are non-hazardous, environmentally friendly and can be used in situ in a method for neutralizing tailings ponds. In various embodiments, the formulations may be used in situ in a semi-passive method for neutralizing tailings ponds. Thus, the present invention avoids the need to transport the tailings pond water to an external reaction vessel. The presently claimed solid formulations may also be used in combination with other neutralizing reagents, concurrently or consecutively such as in a multi-stage process. This and other advantages of the invention are described herein.

According to an aspect of the invention, there is provided a solid formulation for neutralization of an acidic tailings pond, the formulation comprising at least 55 wt % magnesium oxide (MgO) and at least 0.5 wt % chitosan salt.

The chitosan salt may comprise chitosan lactate and/or chitosan acetate. In some embodiments, the chitosan salt is chitosan acetate. Without wishing to be bound by theory, the chitosan acetate may form nanoparticles with the magnesium oxide, thereby creating additional surface area for the neutralization reaction to occur.

In some embodiments, the formulation comprises between about 55 wt % to about 99.5 wt % of MgO and between about 0.5 wt % and about 3 wt % chitosan salt, wherein the balance is made up of one or more fillers, additives and/or additional neutralizing agents.

For example, the one or more fillers may comprise diatomaceous earth (diatomite). The one or more additives may comprise chitosan lactate (if the chitosan salt is chitosan acetate), sodium bicarbonate, magnesium carbonate, soda ash, or a combination thereof. In various embodiments, the sodium bicarbonate may create effervescence and/or increase the surface area for the neutralization reaction, while also acting as an additional neutralization reagent. In various embodiments, the magnesium carbonate may create an effervescence effect. The one or more additional neutralizing agents may comprise calcium hydroxide (lime) and/or sodium hydroxide.

In some embodiments, the solid formulation consists essentially of magnesium oxide and a chitosan salt. For example, some embodiments the formulation comprises about 99 wt % of MgO and about 1 wt % of a chitosan salt. In various embodiments, the solid formulation consists essentially of magnesium oxide and chitosan acetate.

In some embodiments, the formulation further comprises between about 5 wt % to about 15 wt % of a carbonate salt. The carbonate salt may comprise sodium carbonate, sodium bicarbonate, magnesium carbonate and/or potassium carbonate. In some embodiments, the carbonate salt is sodium carbonate or sodium bicarbonate. In some embodiments, the carbonate salt is sodium bicarbonate. In various embodiments, a monovalent metal such as sodium may increase the solubility of sulphate and prevent or decrease gypsum formation in the sludge.

In some embodiments, the formulation may comprise about 90 wt % MgO, about 9 wt % carbonate salt and about 1 wt % chitosan acetate.

In some embodiments, the formulation may be in the form of a free powder. In alternative embodiments, the formulation may be in the form of a compressed powder. For example, the formulation may be provided as a tablet or a ball (e.g. a powder bomb).

When the formulation is provided as a compressed solid, the chitosan salt may be provided as a coating, e.g. a coating on the tablet or ball. Alternatively, the chitosan salt may be combined with the MgO (and optional other ingredients) of the compressed powder (e.g. the ingredients of the tablet or ball).

According to a further aspect of the invention, there is provided a method of neutralizing water in a tailings pond, the method comprising:
(i) providing a solid formulation comprising at least 55 wt % magnesium oxide and at least 0.5 wt % of a chitosan salt,
(ii) mixing the solid formulation with a predetermined volume of water to form a suspension;
(iii) adding the suspension to the tailings pond; and
(iv) allowing neutralization to occur in the tailings pond.

In some embodiments, the starting pH of the tailings pond is 2.5 or less.

In some embodiments, the solid formulation in step (i) is the solid formulation as described above.

After the step of adding (iii), the concentration of MgO in the tailings pond may be up to about 25 g/L. In various embodiments, the concentration of MgO in the tailings pond may be less than 25 g/L. After the step of adding (iii), the concentration of chitosan acetate may be up to about 0.3 g/L. In various embodiments, the concentration of chitosan acetate may be less than 0.3 g/L.

In some embodiments, the solid formulation further comprises at least 5% of a carbonate salt. After the step of adding (iii), the concentration of carbonate salt may be up to about 20 g/L. In various embodiments, the concentration of carbonate may be less than 20 g/L.

In some embodiments, the method does not comprise the steps of mixing, stirring, agitating or heating the tailings pond.

In some embodiments, the suspension formed in step (ii) is a slurry. In some embodiments, the predetermined volume of water in step (ii) is water from the tailings pond. In some embodiments, the weight ratio of the dry formulation to the predetermined volume of water is about 1:2 (50% suspension).

In some embodiments, step (iv) is a time period of at least 5 days. In some embodiments, step (iv) is a time period of between about 5 days to about 35 days.

In some embodiments, the final pH of the tailings pond is about 6.5 or above. The final pH of the tailings pond may be about 9.5 or below.

In some embodiments, method steps (ii)-(iv) are carried out in situ at the tailings pond.

The method may further comprise the step of (v) discharging the neutralized water from the tailings pond. Step (v) may be carried out by pumping or by gravitational discharge.

The method may further comprise the step of (vi) recovering sludge from the bottom of the tailings pond. The sludge may comprise one or more precipitated metals which may be recovered. The one or more precipitated metals may be aluminum, arsenic, chromium, cobalt, manganese, nickel, copper, iron or a combination thereof.

In some embodiments, the method removes more than 80 wt % of one or more contaminant metals from the water. The one or more contaminant metals may be aluminum, arsenic, chromium, cobalt, manganese, nickel, copper, iron or a combination thereof.

The method may selectively remove one or more of the contaminant metals listed above to a greater extent than sulphur. In some embodiments, the method removes less than 20 wt % of sulphur from the water.

According to a further aspect, there is provided a method of neutralizing water in a tailings pond, the method comprising:
(a) a first neutralization stage comprising adding the solid formulation described herein to the tailings pond and allowing neutralization to occur to provide a pre-treated water; followed by
(b) a second neutralization stage comprising adding a second neutralization reagent to the pre-treated water and allowing neutralization to occur to provide a final treated water.

In some embodiments, the second neutralization stage is performed away from the tailings pond, for example in a treatment facility. For example, after the first neutralization stage is complete, the pre-treated water may be moved from the tailings pond to a treatment facility where the second neutralization stage is performed. In some embodiments, the second neutralization reagent comprises lime.

In some embodiments, the dosage of the first neutralization reagent may be up to about 20 g/L. In some embodiments, the dosage of the first neutralization reagent may be between about 0.1 g/L and about 20 g/L, between about 2.5 g/L and about 20 g/L, or between about 2.5 g/L and about 15 g/L. The dosage of the second neutralization agent (e.g. lime) may be between about 1 g/L and about 15 g/L, between about 2.5 g/L and about 15 g/L, or between about 2.5 g/L and about 9 g/L. In some embodiments, the dosage of the second neutralization agent is about 3.5 g/L. In some embodiments, the dosage of the second neutralization agent is about 8.75 g/L.

In some embodiments, a first sludge is generated in the first neutralization stage and a second sludge is generated in the second neutralization stage.

In some embodiments, a first sludge generated in the first neutralization stage may be removed from the tailings pond. In some embodiments, the second sludge generated in the second neutralization stage may be removed from the final treated water.

According to an additional aspect, there is provided a method of selectively precipitating one or more metals dissolved in water in a tailings pond, the method comprising:
(a) a first neutralization stage comprising method steps (i)-(iv) as described herein to provide a pre-treated water, wherein the solid formulation in part (i) is a first neutralization reagent; followed by
(b) a second neutralization stage comprising adding a second neutralization reagent to the pre-treated water and allowing neutralization to occur to provide a final treated water,
wherein the quantity of the first and second neutralization reagents is selected to selectively precipitate the one or more dissolved metals into a first sludge generated in the first neutralization stage or a second sludge generated in the second neutralization stage.

In various embodiments, the one or more metals that may be selectively removed is cadmium, copper, nickel or a combination thereof.

In some embodiments, a first dosage of the first neutralization reagent selectively precipitates the one or more metals into the first sludge and a second dosage of the second neutralization reagent selectively precipitates the one or more metals into the second sludge, wherein the first dosage may be higher than the second dosage.

It will be appreciated that the embodiments described herein may be applied to any of the aspects of the invention.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 (PRIOR ART) shows a typical procedure for neutralizing tailings pond water using lime in which pond water is diverted to one or more neutralization tanks for neutralization and subsequently to a clarifier;

FIG. 2A shows an illustration of a neutralization process in accordance with the present invention and FIG. 2B shows a 3D render of an example set up of an embodiment of the present invention in practice. FIG. 2C shows an illustration of a two-stage neutralization process in accordance with an embodiment of the present invention;

FIG. 3 show photographs of root-shaped barium oxide structures observed 4 days after treatment without chitosan (top panel) and with chitosan (lower panel);

FIG. 4A shows the pH of water treated with lime with (coated) and without (uncoated) chitosan; and FIG. 4B shows the pH of water treated with magnesium oxide with and without chitosan (“modified A family” was when the magnesium oxide was added as a slurry);

FIG. 5A shows the nickel concentration in water treated with lime with and without chitosan; and FIG. 5B shows the corresponding removal efficiency;

FIG. 6A shows nickel concentration in water treated with magnesium oxide formulations; and FIG. 6B shows the corresponding removal efficiency;

FIG. 7A shows the copper concentration in water treated with lime with and without chitosan; and FIG. 7B shows the corresponding removal efficiency;

FIG. 8A shows the copper concentration in water treated with magnesium oxide formulations; and FIG. 8B shows the corresponding removal efficiency;

FIG. 9A shows the iron concentration in water treated with lime with and without chitosan; and FIG. 9B shows the corresponding removal efficiency;

FIG. 10A shows the iron concentration in water treated with magnesium oxide formulations; and FIG. 10B shows the corresponding removal efficiency;

FIG. 11A shows the sulphur concentration in water treated with lime with and without chitosan and FIG. 11B shows the corresponding removal efficiency;

FIG. 12A shows the sulphur concentration in water treated with magnesium oxide formulations and FIG. 12B shows the corresponding removal efficiency;

FIG. 13 shows the pH of water treated with magnesium oxide and chitosan formulations;

FIG. 14A shows the nickel concentration in water treated with magnesium oxide and chitosan formulations; FIG. 14B shows the corresponding removal efficiency; and FIG. 14C shows the impact of chitosan on nickel removal efficiency;

FIG. 15A shows the copper concentration in water treated with magnesium oxide and chitosan formulations; FIG. 15B shows the corresponding removal efficiency; and FIG. 15C shows the impact of chitosan on copper removal efficiency;

FIG. 16A shows the iron concentration in water treated with magnesium oxide and chitosan formulations; FIG. 16B shows the corresponding removal efficiency; and FIG. 16C shows the impact of chitosan on iron removal efficiency;

FIG. 17A shows the sulphur concentration in water treated with magnesium oxide and chitosan formulations; and FIG. 17B shows the re-dissolving efficiency;

FIG. 18A shows the aluminum concentration in water treated with magnesium oxide, sodium bicarbonate and chitosan formulations (powder bomb and slurry); and FIG. 18B shows the removal efficiency;

FIG. 19A shows the arsenic concentration in water treated with magnesium oxide, sodium bicarbonate and chitosan formulations (powder bomb and slurry); and FIG. 19B shows the removal efficiency;

FIG. 20A shows the calcium concentration in water treated with magnesium oxide, sodium bicarbonate and chitosan formulations (powder bomb and slurry); and FIG. 20B shows the removal efficiency;

FIG. 21A shows the chromium concentration in water treated with magnesium oxide, sodium bicarbonate and chitosan formulations (powder bomb and slurry); and FIG. 21B shows the removal efficiency;

FIG. 22A shows the cobalt concentration in water treated with magnesium oxide, sodium bicarbonate and chitosan formulations (powder bomb and slurry); and FIG. 22B shows the removal efficiency;

FIG. 23A shows the copper concentration in water treated with magnesium oxide, sodium bicarbonate and chitosan formulations (powder bomb and slurry); and FIG. 23B shows the removal efficiency;

FIG. 24A shows the iron concentration in water treated with magnesium oxide, sodium bicarbonate and chitosan formulations (powder bomb and slurry); and FIG. 24B shows the removal efficiency;

FIG. 25A shows the manganese concentration in water treated with magnesium oxide, sodium bicarbonate and chitosan formulations (powder bomb and slurry); and FIG. 25B shows the removal efficiency;

FIG. 26A shows the nickel concentration in water treated with magnesium oxide, sodium bicarbonate and chitosan formulations (powder bomb and slurry); and FIG. 26B shows the removal efficiency;

FIG. 27A shows the magnesium concentration in water treated with magnesium oxide, sodium bicarbonate and chitosan formulations (powder bomb and slurry); and FIG. 27B shows the introducing efficiency;

FIG. 28A shows the sodium concentration in water treated with magnesium oxide, sodium bicarbonate and chitosan formulations (powder bomb and slurry); and FIG. 28B shows the introducing efficiency;

FIG. 29A shows the sulphur concentration in water treated with magnesium oxide, sodium bicarbonate and chitosan formulations (powder bomb and slurry); and FIG. 29B shows the introducing efficiency;

FIG. 30 shows the pH of water treated with magnesium oxide, sodium bicarbonate and chitosan formulations (powder bomb and slurry);

FIG. 31 shows overall reagent consumption in the dual-step treatment process at various dosages of the test formulation (PMAP reagent) after 20 days;

FIG. 32 shows the sludge-to-reagent ratio at various dosages of the test formulation (PMAP reagent) after 20 days;

FIG. 33 and FIG. 34 show the total sludge generated and sludge generation distribution in each stage of treatment in the dual-step treatment process at various dosages of the test formulation (PMAP reagent);

FIG. 35 shows the reduction in lime sludge observed after the dual-step treatment process at various dosage of the test formulation (PMAP reagent);

FIG. 36 shows concentrations of aluminum in the liquid phase after treatment with various dosages of the test formulation (PMAP reagent) after 20 days;

FIG. 37 shows the aluminum concentration over time using 2.5 g/L PMAP reagent (FIG. 37A) and 20 g/L PMAP reagent (FIG. 37B);

FIG. 38 shows the aluminum removal efficiency using 2.5 g/L and 20 g/L PMAP reagent;

FIG. 39 shows the distribution of aluminum between the pretreatment sludge (first sludge) and the lime sludge (second sludge) at various dosages of the PMAP reagent (pretreatment reagent or first neutralization reagent);

FIG. 40 shows the change in aluminum concentration within the pretreatment sludge (first sludge) at various dosages of PMAP reagent;

FIG. 41 shows the change in aluminum concentration within the lime sludge (second sludge) at various dosages of PMAP reagent;

FIG. 42 shows concentration of arsenic in the liquid phase after treatment with various dosages of the test formulation (PMAP reagent) after 20 days;

FIG. 43 shows the arsenic concentration over time using 2.5 g/L PMAP reagent (FIG. 43A) and 20 g/L PMAP reagent (FIG. 43B);

FIG. 44 shows the arsenic removal efficiency over time using 2.5 g/L and 20 g/L PMAP reagent;

FIG. 45 shows the distribution of arsenic between the pretreatment sludge (first sludge) and the lime sludge (second sludge) at various dosages of the PMAP reagent (pretreatment reagent);

FIG. 46 shows the change in arsenic concentration within the pretreatment sludge (first sludge) at various dosages of PMAP reagent;

FIG. 47 shows the change in arsenic concentration within the lime sludge (second sludge) at various dosages of PMAP reagent;

FIG. 48 shows concentrations of cadmium in the liquid phase after treatment with various dosages of the PMAP reagent after 20 days;

FIG. 49 shows the cadmium concentration over time using 2.5 g/L PMAP reagent (FIG. 49A) and 20 g/L PMAP reagent (FIG. 49B);

FIG. 50 shows the cadmium removal efficiency over time using 2.5 g/L and 20 g/L PMAP reagent;

FIG. 51 shows the distribution of cadmium between the pretreatment sludge (first sludge) and the lime sludge (second sludge) at various dosages of the PMAP reagent (pretreatment reagent);

FIG. 52 shows the change in cadmium concentration within the pretreatment sludge (first sludge) at various dosages of PMAP reagent;

FIG. 53 shows the change in cadmium concentration within the lime sludge (second sludge) at various dosages of PMAP reagent;

FIG. 54 shows concentrations of cobalt in the liquid phase after treatment with various dosages of the PMAP reagent after 20 days;

FIG. 55 shows the cobalt concentration over time using 2.5 g/L PMAP reagent (FIG. 55A) and 20 g/L PMAP reagent (FIG. 55B);

FIG. 56 shows the cobalt removal efficiency over time using 2.5 g/L and 20 g/L PMAP reagent;

FIG. 57 shows the distribution of cobalt between the pretreatment sludge (first sludge) and the lime sludge (second sludge) at various dosages of the PMAP reagent (pretreatment reagent);

FIG. 58 shows the change in cobalt concentration within the pretreatment sludge (first sludge) at various dosages of PMAP reagent;

FIG. 59 shows the change in cobalt concentration within the lime sludge (second sludge) at various dosages of PMAP reagent;

FIG. 60 shows concentrations of copper in the liquid phase after treatment with various dosages of the PMAP reagent after 20 days;

FIG. 61 shows the copper concentration over time using 2.5 g/L PMAP reagent (FIG. 61A) and 20 g/L PMAP reagent (FIG. 61B);

FIG. 62 shows the copper removal efficiency over time using 2.5 g/L and 20 g/L PMAP reagent;

FIG. 63 shows the distribution of copper between the pretreatment sludge (first sludge) and the lime sludge (second sludge) at various dosages of the PMAP reagent (pretreatment reagent);

FIG. 64 shows the change in copper concentration within the pretreatment sludge (first sludge) at various dosages of PMAP reagent;

FIG. 65 shows the change in copper concentration within the lime sludge (second sludge) at various dosages of PMAP reagent;

FIG. 66 shows concentrations of iron in the liquid phase after treatment with various dosages of the PMAP reagent after 20 days;

FIG. 67 shows the iron concentration over time using 2.5 g/L PMAP reagent (FIG. 67A) and 20 g/L PMAP reagent (FIG. 67B);

FIG. 68 shows the iron removal efficiency over time using 2.5 g/L and 20 g/L PMAP reagent;

FIG. 69 shows the distribution of iron between the pretreatment sludge (first sludge) and the lime sludge (second sludge) at various dosages of the PMAP reagent (pretreatment reagent);

FIG. 70 shows the change in iron concentration within the pretreatment sludge (first sludge) at various dosages of PMAP reagent;

FIG. 71 shows the change in iron concentration within the lime sludge (second sludge) at various dosages of PMAP reagent;

FIG. 72 shows concentrations of nickel in the liquid phase after treatment with various dosages of the PMAP reagent after 20 days;

FIG. 73 shows the nickel concentration over time using 2.5 g/L PMAP reagent (FIG. 73A) and 20 g/L PMAP reagent (FIG. 73B);

FIG. 74 shows the nickel removal efficiency over time using 2.5 g/L and 20 g/L PMAP reagent;

FIG. 75 shows the distribution of nickel between the pretreatment sludge (first sludge) and the lime sludge (second sludge) at various dosages of the PMAP reagent (pretreatment reagent);

FIG. 76 shows the change in nickel concentration within the pretreatment sludge (first sludge) at various dosages of PMAP reagent;

FIG. 77 shows the change in nickel concentration within the lime sludge at various dosages of PMAP reagent;

FIG. 78 shows concentrations of magnesium in the liquid phase after treatment with various dosages of the PMAP reagent after 20 days;

FIG. 79 shows the magnesium utilization at various dosage of the PMAP reagent after 20 days;

FIG. 80 shows the magnesium utilization percentage at the end of 20 day treatment with various dosages of the PMAP reagent;

FIG. 81 shows the change in magnesium concentration over time using 2.5 g/L PMAP reagent (FIG. 81A) and 20 g/L PMAP reagent (FIG. 81B);

FIG. 82 shows the percentage of unutilized magnesium over time with different dosage of the PMAP reagent;

FIG. 83 shows the percentage of magnesium removal from the overflow of the pretreatment step at various dosages of PMAP reagent;

FIG. 84 shows the distribution of magnesium between the pretreatment sludge (first sludge) and the lime sludge (second sludge) at various dosages of the PMAP reagent (pretreatment reagent);

FIG. 85 shows the change in magnesium concentration within the pretreatment sludge (first sludge) at various dosages of PMAP reagent; and

FIG. 86 shows the change in magnesium concentration within the lime sludge (second sludge) at various dosages of PMAP reagent.

### DETAILED DESCRIPTION

Disclosed herein are solid formulations for neutralizing acidic tailings ponds and methods of neutralizing acidic tailings ponds. The formulations described herein are non-hazardous, environmentally friendly and can be used in situ in a method, such as, for example, a semi-passive method, for neutralizing tailings ponds. The methods described herein avoid the need to transport the tailings pond water to an external reaction vessel, thereby eliminating the tangible risk and associated liabilities related to pumping and transporting low-pH water to a secondary location for treatment purposes. The methods described herein may be used to prevent the accumulation of low-pH water in tailings ponds and to reduce or eliminate the chance of accidental release of acidic water to the environment.

### Formulations

The formulations described herein comprise one or more active neutralization reagents including magnesium oxide (MgO) as well as a natural polymer such as a chitosan salt. The formulations may also comprise additional nonhazardous additives to support the physical structure of the tablets while managing the proper sequence of the chemical reactions. Although the main components of the tablets and their functionalities are predetermined, it will be appreciated that the composition of the ingredients, the physical properties of the tablets and their injection methods may be adjusted based on the special needs of the treatment process, the tailings pond water quality and the desired quality of the treated water.

### Neutralizing Agents

In various embodiments, the one or more neutralization reagents may comprise or consist of magnesium oxide. In various embodiments, the one or more neutralization reagents may comprise or consist of two neutralizing reagents: magnesium oxide and a carbonate salt.

Magnesium oxide may be used as the main neutralizing reagent to react with acidic water in tailings ponds and generate hydroxide ions to neutralize the existing acidity in the water. Magnesium oxide (MgO), or magnesia, is a white hygroscopic solid mineral that occurs naturally as periclase. MgO is readily available for purchase at relatively low expense. For example, the cost of the raw material for the formulations described may be less than $580/ton depending on the formulation.

Carbonate salts are weakly alkaline and may be used as a second neutralization reagent to assist in neutralizing the water while releasing carbon dioxide. The carbonate salts may be any metal salt comprising a carbonate ion (CO₃²⁻) such as sodium carbonate, sodium bicarbonate, magnesium carbonate and/or potassium carbonate.

In formulations provided in the format of a compressed powder such as a tablet, the release of carbon dioxide from the carbonate salt accelerates the destruction of the tablet's structure and increases contact between the main neutralization reagent and the acidic water. The residual metallic ions from carbonate salt prevent, or significantly reduce the chance of, calcium sulphate formation and the scaling potential of the treated water.

The formulations may further comprise one or more additional neutralization agents. For example, the formulations may comprise calcium hydroxide (lime) and/or sodium hydroxide. It will be appreciated that any other suitable neutralization agent may be included in the formulation; however, the neutralization agents that are used should be non-hazardous such that they are suitable for addition to a tailings pond in situ and for discharge into the environment.

The choice of the secondary and/or additional neutralization reagents may be a function of the water quality and allowable types and concentrations of the dissolved metals in the treated water.

### Natural Polymers

The natural polymer present in the formulations may comprise or consist of a chitosan salt. For example, the chitosan salt may comprise chitosan lactate and/or chitosan acetate.

In some embodiments, the chitosan salt is chitosan acetate. Chitosan acetate is a water-soluble biocompatible, environmentally friendly and natural polymer, which is soluble in water at a pH of 6.0 or lower. Even though chitosan acetate is soluble at a pH lower than 6.0, it acts as a flocculent at pH between 6 and 9.5 to support the solids settling process by forming flocs of suspended solids.

In formulations provided in the format of a compressed powder such as a tablet, the chitosan salt may be provided as a coating on the tablet. In such embodiments, the chitosan coating may dissolve first when contacted with the acidic tailings water while the pH is low. Polymer solubility is high at this pH, thereby dissolving the polymer so that it may work more effectively as a flocculent as the pH increases with the neutralization reactions. Alternatively, the chitosan salt may be distributed throughout the formulation e.g. mixed with the other ingredients before being compressed.

### Fillers and Additives

The formulations may further comprise one or more fillers and/or one or more additives. It will be appreciated that any suitable filler may be chosen, however the fillers and additives should be non-hazardous such that they are suitable for addition to a tailings pond in situ and for discharge into the environment.

For example, a filler such as diatomaceous earth (diatomite) may be used. In various embodiments, soda ash may also be used as an additional additive. In various embodiments, chitosan lactate may be used as an additive when using chitosan acetate as the natural polymer. Sodium bicarbonate and magnesium carbonate may be used as additives to create effervescence. In various embodiments, the sodium bicarbonate may increase the surface area for reaction while also working as an additional neutralization agent.

### Ratios

The primary neutralization reagent magnesium oxide (MgO) may be present in the formulation in an amount of about 55 wt % or greater. The MgO may be present in an amount of at least 60 wt %. The MgO may be present in an amount of at least 65 wt %. The MgO may be present in an amount of at least 70 wt %. The MgO may be present in an amount of at least 75 wt %. The MgO may be present in an amount of at least 80 wt %. The MgO may be present in an amount of at least 85 wt %. The MgO may be present in an amount of at least 90 wt %. The MgO may be present in an amount of at least 95 wt %. The MgO may be present in an amount of at least 98 wt %. The MgO may be present in an amount of at least 99 wt %.

For example, the formulations may comprise between 80-99.5 wt % MgO, or any amount therebetween. The formulations may comprise 85-99.5 wt % MgO. The formulations may comprise 90-99.5 wt % MgO. The formulations may comprise about 90 wt % MgO. The formulations may comprise about 99 wt % MgO.

The formulations may comprise between 0.5-3 wt % chitosan salt, or any amount therebetween. The formulations may comprise between 0.5-1.5 wt % chitosan salt. The formulations may comprise about 1 wt % chitosan salt.

The secondary neutralization reagent, e.g. carbonate salt, may be present in an amount between about 5 and about 15 wt %. The secondary neutralization reagent may be present in an amount between 5-10 wt %. The secondary neutralization reagent may be present in an amount of about 9 wt %.

Table 1 below summarizes two of the formulation groups that are exemplified herein. Formulation Group 1 comprises MgO and chitosan salt and Formulation Group 2 comprises MgO, carbonate salt and chitosan salt. Exemplary formulations in Group 1 consist or consist essentially of about 99 wt % MgO and about 1 wt % chitosan salt. Exemplary formulations in Group 2 consist or consist essentially of about 90 wt % MgO, about 9 wt % carbonate salt and about 1 wt % chitosan salt. Alternative variations and ratios are also included within the scope of the present disclosure.

TABLE 1

| | | | | Example | | Example |
|---|---|---|---|---|---|---|
| | | Component | | formu- | | concen- |
| Formu- | | Ranges | | lation | | tration |
| lation # | Component | (wt %) | | (wt %) | | in pond |
| Formu- | MgO | 55-99.5 | wt % | 99 | wt % | up to 25 g/L |
| lation | chitosan salt (e.g. | 0.5-3 | wt % | 1 | wt % | up to 0.3 g/L |
| Group 1 | chitosan acetate) | | | | | |
| Formu- | MgO | 55-99.5 | wt % | 90 | wt % | up to 20 g/L |
| lation | chitosan salt (e.g. | 0.5-3 | wt % | 1 | wt % | up to 0.2 g/L |
| Group 2 | chitosan acetate) | | | | | |
| | carbonate salt | 5-15 | wt % | 9 | wt % | up to 25 g/L |
| | (e.g. sodium | | | | | |
| | bicarbonate) | | | | | |

It will be appreciated that the present disclosure also incorporates formulations comprising the ratios of components described herein where the weight balance may be made up of one or more fillers, one or more additives and/or one or more additional neutralizing agents. For example, the disclosure includes formulations having a ratio of magnesium oxide to chitosan salt of between 99.5:0.5 to 55:3, with the weight balance made up of one or more fillers, one or more additives and/or one or more additional neutralizing agents.

It will further be appreciated that the components and amounts of each component in the formulation may be adjusted for selective precipitation of the metals inside the pond whilst avoiding precipitation of other metals. Thus, the formulations may be used for separating valuable metals from less expensive metals and increasing the percentage of the valuable metals in either solid or liquid phases in the tailings pond.

### Format

The formulations described herein are generally described as “solid” formulations. The term “solid” is used to mean that the formulations are not liquid or fluid or gaseous. For example, the formulations may be provided as a powder which may be in the form of a free powder or a compressed powder. In the case of compressed powder, the formulation may be provided in any shape or size, such as a tablet or ball.

An advantage of using tablets instead of a combination of powder and liquids is that it reduces the quantity of required equipment and labour on site which has a significant financial advantage for the mining industry. Also, the use of tablets could prevent improper use of materials and/or wrong portions due to human errors in mixing or equipment failures.

### Methods of Neutralizing Tailings Ponds

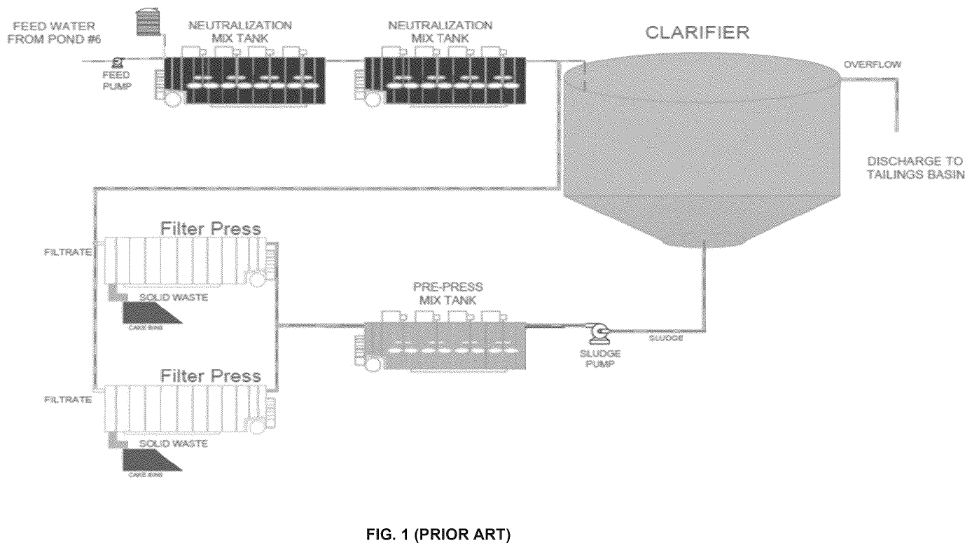

FIG. 1 shows an illustration of a typical set up for a current method of tailings pond neutralization. As shown, feed water from the tailings pond is fed into a series of neutralization tanks where the water is mixed, and sometimes heated, with neutralizing reagents. The neutralized water is then fed into a clarifier to separate the water from sludge containing precipitated metals and other particles. The neutralized water is then discharged into a tailings basin and the sludge is pumped for further processing including a pre-press mix tank and one or more filter presses to extract solid waste.

In contrast to the methods that are currently used, the presently disclosed neutralization method is performed in situ and involves fewer steps. The method may be described as semi-passive. In particular, the method involves the steps of: (i) providing a solid formulation comprising at least 55 wt % magnesium oxide and at least 0.5 wt % of a chitosan salt; (ii) mixing the solid formulation with a predetermined volume of water to form a suspension; (iii) adding the suspension to the tailings pond; and (iv) allowing neutralization to occur.

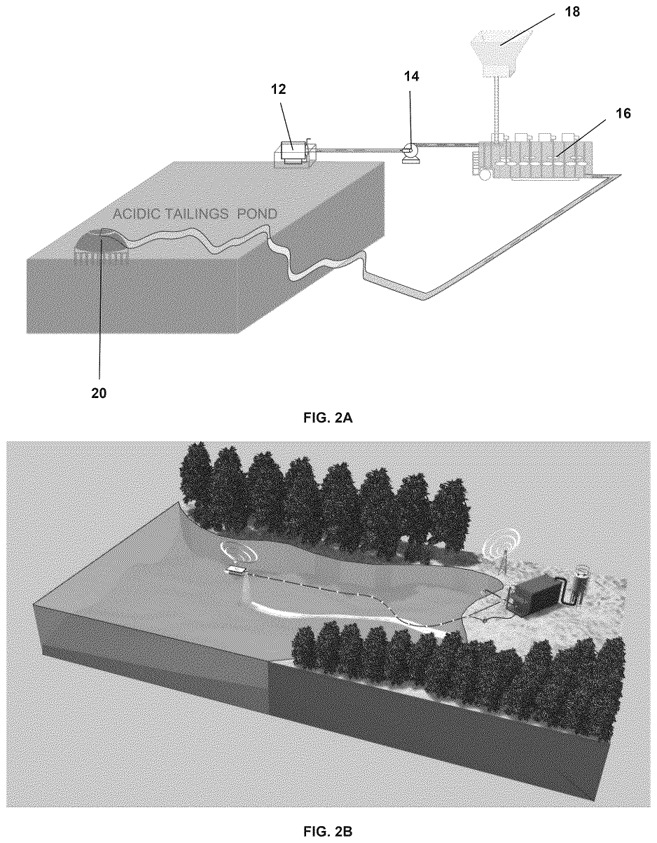

FIG. 2 shows an example of a method of pond neutralization according to the present invention. A predetermined amount of acidic water is extracted from the pond using intake float 12 and pump 14 and fed into mixing tank 16. The solid neutralization formulation is also fed into mixing tank 16 from storage container 18 and is mixed with the pond water to create a slurry. The slurry is then added to the tailings pond via a dispenser 20 for neutralization to occur.

The tailings pond may have an initial pH of 2.5 or less. In some cases, the tailings pond may have an initial pH of 2 or less. In some cases, the tailings pond may have an initial pH of 1.5 or less. In some cases, the tailings pond may have an initial pH of 1 or less.

The solid formulation may be one of the solid formulations described herein. After addition of the solid formulation, the concentration of MgO in the tailings pond may be up to about 25 g/L. For example, the concentration of MgO in the tailings pond may be between about 15 g/L to about 20 g/L. The concentration of chitosan salt in the tailings pond may be up to about 0.3 g/L. For example, the concentration of chitosan salt in the tailings pond may be between about 0.05 g/L to about 0.15 g/L. In some embodiments where the formulation comprises a carbonate salt, the carbonate salt may be present in an amount up to about 20 g/L. For example, the concentration of carbonate salt in the tailings pond may be between about 1.5 g/L to about 2 g/L.

In step (ii), the water used to make the suspension may be taken from the tailings pond or alternatively may be from any other water source. The weight ratio of the formulation to the predetermined volume of water may be between about 1:4 (25% suspension) and about 1:1.3 (75% suspension). The weight ratio may be about 1:2 (50% suspension). The weight ratio may be between about 1:4 (25% suspension) and about 1:2 (50% suspension). The weight ratio may be between about 1:4 (25% suspension) and about 1:3 (approximately 30% suspension). The suspension may be in the form of a slurry.

The suspension (or slurry) may be added to the tailings pond in one location or at multiple locations across the pond. The suspension (or slurry) may be added all at once or gradually. The method may not comprise steps of mixing, stirring, agitating or heating the tailings pond and is carried out in situ (e.g. semi-passive).

The neutralization reaction may be left to proceed for at least 5 days. In some cases, the neutralization reaction will take at least 20 days, at least 25 days, or at least 30 days. Thus, step (iv) may be a time period of between about 5 days to about 35 days.

The term “neutralization”, “neutralize” or “neutralizing” refers to a chemical change in the pH of acidic tailings pond water from a low acidic pH (e.g. between pH 1-2.5) to a higher neutral pH (e.g. pH 6.5-7.5) or alkaline pH (e.g. pH 7.5-9.5). Typically, the allowable pH range for discharge to the environment for tailings ponds is between pH 6.5 and pH 9.0 (see, for example, British Columbia Ministry of Environment and Climate Change Strategy (2021) British Columbia Approved Water Quality Guidelines: Aquatic Life, Wildlife & Agriculture—Guideline Summary, Water Quality Guideline Series, WQG-20, Prov. B.C., Victoria, Canada: page 27, Table 30).

As the neutralization reaction inside the pond progresses, dissolved metals convert to insoluble metal hydroxides, thus gradually increasing the pH of the water. When the pH of the pond reaches above 6.0, the natural polymer (e.g. chitosan) starts working as a safe, environmentally friendly, harmless and biocompatible settling aid to support the solid separation process in the pond.

The method may further comprise the step of discharging the treated water into the environment. The discharge may be carried out by pumping or by gravitational discharge. Discharge may be possible without the need for further treatment steps due to the non-hazardous nature of magnesium oxide as well as its ability for neutralization and pH control. The formulations described herein are designed such that, regardless of the amount added to the tailings pond water, the treated water does not reach a pH above 9.5. Therefore, pH overshooting may be prevented which may eliminate the risk of producing and discharging high-pH water to the environment.

The method may further comprise recovering sludge from the tailings pond. The sludge is commonly settled at the bottom of the tailings pond. The sludge may comprise one or more precipitated metals such as aluminum, arsenic, chromium, cobalt, manganese, nickel, copper, and iron. Thus, the method provides removal of contaminant metals from the water which may precipitate in the sludge. The method may remove more than 80 wt % of one or more contaminant metals from the water. The method may remove more than 90 wt % of one or more contaminant metals from the water. The method may remove more than 95 wt % of one or more contaminant metals from the water. The method may remove more than 98 wt % of one or more contaminant metals from the water. The method may remove more than 99 wt % of one or more contaminant metals from the water. The method may remove more than 99.9 wt % of one or more contaminant metals from the water. The sludge may be subjected to further processing to recover the precipitated metals.

The method may remove a minimal amount of sulphur (e.g. sulphates) from the water. Generally, sulphur, or its dominant form at low pH environments sulphate, is not an element of concern for water treatment; however, in the presence of calcium, the excessive concentration of sulphate could form gypsum. Gypsum generation harms the overall volume of the generated sludge and particularly in the case of valuable metals recovery, gypsum formation reduces the value of saleable sludge by reducing the percentage of valuable metal in the sludge due to the excessive volume of gypsum.

Unlike calcium sulphate (gypsum), magnesium sulphate has high solubility and stays in solution. Therefore, adding magnesium to the water in the presently described processes avoids increasing the volume of the sludge by precipitating magnesium sulphate and also increases the concentration of dissolved sulphate in the water by converting insoluble sulphate salts of the other metals to dissolved magnesium sulphate.

The strong binding properties of the main neutralizing reagent (magnesium oxide) eliminate the risk of remobilization of the settled metals. In general, the generated sludge with the disclosed methods is more stable and resilient against environmental changes and pH fluctuations than the sludge generated by other neutralization methods. Furthermore, the overall volume of the generated sludge is significantly smaller than the volume of generated sludge with traditional neutralization reagents such as lime or sodium hydroxide due to its high compaction factor.

The method may comprise additional steps following the primary neutralization. For example, secondary neutralization such as with lime may be performed. Combining the primary neutralization reaction with a secondary lime treatment could generate two sludges with a high percentage of valuable metals in each sludge whilst also preventing gypsum formation.

Some of the advantages of the methods of neutralization described herein are listed below:
neutralization formulations are prepared off-site which eliminates issues surrounding onsite reagent handling;
solid formulations are transported to site which eliminates the need to transport the tailings pond water and the associated risks;
use tailings pond as a reaction vessel which eliminates the need for tanks and clarifiers;
excavate settled solids and metals which reduces sludge handling costs, and may allow for valuable metal recovery.

### Multi-Stage Neutralization Methods

The solid formulations and methods of neutralization described herein may be utilized as part of a multi-stage neutralization method. For example, the neutralization formulations as described herein (“or PMAP reagent”) may be used in a pre-treatment stage prior to a secondary neutralization stage using another neutralization reagent such as lime or sodium hydroxide.

The PMAP reagent in the pre-treatment step may be used at a dosage of between about 0.1 g/L and about 20 g/L, about 2.5 g/L and about 20 g/L, between about 2.5 g/L and about 15 g/L, or between about 2.5 g/L and about 10 g/L.

The second neutralization reagent e.g. lime and/or sodium hydroxide may be used at a dosage of up to about 15 g/L, such as between about 1 g/L and about 15 g/L, such as between about 1 g/L and about 14 g/L, such as about 2.5 g/L and about 9 g/L, or such as around 3.5 g/L.

The multi-stage process may be used to selectively precipitate one or more metals from water in a tailings pond. For example, such as for the selective precipitation of copper, cadmium or nickel, a dosage of the first neutralization reagent may be used to selectively precipitate one or more metals into the first sludge (pretreatment sludge), or alternatively, a dosage of the first neutralization reagent may be used to selectively precipitate the one or more metals into the second sludge (lime sludge) following treatment with the second neutralization reagent. In other words, a low dosage of the first neutralization reagent (e.g. 2-3 g/L PMAP reagent) may selectively precipitate one or more metals into the second sludge following treatment with the second neutralization reagent, whereas a high dosage of the first neutralization reagent (e.g. 8-10 g/L PMAP reagent) may selectively precipitate the one or more metals into the first sludge.

The term “selective precipitation” means that a majority (>50%) of the total metal that is precipitated (e.g. into the first sludge or the second sludge).

It has been found that by using the two-stage neutralization method described herein:
the amount of lime required in the second neutralization stage is significantly reduced when compared to an equivalent method having a single lime neutralization stage;
the amount of lime sludge generated is reduced compared to an equivalent method having a single lime neutralization stage, thus reducing operating costs;
since the first sludge settles at the bottom of the tailings pond, the cost of waste management is reduced significantly and the need for immediate sludge management is eliminated;
the PMAP reagent is non-hazardous thereby reducing the transportation and operation of hazardous reagents on the mine site and improving the Environmental, Social and Governance (ESG) score for the mine;
the total amount of sludge generated by both stages is less than the total amount of sludge generated compared to an equivalent method having a single lime neutralization stage;
>99% of contaminant metals can be removed to acceptable discharge levels;
the concentration of the PMAP reagent can be adjusted to selectively precipitate metals such as cadmium, copper and nickel in either the first or second sludges; and
the concentration of the PMAP reagent can be adjusted to account for short or long pre-treatment times.

The present invention will be further illustrated in the following examples.

### Example 1: Evaluation of Metal Oxides

Three alternative neutralization reagents (calcium oxide, magnesium oxide and barium oxide) were tested for their performance in neutralization and metal removal.

### Test Water

Synthetic feed water was made by mixing two different waters and adding selected contaminants to have sufficient amounts of elements of concern. Since the goal was simulating the acidic water in the tailings pond, a sufficient amount of sulphuric acid was added to the mixture to adjust the pH of the solution to 2 or lower. Table 2 below shows the total and dissolved concentrations of the key elements of concern in the feed water.

Iron with a dissolved concentration of 2070 mg/L has the highest concentration of contaminants in the water, followed by nickel with a dissolved concentration of 1230 mg/L. Sulphur concentration in the feed water also is an important parameter since all the sulphur at this pH converts to sulphate and sulphate salts such as calcium sulphate which could cause scaling in the treatment system.

TABLE 2

| | | Dissolved | Total |
|---|---|---|---|
| Element | Unit | Concentration | Concentration |
| Aluminum | mg/L | 8.6 | 8.68 |
| Arsenic | mg/L | 144 | 142 |
| Chromium | mg/L | 0.329 | 0.374 |
| Cobalt | mg/L | 32.1 | 32.6 |
| Copper | mg/L | 519 | 534 |
| Iron | mg/L | 2070 | 2090 |
| Nickel | mg/L | 1230 | 1270 |
| Sulfur | mg/L | 3000 | 2740 |

### Formulations

An objective was to select the most effective neutralization reagent and chemical formula which could achieve high removal efficiency at the desired conditions. The selected main neutralization reagents in this study were magnesium oxide (A family), barium hydroxide (B family) and calcium hydroxide (C family). In each family, three formulae were generated; a pure reagent (#1), a combination of 99% neutralization reagent and 1% chitosan lactate (#2) and a combination of 70% neutralization reagent and 30% diatomic earth (#3).

The powder in the A family, due to its adhesive properties, was converted to 2 g tablets at the beginning of the tests, but the B and C families did not have these properties and so they were added to water as powder.

Also to investigate the impact of chitosan acetate, the natural polymer as a settling aid, the second group of nine reactors (Ai, Bi and Ci families) was prepared similarly to the first set (nine additional reactors) and in addition to adding the main neutralization reagents, a certain amount of the chitosan acetate was also added to each reactor. For the A family, chitosan was added as a coating to the tablets while for B and C families the chitosan was added directly to the reactors after adding the main powders.

In total, 18 different combinations were tested as shown in Table 3 below.

TABLE 3

| | Number | | |
|---|---|---|---|
| Family | 1 | 2 | 3 |
| A | 100% magnesium oxide | 99% magnesium oxide + | 70% magnesium oxide + |
| | | 1% chitosan lactate | 30% diatomic earth |
| Ai | 100% magnesium oxide + | 99% magnesium oxide + | 70% magnesium oxide + |
| | 1 mL/L of chitosan | 1% chitosan lactate + | 30% diatomic earth |
| | acetate as coating | 1 mL/L of chitosan | 1 mL/L of chitosan |
| | | acetate as coating | acetate as coating |
| B | 100% barium hydroxide | 99% barium hydroxide + | 70% barium hydroxide + |
| | | 1% chitosan lactate | 30% diatomic earth |
| Bi | 100% barium hydroxide + | 99% barium oxide + | 70% barium oxide + |
| | 1 mL/L of chitosan | 1% chitosan lactate + | 30% diatomic earth |
| | acetate as coating | 1 mL/L of chitosan | 1 mL/L of chitosan |
| | | acetate as coating | acetate as coating |
| C | 100% calcium hydroxide | 99% calcium hydroxide + | 70% calcium hydroxide + |
| | | 1% chitosan lactate | 30% diatomic earth |
| Ci | 100% calcium hydroxide + | 99% calcium hydroxide + | 70% Calcium hydroxide + |
| | 1 mL/L of chitosan | 1% chitosan lactate + | 30% diatomic earth + |
| | acetate as coating | 1 mL/L of chitosan | 1 mL/L of chitosan |
| | | acetate as coating | acetate as coating |

The lime family consisted of six samples. The first three samples were produced by using a) lime (C1), b) lime and 1% chitosan lactate (C2), and c) 70% lime plus 30% diatomic earth (C3). The second set of samples was the same as the first set of samples plus a small amount of chitosan acetate as natural flocculent (Ci1, Ci2, Ci3).

Similar to the lime family, the magnesium family consisted of six samples. The first three samples were produced by using a) magnesium oxide (A1), b) magnesium oxide and 1% chitosan lactate (A2), and c) 70% magnesium oxide plus 30% diatomic earth (A3). The second set of samples was the same as the first set of samples plus a small amount of chitosan acetate as natural flocculent (Ai1, Ai2, Ai3). A sample of A1 (A1 Powder) and a sample of A3 (A3 Powder) were also generated as powder samples. Also to investigate the impact of using chitosan acetate instead of water as a binding reagent for making the tablets a sample of pure magnesium (A1(pill+flee)) and a sample of 70% magnesium oxide plus 30% diatomic earth (A3(F)) was made by adding chitosan acetate to the powder before making the tablets.

### Method

2 g of each formulation (powder or tablet form) was added to a beaker (reaction vessel) of test water. Since the objective of the test was to simulate the reaction in the tailings pond, no mixing or heating was added to the reactors to increase the reaction rate by improving the reaction conditions.

After the fifth day of running the test and measuring the pH of the solutions, it was concluded that the quantity of active material in each reactor wasn't enough to complete the reaction. Therefore on the sixth day, 200% of the active material in the form of two 2 g tablets for the A family and 4 g of powder for the B and C families were added to the reactors. The tests were conducted for 30 days and during that period the pH of each solution was measured as the indicator of the progress of the reaction.

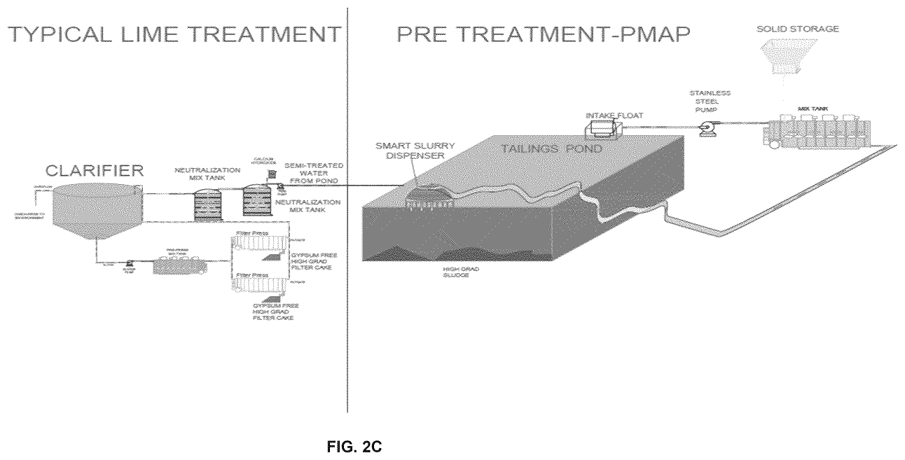

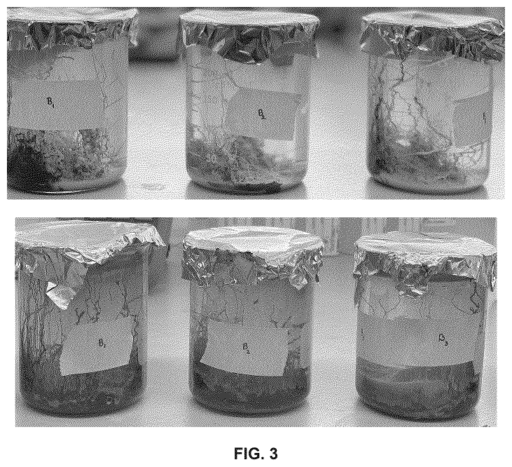

Visual changes were also observed throughout the progress of the reaction. In both A and C families, the change was limited to the colour of the water and the solid at the bottom, but in the B family, the solids started forming a root shape structure which continued to grow (see FIG. 3). FIG. 3 (top panel) shows the B family without chitosan acetate after 4 days of the tests and FIG. 3 (bottom panel) shows the B family with chitosan acetate after 9 days of the tests. Also, it was found that the pH of the water near the structure was higher than the pH of the water in the other locations in the reactor vessel.

After 30 days of test work, the water samples from the A-family reactors and the C-family reactors were collected and sent for water quality analysis. However, due to the formation of the root shape structures in the B family reactors, it was decided to not send the water from those reactors for analysis.

The impact of each sample on selected elements and the pH of treated water are reviewed below:

pH

pH is an important parameter for both discharging the treated water to the receiving environment and for categorizing the liquid as hazardous/non-hazardous liquid. Therefore, the impact of the reagent family on the pH of the treated water was investigated.

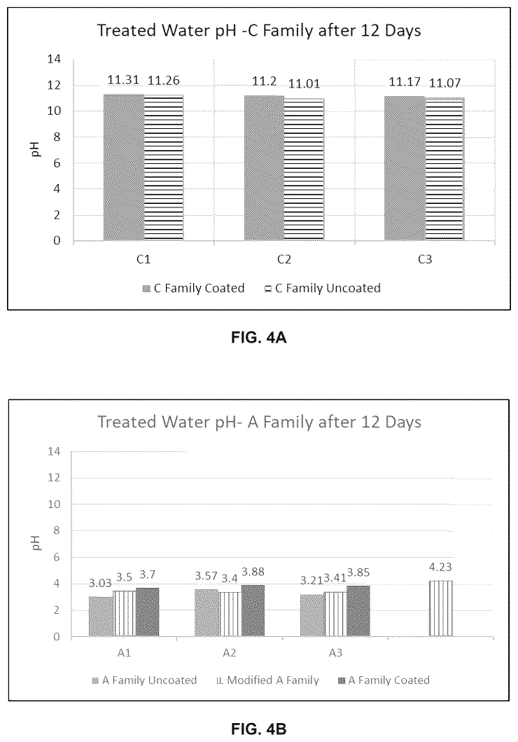

FIG. 4A shows the pH of the treated water at the end of treatment with both coated (with chitosan acetate) and uncoated lime families. The result shows regardless of the percentage of lime in the reagent formula and the existence of the coating, the pH of treated water would be above 11 and the treated water required additional pH adjustment before discharging to the receiving environment. Also, the results unveiled the fact that the final pH of the coated reagents is slightly higher than the pH of the similar tests without coating.

FIG. 4B shows the pH of treated water at the end of treatment with both coated (with chitosan acetate) and uncoated magnesium oxide families. Unlike the treated water with the lime family, the pH of water treated with magnesium oxide was below 4.5. The low pH of the treated water in tests with magnesium oxide could be the result of buffering property of the magnesium oxide. Although this characteristic of the magnesium oxide might have some negative impact on metals removal efficiency, it prevents pH overshooting due to excessive use of the reagent and provides a reaction environment with better control of pH.

### Metal Removal Efficiency

### Nickel

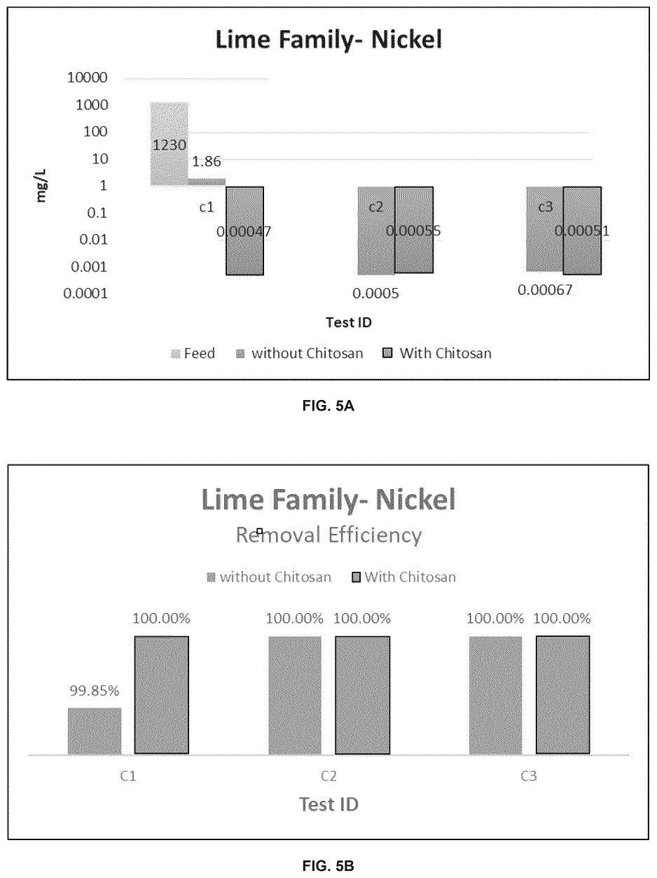

The concentrations of nickel in all samples from the lime family tests were significantly lowered. FIG. 5A shows the nickel concentration in feed water and the treated samples on the left side and the nickel removal efficiency on the right side. Based on the collected information, the lowest removal efficiency was the sample from pure lime without using chitosan acetate. In this sample, the initial concentration of nickel in the feed, 1230 mg/L, was reduced to 1.86 mg/L. The nickel removal efficiency, in this case, was 99.85%, which was the lowest removal efficiency among all the lime family tests. In other tests, the concentration of the residual nickel in treated water was either undetectable or significantly lower than environmental limits (see FIG. 5B).

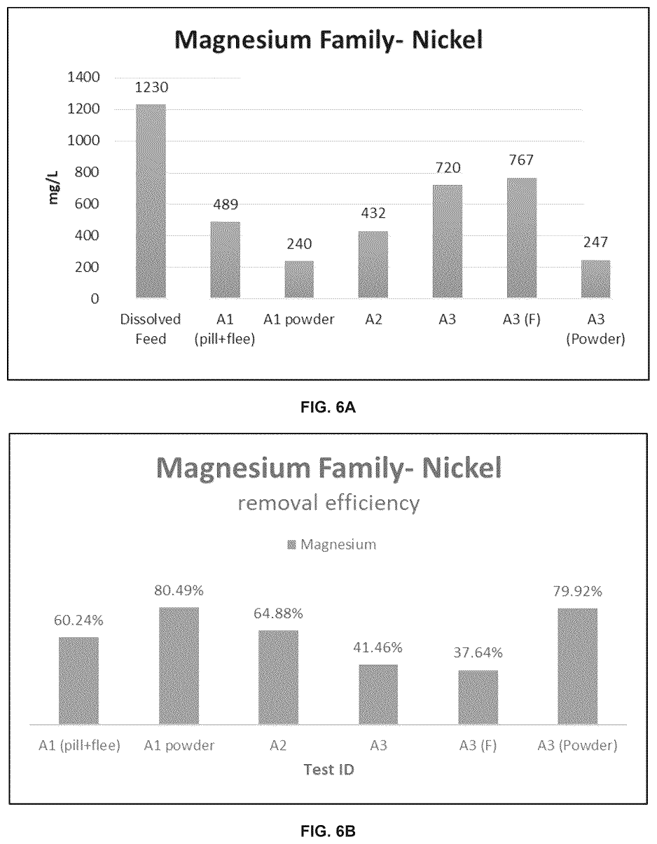

The concentrations of nickel in all samples from the magnesium family tests were higher than the similar numbers in samples from the lime family. FIG. 6A shows the nickel concentration in feed water and the treated samples and FIG. 6B shows the nickel removal efficiency.

Based on the collected information the highest removal efficiency was the sample from pure magnesium in powder form (A1-powder). In this sample, the initial concentration of nickel in the feed, 1230 mg/L, was reduced to 240 mg/L. The nickel removal efficiency, in this case, was 80.49% which was the highest removal efficiency among all the magnesium family tests. The removal efficiency of the A1-Powder sample closely followed by the removal efficiency of the A3-Powder (79.92%). Based on this observation it was concluded that the physical form of the reagent has a significant impact on the performance of reagent. In this case, despite the low percentage of the active reagent in the sample A3-Powder with 70% magnesium oxide, the reagent performance was very close to the performance of the A1-powder with pure magnesium oxide. Therefore, it was determined that the most effective way of using magnesium oxide to treat this water sample was either powder or slurry.

### Copper

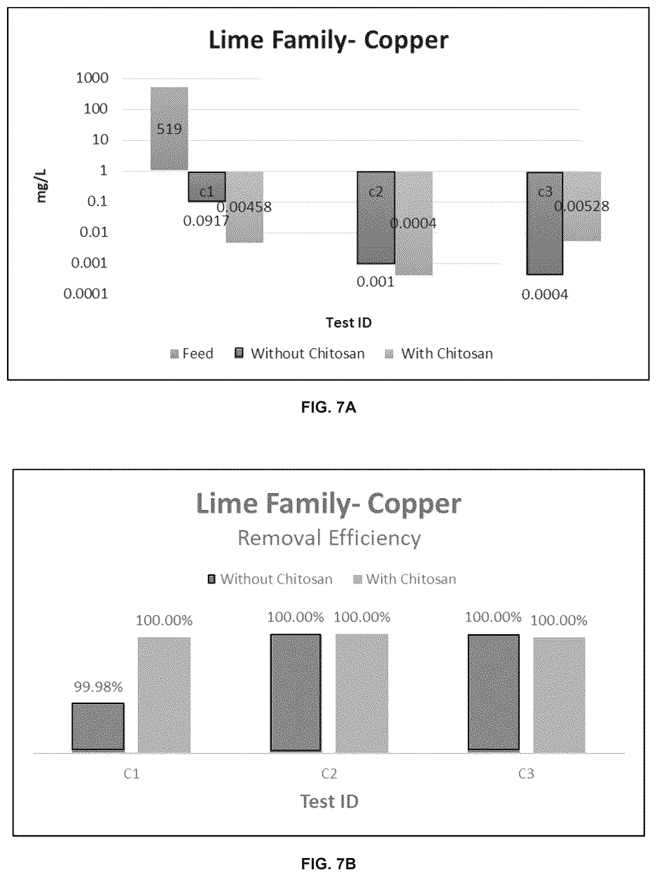

The concentrations of copper in all samples from the lime family tests were very low. FIG. 7A shows the copper concentrations in feed water and the treated samples and FIG. 7B shows the copper removal efficiency. Similar to nickel, the lowest removal efficiency was the sample from pure lime without using chitosan acetate. In this sample, the initial concentration of copper in the feed, 519 mg/L, was reduced to 0.0917 mg/L. The copper removal efficiency, in this case, was 99.98% which was the lowest removal efficiency among all the lime family tests. In other tests, the concentration of the residual copper in treated water was either undetectable or significantly lower than environmental limits.

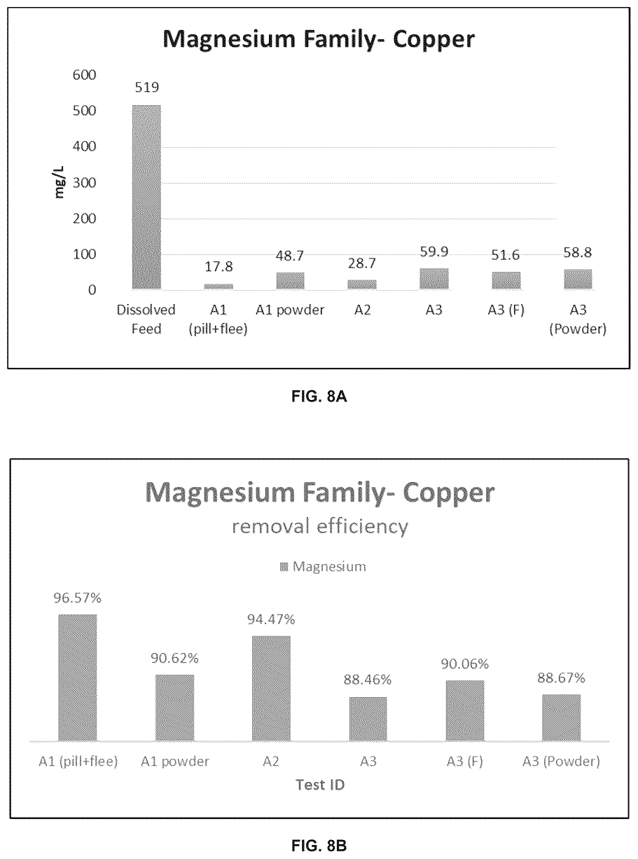

The concentrations of copper in all samples from the magnesium family tests were very low. FIG. 8A shows the copper concentrations in feed water and the treated samples and FIG. 8B shows the copper removal efficiency. Regarding the copper concentration, the lowest concentration of copper in the treated water belonged to the sample from pure magnesium which was made by using chitosan acetate as a binding reagent (A1 (pill+flee)). In this sample, the initial concentration of copper in the feed, 519 mg/L, was reduced to 17.8 mg/L. The copper removal efficiency, in this case, was 96.57%, which was the highest removal efficiency among all the magnesium oxide family tests.

The lowest copper removal efficiency in those samples was related to using 70% magnesium oxide as a tablet. This low removal efficiency could be caused by both the physical shape of reagent delivery (tablet vs. powder) and/or the low percentage of active material (70% magnesium oxide vs. pure magnesium oxide). It seems the copper concentration in the treated water is more sensitive to the purity of the reagent and the presence of the chitosan acetate than the physical shape of reagent delivery.

### Iron

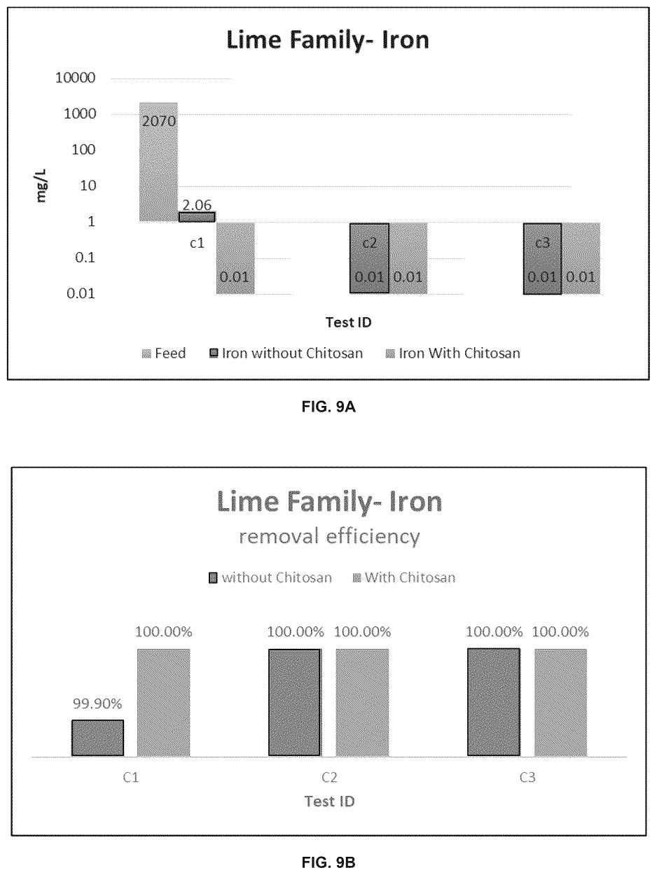

The concentrations of iron in all samples from the lime family tests (except the sample from the test with pure lime) were below the detection limit. FIG. 9A shows the iron concentrations in feed water and the treated samples and FIG. 9B shows the iron removal efficiency. Similar to the other metals, the lowest removal efficiency was the sample from pure lime without using chitosan acetate. In this sample, the initial concentration of iron in the feed, 2070 mg/L, was reduced to 2.06 mg/L. The iron removal efficiency, in this case, was 99.90%, which was the lowest removal efficiency among all the lime family tests. In other tests, the concentration of the residual iron in treated water was undetectable.

The concentrations of iron in all samples from the magnesium family tests were very low. FIG. 10A shows the iron concentrations in feed water and the treated samples and FIG. 10B shows the iron removal efficiency. The concentration of iron in both A1-pill+flee and A1-powder (pure magnesium oxide), as well as the A2 (99% magnesium oxide) samples, were under detection limits. While the concentration of residual iron after treating the water with samples consisting of less active reagent (70% magnesium oxide) was higher, it seems iron removal is mostly a function of active reagents rather than the physical shape of the delivered reagent. In general, the removal efficiency of iron with the magnesium oxide family was above 93% which was comparable with the lime family removal efficiency.

### Sulphur

Although sulphur (or sulphate as it is the dominant form of sulphur in the acidic feed), was not a treatment target in this study, precipitation of metal sulphates in this process increases the quantity of the generated sludge and harmed the quality (and the economy) of the potential valuable metals recovery.

Since the total mass of valuable metals in the treatment's sludge is limited to their mass in the liquid phase, an increase in the overall mass of the sludge by metal sulphate precipitation reduces the percentage of the valuable metals in the sludge. The volume of the sludge was found to be directly related to the sulphur removal potential of the neutralization reagent. The high sulphur removal efficiency (which is equal to the low concentration of residual sulphur in the treated water) causes the high volume of generated sludge and reduces the percentage of the valuable metals in the sludge. For this reason, if metals recovery is a target of water treatment, the low sulphur removal efficiency would be favourable.

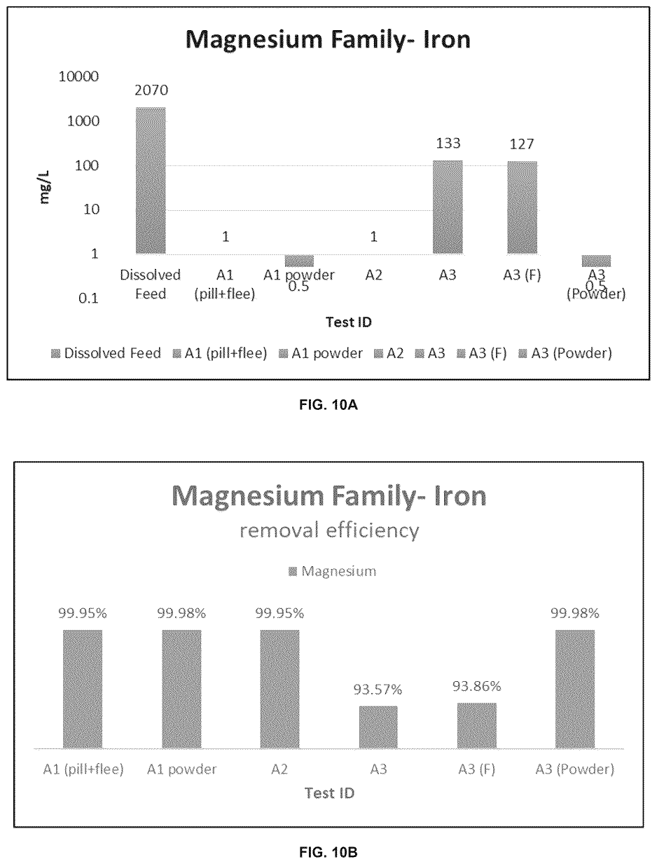

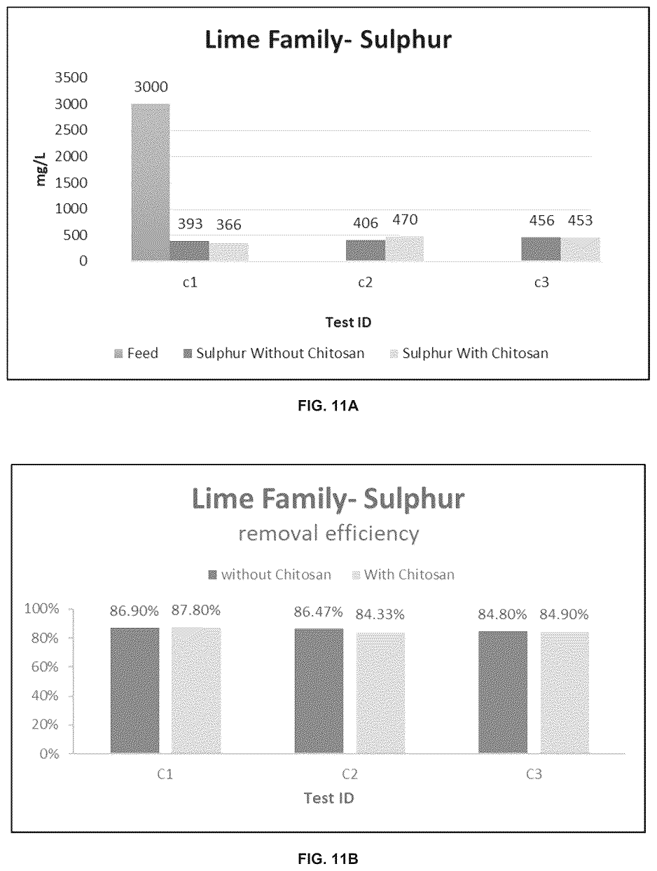

FIG. 11A shows the sulphur concentrations in feed water and the treated samples and FIG. 11B shows the sulphur removal efficiency on the right side (lime family). Similar to the metals, the highest removal efficiency was the sample from pure lime with chitosan acetate. In this sample, the initial concentration of sulphur in the feed, 3000 mg/L, was reduced to 366 mg/L. The sulphur removal efficiency, in this case, was 87.80% which was the highest removal efficiency among all the lime family tests. This high removal efficiency could be valuable if sulphur removal is one of the treatment objectives, but it would be harmful if valuable metals' recovery from the sludge was defined as the treatment objective.

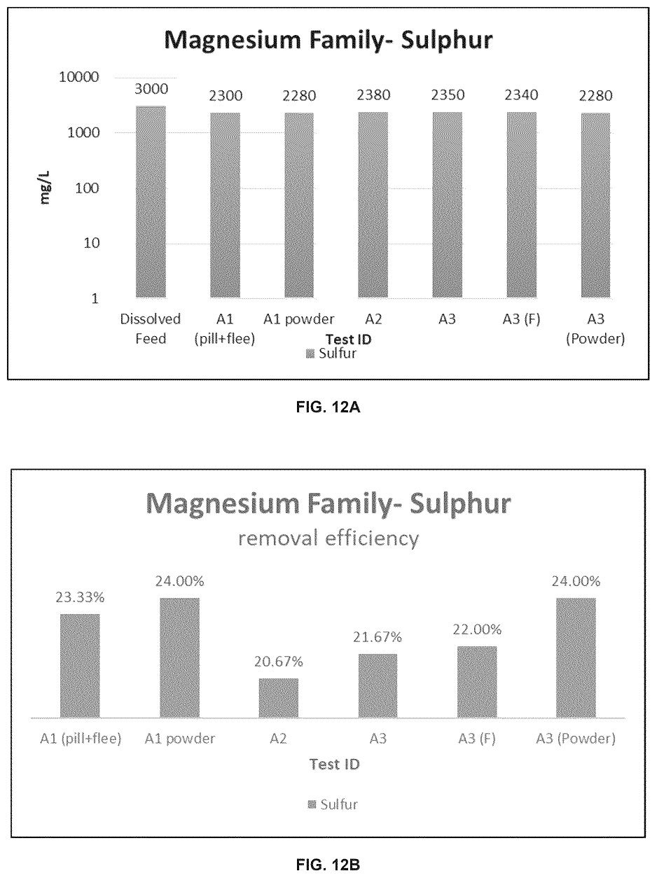

FIG. 12A shows the sulphur concentrations in feed water and the treated samples and FIG. 12B shows the sulphur removal efficiency. The lowest removal efficiency was presented by a 99% magnesium oxide tablet and the highest removal efficiency was presented by powder samples. In general, the sulphur removal efficiency was less than a third of the sulphur removal efficiency of the samples by lime. Therefore, if the recovery of the valuable metals is a main objective of the treatment process, the use of magnesium oxide (regardless of physical shape) is preferable.

### Conclusion

Despite the excellent performance of calcium oxide (lime) in metals removal, lime was also found to result in an excessive increase in the pH of the treated water and had the potential for gypsum formation in a high sulphate environment. Barium hydroxide was eliminated due to the formation of root-shape structures instead of settling materials at the bottom of the container (see FIG. 3).

Magnesium oxide was selected for its properties such as pH buffering which prevents high pH in the treated water and insensitivity to the sulphate concentration in the water due to the high solubility of the magnesium sulphate. Also, the binding properties of magnesium has a positive impact on the volume of the generated sludge while preventing the remobilization of the precipitated metals. Both the sludge volume and immobility of the metals are key parameters for managing the treatment's solids waste.

Based on the results, the magnesium oxide (family A) was selected for further testing. The main advantages of magnesium oxide include one or more of
Non-hazardous, environmentally friendly neutralization reagent which eliminates operation and transportation risks;
Buffering properties which prevent pH overshooting and produce treated water with dischargeable pH and eliminates the need for final pH adjustment of treated water;
High solubility of magnesium sulphate which reduces the volume of the generated sludge;
Binding properties which produce compact sludge and prevents remobilization of settled metals;
Selective precipitation of valuable metals under different dosages; and
Compressibility of magnesium oxide to form a tablet or other physical forms, which reduces labor required for onsite operations.

Although lime showed a high removal efficiency for nickel (min. 99.85%), copper (min. 99.98%) and iron (min. 99.99%), it is not the preferred reagent due to one or more of the following reasons:
The hazardous nature of lime which causes significant transportation and operation risks;
The high pH of the treated water after lime treatment which required pH adjustment before discharging the water;
The formation of gypsum in the sludge which increases the volume of sludge and reduces the percentage of the valuable metals and the value of sludge; and
The difficulty of producing tablets from lime.

### Example 2: Evaluation of the Effect of Chitosan

The effect of the concentration of magnesium oxide and the impact of liquid chitosan (chitosan acetate) in combination with magnesium oxide on metal removal efficiency was evaluated.

### Formulations

TABLE 4

| | | | Volume | | |
|---|---|---|---|---|---|
| | Volume | Mass of | of mixed | | |
| Formulation | of water | MgO | water | Type of | MgO |
| # | (mL) | (g) | (mL) | mixing | (g/L) |
| A1 | 100 | 5 | 10 | With RO | 50 |
| A2 | 250 | 2.5 | 10 | With feed | 10 |
| A3 | 250 | 2.5 | 0 | Dry | 10 |
| A4 | 250 | 3 | 8 | With feed | 12 |
| A5 | 250 | 4 | 8 | With feed | 16 |
| A6 | 250 | 5 | 10 | With feed | 20 |
| A4-1 | 250 | 3 | 10 | With feed + | 12 |
| | | | | 0.1 g/L | |
| | | | | chitosan | |
| A5-1 | 250 | 4 | 10 | With feed + | 16 |
| | | | | 0.1 g/L | |
| | | | | chitosan | |
| A6-1 | 250 | 5 | 10 | With feed + | 20 |
| | | | | 0.1 g/L | |
| | | | | chitosan | |

### Method

Different amounts of magnesium oxide were added to the feed water (see Example 1) by mixing the powder with a small amount of the feed water and adding the slurry to the water in the reaction “pond”.

Nine 300 ml beakers were used as the reaction pond, 250 ml of the feed water was added to eight beakers and 100 ml of the feed water was added to the final beaker. Then, a sufficient amount of magnesium oxide was added to each beaker to reach the concentration presented in Table 4 (see above).

As presented in Table 4, for beaker A1 with 100 ml of feed water, 10 ml of reverse osmosis (RO) water was used to make a 50% slurry by adding 5 g of magnesium oxide. To prepare the magnesium oxide slurry for the other beakers, the feed water was pulled from the beaker itself and after generating the slurry it was returned to the beaker with additional solids. For example, in the case of beaker A2, at first 10 ml of the feed in the beaker was pulled out by a syringe and then the liquid was added to 2.5 g of magnesium oxide to generate the slurry. After the formation of the slurry, the mixture was returned to the beaker. In this way, the total volume of the feed water did not change due to adding RO or feed water.

By using a similar method, beakers A4, A5 & A6 with 12, 16 & 20 g/L of magnesium oxide were prepared, respectively. Beaker A3 was used to evaluate the impact of adding powder magnesium oxide directly to the pond. The amount of used magnesium oxide in the beaker A3 was equal to the amount of magnesium oxide in A2 but it was added as powder instead of slurry. The impact of chitosan acetate was evaluated by providing a duplicate of solutions in beakers A4, A5 and A6 and adding 0.1 ml (0.4 ml/L of feed water) of the chitosan acetate to each beaker.

The test was continued for 18 days and the pH of the water sample in each beaker was measured occasionally. At the end of day 18, the water samples from all beakers were collected for dissolved analysis.

pH

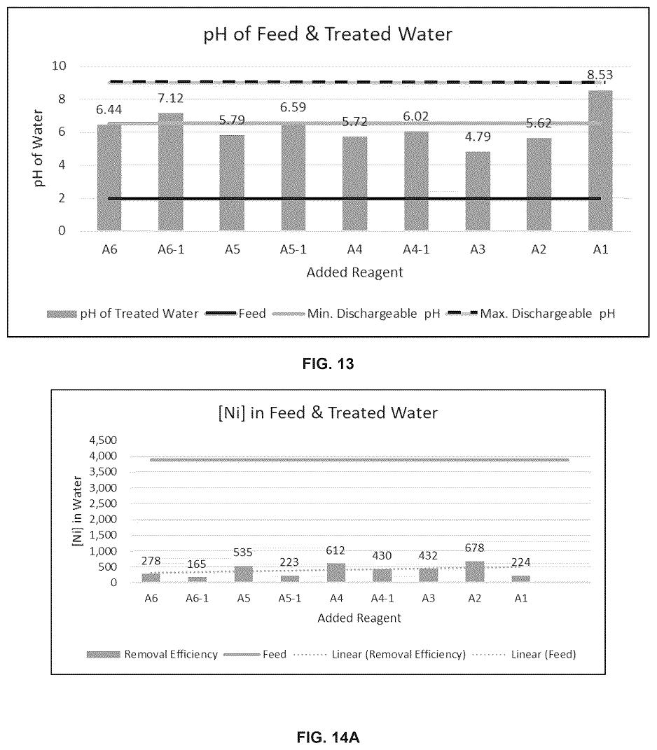

FIG. 13 shows the final pH of each sample at the end of the test as well as the pH of feed water and upper (9.5) and lower (6.5) limits for discharging water to receiving environment.

Based on the current observations, the pH of the treated water after tests A6-1, A5-1 and A1 were within the discharge range. The test with A6-1 presented good results and generated treated water within the desirable pH range.

Since A6 and A6-1 consumed the same amount of magnesium oxide, the difference between the pH of the two samples could be interpreted as the effect of chitosan acetate on the quality of the treated water. The higher pH of the treated water in samples with chitosan acetate also could explain the better performance of those samples compared to the performance of similar samples without chitosan acetate.

### Metal Removal Efficiency

### Nickel

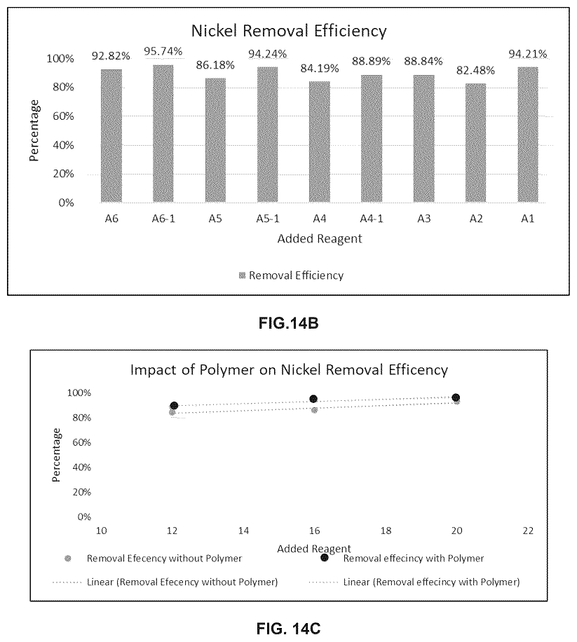

The concentrations of nickel in all samples were significantly low. FIG. 14A shows the nickel concentration in feed water and the treated samples and FIG. 14B shows the nickel removal efficiency.

The highest removal efficiency belonged to the sample with 20 g/L magnesium plus chitosan acetate in powder form. In this sample, the initial concentration of nickel in the feed, 3870 mg/L, was reduced to 165 mg/L. The nickel removal efficiency, in this case, was 95.74%, which was 1.53% higher than the removal efficiency of the 50 g/L magnesium sample. This could be interpreted as that the proper use of magnesium (as a slurry with chitosan acetate) could be more efficient than the use of a high amount of magnesium (2.5 times) with a less desired physical form (dry injection without chitosan acetate). In addition, the test results unveiled the fact that increasing magnesium oxide dosage after a certain concentration has a limited impact on nickel removal. For example, moving from 12 g/L in sample A4-1 to 20 g/L of magnesium oxide in sample A6-1 (66.6% increase in reagent consumption) has a marginal effect on the nickel removal efficiency and the removal efficiency jumped from 88.89% to 95.74% (only 6.85% increase).

FIG. 14C shows the impact of the chitosan acetate on the nickel removal efficiency. The removal efficiency of all samples marginally improved by using chitosan acetate. The better performance of the reagent with chitosan acetate could be due to the ability of the polymer to absorb some of the dissolved ions to its active sites and reduce dissolved metals concentrations.

### Copper

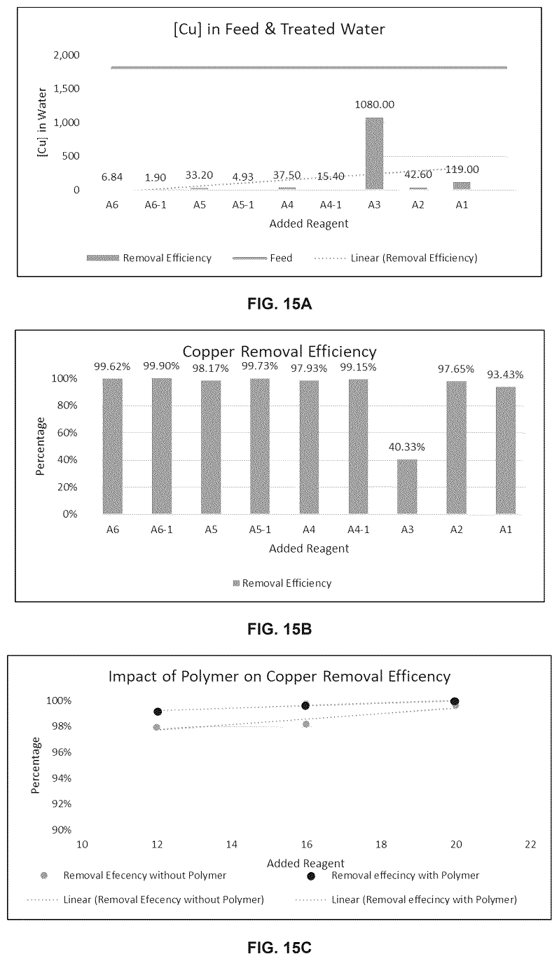

The concentrations of copper in all samples (except A3) were significantly lowered. FIG. 15A shows the copper concentration in feed water and the treated samples and FIG. 15B shows the copper removal efficiency.

After ignoring A3 as an outlier, the lowest observed removal efficiency in the test, 93.43%, belonged to A1 with the excessive amount of magnesium oxide (50 g/L) which was added as dry powder. The test shows that magnesium oxide can easily remove a high percentage of copper even at a low dosage. Therefore, if copper precipitation was considered the main target of the treatment, a low dosage of magnesium in this method could successfully deliver the required result.

FIG. 15C shows the impact of the chitosan acetate on the copper removal efficiency. Similar to the nickel, the removal efficiency of all samples marginally improved by using chitosan acetate.

### Iron

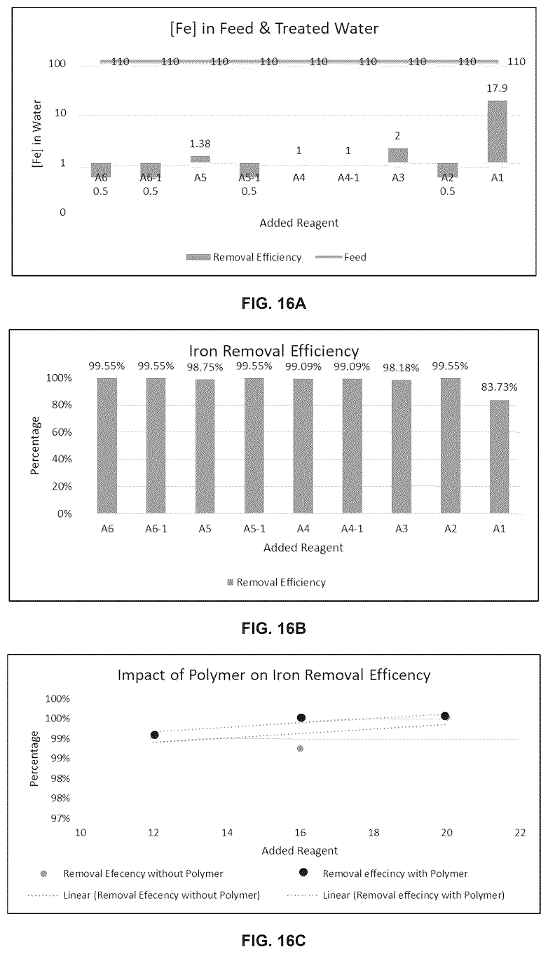

The concentrations of iron in all samples (except A4) were very low. FIG. 16A shows the iron concentration in feed water and the treated samples and FIG. 16B shows the iron removal efficiency.

In many cases, the iron concentration in the treated water was below the lab detection limit. The lowest observed removal efficiency in the test, 83.73%, belonged to A1 with the excessive amount of magnesium oxide (50 g/L) which was added as dry powder. The test shows that magnesium oxide can easily remove almost all of the iron even at a very low dosage. Therefore, if iron precipitation was considered the main target of the treatment, a low dosage of magnesium in this method could successfully deliver the required result.

FIG. 16C shows the impact of the chitosan acetate on the iron removal efficiency. Similar to the other metals, the removal efficiency of all samples marginally improved by using chitosan acetate. Without wishing to be bound by theory, it could be interpreted that the chitosan's ability to adsorb cationic ions in the water was the main reason for the better performance of the samples with chitosan acetate.

### Sulphur

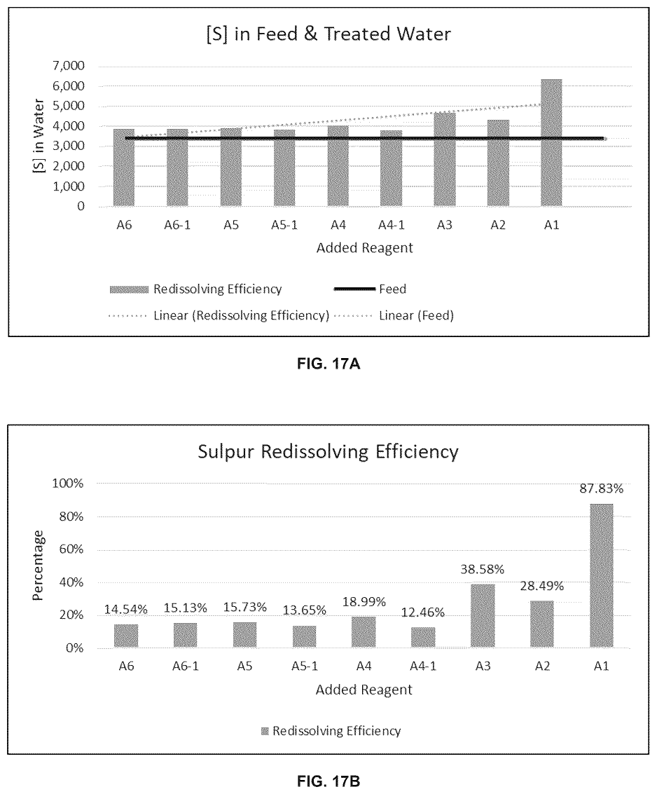

FIG. 17A shows the sulphur concentration in feed water and the treated samples and FIG. 17B shows the sulphur re-dissolving efficiency. The impact of using magnesium oxide was to maintain a constant concentration of sulphur in the water at a low dosage of magnesium oxide and by increasing the magnesium oxide dosage, the concentration of the dissolved sulphur would increase.

The holding capacity of the sulphur in the water would be the key parameter if this method was used as the first step of valuable metal recovery to precipitate the first valuable metal (e.g. copper) followed by lime neutralization to precipitate the second valuable metal (e.g. nickel) in the second step. Due to the high concentration of magnesium in the overflow from the pond, the existing sulphur in the overflow won't generate gypsum in the lime neutralization and by reducing the overall volume of the generated sludge, the percentage of the valuable metal (nickel) in the second sludge would be significantly higher than the metal percentage in the sludge generated by regular lime neutralization.

### Conclusion

Overall, the results show high success at removing metals with magnesium oxide without increasing the pH of the treated water above the dischargeable pH. Magnesium oxide slurry mixed with chitosan acetate could remove nickel (95.74%), copper (99.90%) and iron (99.55%) while removing only 15.33% of sulphur. The low sulphur removal efficiency reduces the volume of generated sludge and works in favour of both solids waste management and valuable metals recovery. The pH of the treated water was 7.12, which is in the range of dischargeable pH for treated water.

### Example 3: Evaluation of the Effect of Delivery Format and the Effect of Sodium Bicarbonate

Tests were conducted to investigate the impact of the reagent delivery format on the reagent performance and the effect of sodium bicarbonate. Samples of feed water were collected in two separate beakers and placed outside in an open environment to simulate the actual pond condition. For the first test, the formulation was shaped into a ball and was directly delivered to the beaker. For the second test, the reagent was a mixed powder that was mixed with a small amount of the feed water to form a slurry and then delivered to the second beaker.

### Formulations

The tests were conducted using a formulation composed of 90% magnesium oxide, 9% sodium bicarbonate and 1% chitosan acetate (1% solution in acetic acid) in a 50 g ball (similar to a bath bomb), or as a slurry made from 50 g of the powder formulation and a small volume of the feed water. The feed waters for both tests were samples of actual pond water collected in two beakers.

### Feed Water

The feed water was wastewater from the tailing pond of an old mine available at the University of British Columbia. Since the pH of the water was 2.04, no additional acid or salt was added to the water. Table 5 shows the total and dissolved concentrations of the key elements of concern in the feed water.

Nickel with a dissolved concentration of 2170 mg/L had the highest concentration of contaminants in the water, followed by copper and calcium with a dissolved concentration of 502 mg/L and 460 mg/L, respectively. Sulphur and sodium concentrations in the feed water also were important parameters since all the sulphur at this pH would be converted to sulphate such as calcium sulphate which could cause scaling in the treatment system. At the same time, the existence of sodium prevents the formation of calcium sulphate by producing sodium sulphate with high solubility.

TABLE 5

| Parameter | Feed (mg/L) |
|---|---|
| pH | 2.04 |
| Hardness, Total (as CaCO₃) | 1280 |
| Aluminum, dissolved | 18.9 |
| Arsenic, dissolved | 62.6 |
| Calcium, dissolved | 460 |
| Chromium, dissolved | 0.368 |
| Cobalt, dissolved | 100 |
| Copper, dissolved | 502 |
| Iron, dissolved | 44.7 |
| Magnesium, dissolved | 32.8 |
| Manganese, dissolved | 1.47 |
| Nickel, dissolved | 2170 |
| Sodium, dissolved | 360 |
| Sulfur, dissolved | 1900 |

### Method

Two 2 L beakers were filled, each with 950 mL of the feed water. Then 100 mL of the feed water from the slurry beaker was transferred to a 300 mL beaker equipped with a mixer. 50 g of the powder was added to the 300 mL beaker and mixed rapidly for 1 minute to make the slurry before transferring it into the slurry beaker. Meanwhile, the ball was added to the bomb beaker and the initial reaction was recorded with a video camera.

Both tests were conducted outside in open containers to simulate the actual pond situation. The beakers were exposed to environmental conditions for 10 days before measuring pH and collecting dissolved metal samples for the first time. The pH was measured on the 15th, 20th, and 30th days of the test, and the second set of water samples was collected on day 20 for the dissolved metal analysis. As observed during the test, the colour of the water in the slurry beaker changed in 10 days and the water became colourless after 20 days. On the other hand, the colour change in the bomb beaker wasn't that obvious. However, the ball showed some discolouration and the porosity of the ball was visible.

Another observation was related to losing water due to evaporation. A total of about 50 mL of the water from each beaker was withdrawn for two sets of samples while 50 g of reagent was added to each beaker. Therefore, observing a small change in the initial volume of the water (950 mL) was expected. However, the final volumes of the reaction mixtures were about 800 mL after 20 days. The 10-12% volume reduction in the test significantly affected contaminant concentrations. This volume reduction has been taken into consideration in the discussion of results (see below).

### Metal Removal Efficiency

The selected elements in this study were categorized into two main groups; the removed elements whose dissolved concentration was decreased over time, and the inclined elements whose dissolved concentration was increased over time. The main elements in the removed group were aluminum, arsenic, calcium, chromium, cobalt, copper, iron, manganese and nickel. The main elements in the second (inclined) group were magnesium, sodium and sulphur.

### Aluminum

Although the concentration of aluminum in both samples was reduced over time, the concentration reduction in the test with slurry was remarkably quick and the residual concentrations were below the applicable detection limit for the analysis. FIG. 18A shows the dissolved aluminum concentration in feed water and the treated samples with both slurry and ball, and FIG. 18B shows the aluminum removal efficiency.

Based on the analysis, the slurry formulation was able to remove more than 97% of the aluminum in the feed water (18.9 mg/L) and produced water with less than 0.5 mg/L of aluminum after 10 days. In addition, by continuing the process for another 10 days, the removal efficiency increased by reducing the aluminum concentration to less than 0.25 mg/L. On the contrary, the ball test showed lower removal efficiency and in 10 days removed only 21% of the aluminum. The longer test duration worked in favour of the ball and increased the removal efficiency to 63%.

### Arsenic

The concentration of arsenic in both samples was reduced over time. However, as was expected, the concentration reduction in the test with slurry was quick and the residual concentrations in this test were lower than the residual dissolved arsenic in the ball test. FIG. 19A shows the dissolved arsenic concentration in feed water and the treated samples with both slurry and ball and FIG. 19B shows the arsenic removal efficiency.

For arsenic, the concentration difference between the two tests was high after 10 days. However, the ball showed a significant improvement over the second half of the test and the residual dissolved arsenic concentration in both tests became very low at the end of the test period. Based on this observation, it seems that the arsenic removal efficiency over a long period was independent of the reagent delivery method and the reagent could remove a high percentage of the arsenic in both cases, which may be due to the arsenic removal mechanism.

### Calcium

FIG. 20A shows the dissolved calcium concentration in feed water and the treated samples with both slurry and ball and FIG. 20B shows the calcium removal efficiency.

The concentration of dissolved calcium in the treated water with the slurry solution was reduced over time, while the same concentration was increased in the treated water by the ball. The slurry reagent removed 64% of the dissolved calcium and reduced the calcium concentration from 460 mg/L to 165 mg/L. The dissolved calcium reduction could be due to the formation of calcium hydroxide by a replacement reaction between magnesium hydroxide and calcium sulphate in the water. In this case, additional time didn't have a tangible impact on the calcium removal efficiency

On the contrary, the concentration of the dissolved calcium in the treated water by the ball increased over time. The change in the concentration of dissolved calcium in this test showed that calcium was not involved with a replacement reaction when the reagent was introduced as a ball.

Since the test was conducted over a long period (20 days) with open-top beakers almost 10% of the water evaporated. Water evaporation would have reduced the volume of the pure water without affecting the mass concentration of the other elements in the water; therefore, without removing dissolved elements, the concentration of those elements would increase. The pseudo-increase in calcium concentration was attributed to the absence of element removal caused by water evaporation.

### Chromium

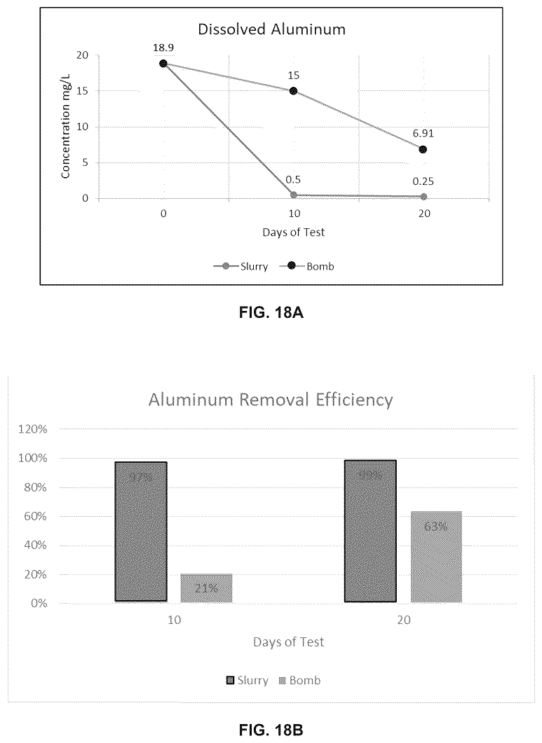

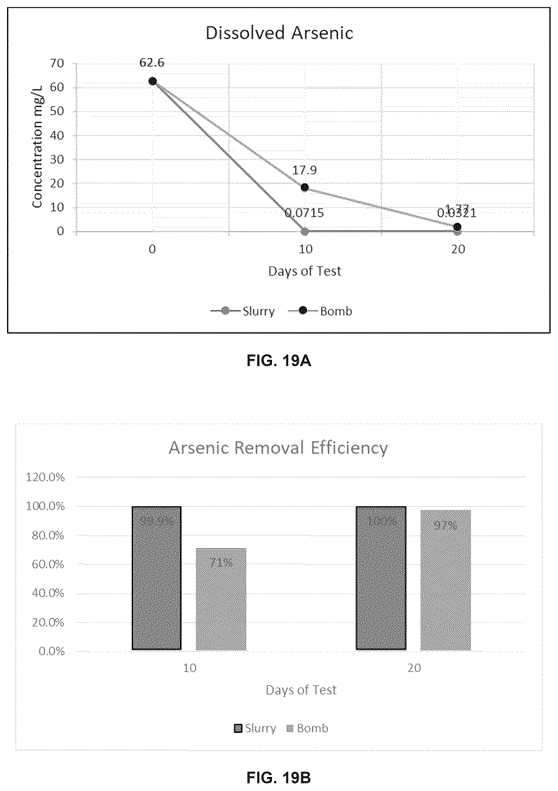

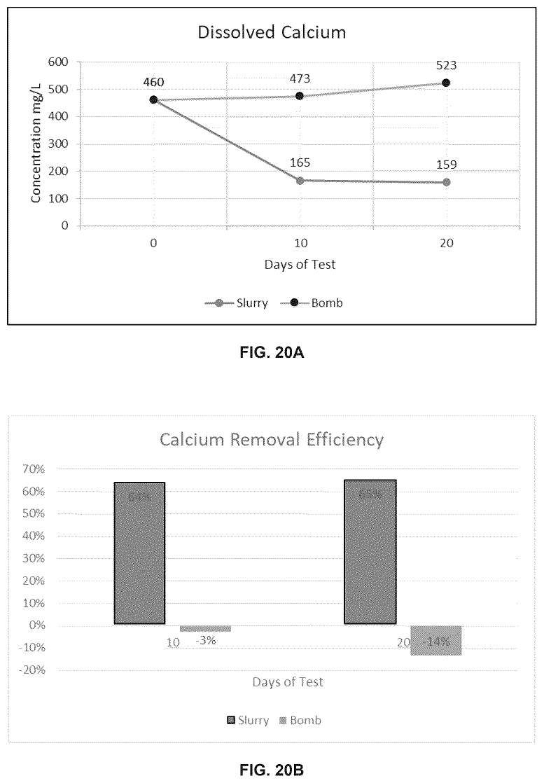

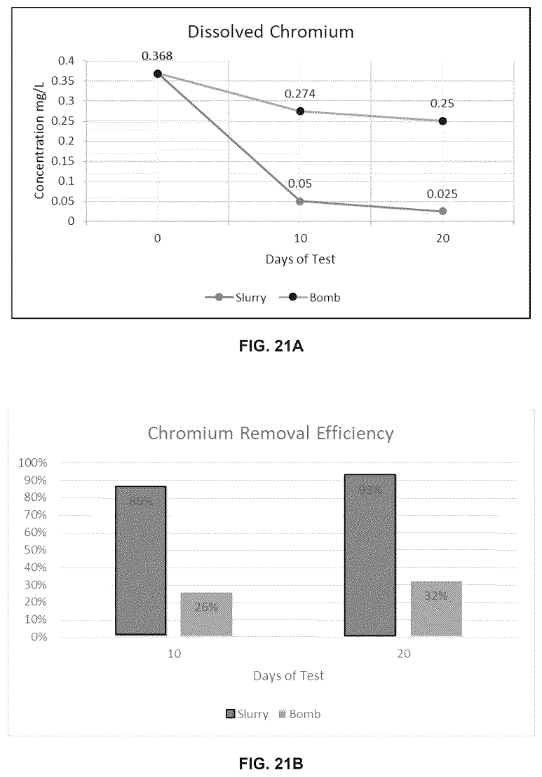

The concentration of chromium in both samples was reduced over time. As was expected, the concentration reduction in the test with slurry was quick and the residual concentrations in this test were lower than the residual dissolved chromium in the ball method. FIG. 21A shows the dissolved chromium concentration in feed water and the treated samples with both slurry and ball and FIG. 21B shows the chromium removal efficiency.

The concentration of chromium in both analyses for the water samples from the slurry and the ball after 20 days was reported below the lab reading limit. Therefore, the reported removal efficiencies do not have quantitative meaning and they should be considered as an indication of the total removal.

Based on the collected information, the slurry formulation removed more than 86% of the chromium in the feed water (0.368 mg/L) and produced water with less than 0.05 mg/L of chromium. In addition, by continuing the process for another 10 days, the removal efficiency increased to 93% by reducing the chromium concentration to less than 0.025 mg/L. On the contrary, the ball method showed lower removal efficiency and in 10 days removed only 26% of the chromium. The longer test duration worked in favour of the ball and increased the removal efficiency to 33%.

### Cobalt

FIG. 22A shows the dissolved cobalt concentration in feed water and the treated samples with both slurry and ball and FIG. 22B shows the cobalt removal efficiency.

The concentration of dissolved cobalt in the treated water with the slurry solution was reduced over time, while the same concentration was increased in the treated water by the ball. The slurry reagent removed 85% of the dissolved cobalt and reduced the cobalt concentration from 100 mg/L to 14.6 mg/L. The dissolved cobalt reduction could be due to the formation of cobalt hydroxide by a replacement reaction between magnesium hydroxide and cobalt sulphate in the water.

On the contrary, the concentration of the dissolved cobalt in the treated water by the ball increased over time. The change in the concentration of dissolved cobalt in this test showed the fact that cobalt was not involved with a replacement reaction when the reagent was introduced as the ball. As was discussed in the calcium section, this pseudo increase in the concentration of some elements such as cobalt was attributed to the absence of element removal caused by water evaporation.

### Copper

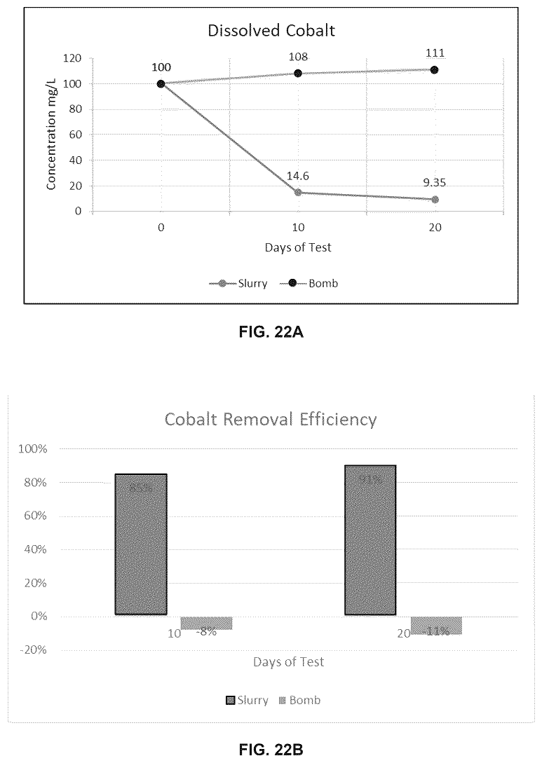

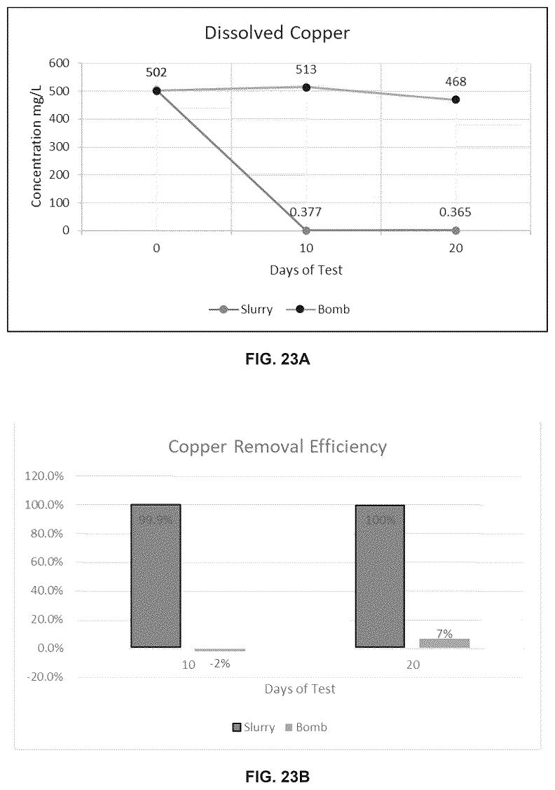

FIG. 23A shows the dissolved copper concentration in feed water and the treated samples with both slurry and ball and FIG. 23B shows the copper removal efficiency.

The concentration of dissolved copper in the treated water with the slurry solution was reduced over time, while the same concentration fluctuated in the treated water by the ball. The slurry reagent removed 100% of the dissolved copper and reduced the copper concentration from 502 mg/L to 0.365 mg/L. The dissolved copper reduction could be due to the replacement reaction between magnesium hydroxide and copper sulphate in the water.

On the contrary, the concentration of the dissolved copper in the treated water by the ball increased during the first 10 days of the test. The change in the concentration of dissolved copper in this test might be the result of evaporation as explained in the previous section. However, after providing additional 10 days, the copper concentration declined. Thus, the rate of reaction between copper sulphate and magnesium hydroxide surpassed the evaporation rate and the dissolved copper elimination became visible despite the water evaporation.

### Iron

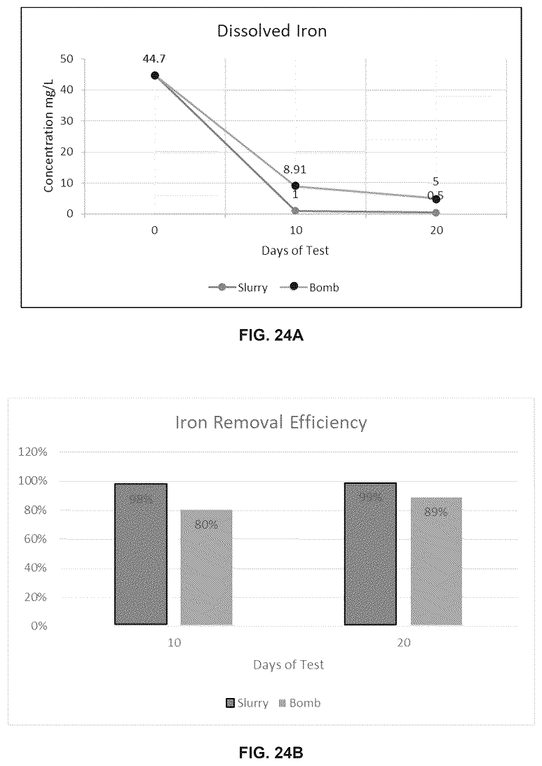

FIG. 24A shows the dissolved iron concentration in feed water and the treated samples with both slurry and ball and FIG. 24B shows the iron removal efficiency.

Although the concentration of iron in both samples was reduced over time, the concentration reduction in the test with slurry was remarkably quick and the residual concentrations were below the reading limit for the analysis.

Based on the collected information the slurry method could remove more than 98% of the iron in the feed water (44.7 mg/L) and produced water with less than 1.00 mg/L of iron. In addition, by continuing the process for another 10 days, the removal efficiency increased by reducing the iron concentration to less than 0.5 mg/L. On the contrary, the ball method showed lower removal efficiency and in 10 days removed only 80% of the iron. The longer test duration worked in favour of the ball and increased the removal efficiency to 89%, but still, the ball removal efficiency was significantly lower than the slurry.

### Manganese

FIG. 25A shows the dissolved manganese concentration in feed water and the treated samples with both slurry and ball and FIG. 25B shows the manganese removal efficiency.

Manganese showed different behaviour in the two tests. The dissolved concentration of manganese dropped significantly in the treated water with the slurry, and the initial manganese concentration of 1.47 mg/L was reduced to 0.241 mg/L after 10 days and then reduced to 0.136 mg/L after 20 days. The reduction of manganese in this test showed 84% and 91% removal efficiency subsequently.

On the contrary, the use of the ball in the test increased the concentration of dissolved manganese in the water. The initial concentration of the dissolved manganese in the water (1.47 mg/L) was increased to 1.58 mg/L after 10 days of the test and reached 1.65 mg/L after 20 days of the test. As discussed earlier, the increase in the dissolved concentration of manganese in the water could be due to water evaporation.

### Nickel

FIG. 26A shows the dissolved nickel concentration in feed water and the treated samples with both slurry and ball and FIG. 26B shows the nickel removal efficiency.

The behaviour of dissolved nickel in the water was similar to that of manganese. The dissolved concentration of nickel showed a significant drop in the test with slurry and the initial concentration of nickel in the feed water (2170 mg/L) was reduced to 340 mg/L after 10 days and to 203 mg/L after 20 days. Those reductions represent 84% and 91% removal efficiency in 10 and 20 days periods, respectively.

Similar to the manganese, the use of a ball in the test increased the concentration of dissolved nickel in the water. The initial concentration of the dissolved nickel in the water (2170 mg/L) was increased to 2360 mg/L after 10 days and stayed at the same level after 20 days. As was discussed the increase in the dissolved concentration of nickel in the water could be due to water evaporation.

### Magnesium

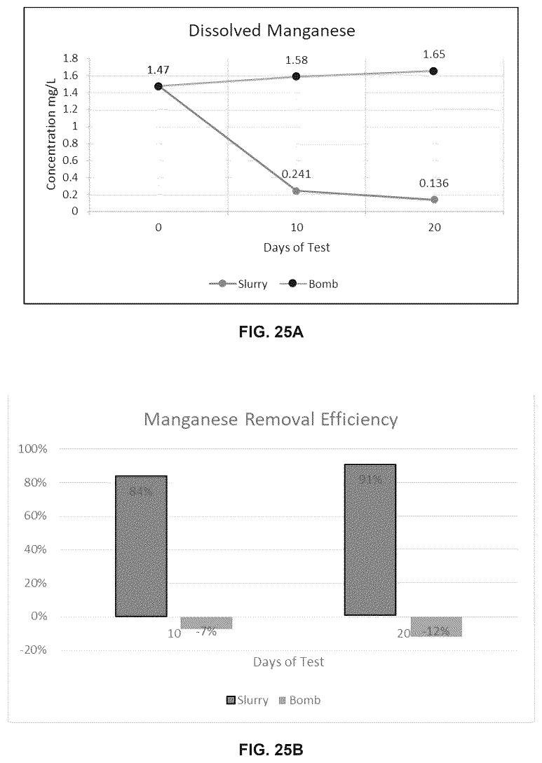

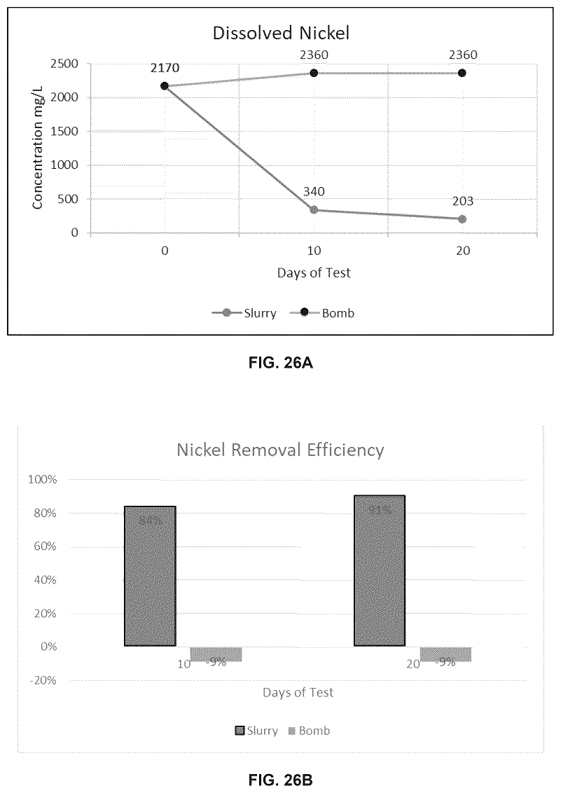

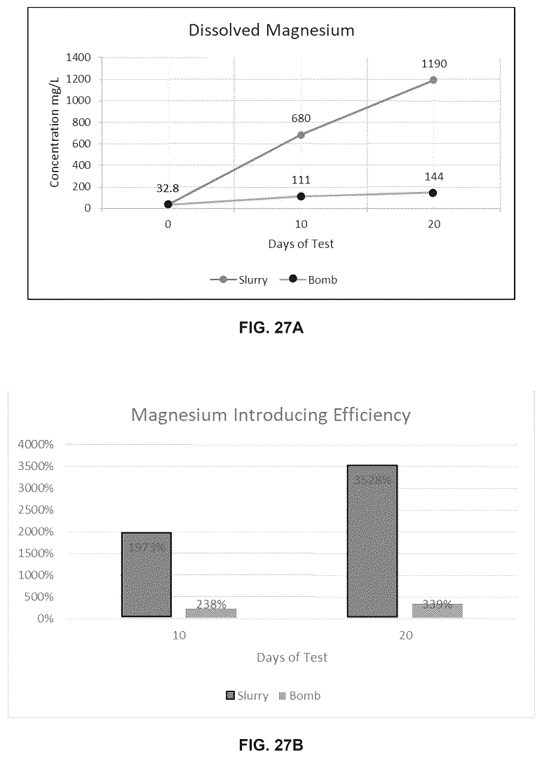

FIG. 27A shows the dissolved magnesium concentration in feed water and the treated samples with both slurry and ball and FIG. 27B shows the magnesium introducing efficiency.

The dissolved concentration of magnesium, one of the main components in the formulations, increases by adding the reagent to the feed water. By using the slurry method, a significant amount of magnesium was converted to dissolved magnesium and the magnesium concentration was increased by an order of magnitude. The dissolved concentration of the magnesium in the feed (32.8 mg/L) reached 680 mg/L after 10 days and 1,190 mg/L after 20 days.

On the other hand, the ball method had a limited impact on the concentration of dissolved magnesium in the treated water. The concentration of dissolved magnesium in the treated water with the ball after 10 days of the test was 111 mg/L, which was six times smaller than the dissolved concentration of magnesium in the slurry at the same time. The concentration difference between the two tests became larger after 20 days and the dissolved concentration of magnesium in the treated water with the ball reached 144 mg/L, which was significantly smaller than the 1,190 mg/L of magnesium in the treated water by slurry.

### Sodium

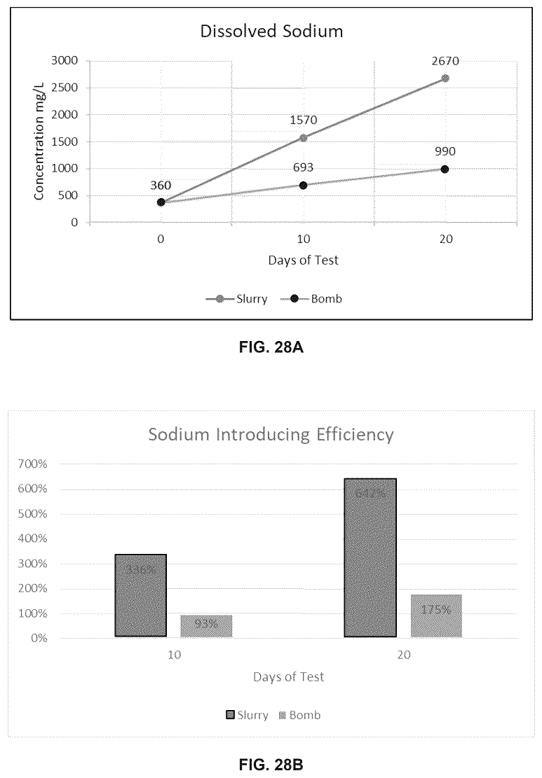

FIG. 28A shows the dissolved sodium concentration in feed water and the treated samples with both slurry and ball and FIG. 28B shows the sodium introducing efficiency.

The dissolved concentration of sodium, the other main component in the formulations, increases by adding the reagent to the feed water. By using the slurry method a significant amount of sodium was converted to dissolved sodium, so the sodium concentration was significantly increased. The dissolved concentration of the sodium in the feed (360 mg/L) reached 1,570 mg/L after 10 days and 2,670 mg/L after 20 days.

The ball method, however, had a limited impact on the concentration of dissolved sodium in the treated water. The concentration of dissolved sodium in the treated water with the ball after 10 days was 693 mg/L, which was almost one-third of the dissolved concentration of sodium in the slurry at the same time. The concentration difference between the two tests became larger after 20 days and the dissolved concentration of sodium in the treated water with the ball reached 990 mg/L, which was significantly smaller than the 2,670 mg/L of sodium in the treated water by slurry.

### Sulphur

The replacement reaction between metal sulphates and magnesium hydroxide produces metal hydroxides with low solubility and soluble magnesium sulphate. This replacement reaction increases the dissolved concentration of the sulphate in the water. Also, the existence of sodium bicarbonate in the formulations increases sodium concentration in the water by releasing carbon dioxide while converting metal sulphates to metal hydroxides. The high solubility of the sodium sulphate is another reason for converting suspended sulphate to dissolved sulphate. Therefore, it was expected to observe a high concentration of sulphur in the treated water. The concentration of dissolved sulphur in the treated water could be an indicator of the reaction progress.

FIG. 29A shows the dissolved sulphur concentration in feed water and the treated samples with both slurry and ball and FIG. 29B shows the sulphur introducing efficiency.

The sulphur concentration in both tests increased with time; however, the dissolved concentration of the sulphur in the water treated with the slurry was significantly higher than the dissolved concentration of sulphur in the feed water. The redissolving efficiency of the sulphur in the slurry test reached 58%.

Although sulphur, or sulphate as it is the dominant form of sulphur in the acidic feed, was not a treatment target in this study, precipitation of the calcium and other metal sulphates in this process would increase the quantity of the generated sludge and harm the quality (and the economy) of the potential valuable metals recovery. Therefore a high percentage of redissolving sulphur could have an important impact on the success of the selected process.

pH

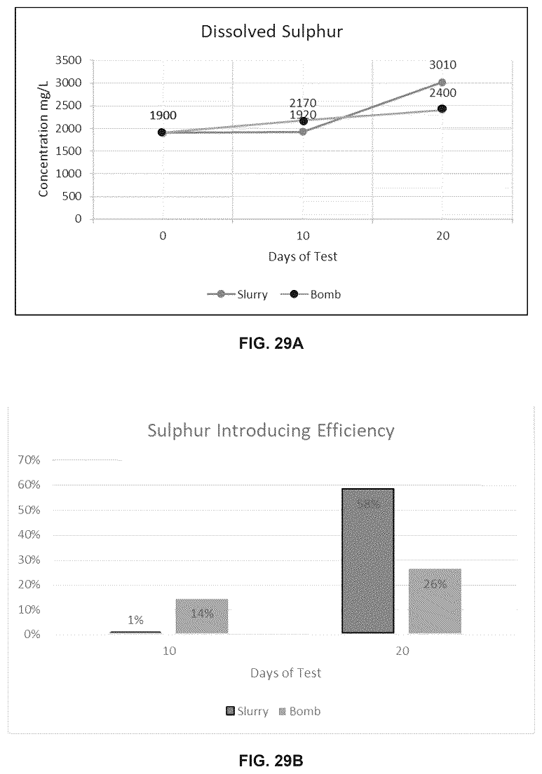

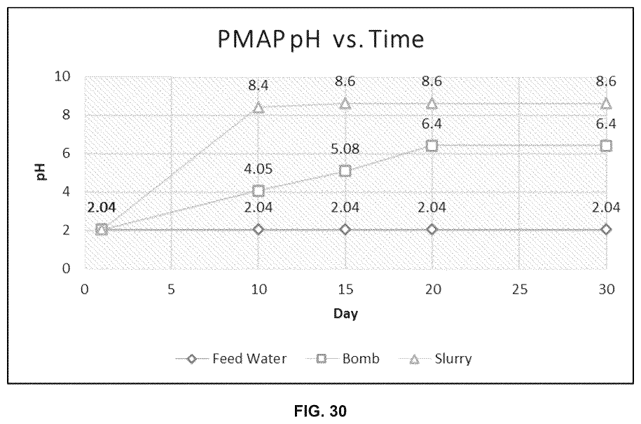

The pH of treated water is a crucial parameter for discharging it into the receiving environment and in determining whether it is a non-hazardous liquid. Therefore, the impact of the reagent delivery format on the pH of the treated water was investigated. FIG. 30 shows the pH of the treated water for both tests over time. The change of pH in the slurry was quick and the pH of the treated water reached 8.4 in 10 days and stabilized at 8.6 after 15 days of the test.

On the other hand, the pH of treated water with the ball changed slowly and reached 4.05 after 10 days. The change in the pH continued in the test and after 20 days, the maximum absorbed pH was 6.4. The treated water with the ball did not reach the dischargeable pH and required polishing before discharging into the environment. This slow change in the pH also created the selective precipitation opportunity. As discussed above, the ball method removed a high percentage of arsenic and iron while keeping nickel, copper and cobalt almost unchanged. By using the ball method, it would be possible to remove arsenic and iron and pass the overflow to a lime (or similar precipitation) treatment facility to precipitate the target metals in arsenic and iron-free sludge.

### Conclusion

The conducted tests showed that using the formulation as a slurry had tangible advantages and could remove a high percentage of the common contaminants of concern in 20 days or less without requiring additional actions such as mixing or heating. The conducted test with reagent slurry (generated by mixing reagent powder with the feed water) proved the ability of the treatment method to remove more than 91% of nickel, cobalt and manganese, 93% of chromium, 99% aluminum, 99.9% copper, iron and arsenic while redissolving 58% of the sulphur. The metal removal occurred at a pH of around 8.5 and the treated water after this process was dischargeable without further pH adjustment.

On the other hand, the use of the reagent in the form of a ball has an impact on the quality of the treated water. Based on the conducted tests with the ball, it was concluded that the ball could remove almost 97% of the arsenic, 89% of the iron, 63% of the aluminum and 32% of chromium in the water while having little or no impact on the other elements such as nickel, copper and cobalt, and the pH of the treated water did not go above 6.4. Without wishing to be bound by theory, this behaviour of the reagent ball could be due to either limited access to the magnesium oxide from the surface of the ball, which caused slow and limited changes in the pH of the reaction environment, or the different removal mechanisms such as absorption under this condition. Although the ball method did not have an overall high removal efficiency for all contaminants, it unveiled a selective precipitation opportunity for contaminants such as iron and arsenic.

As noted above, the evaporation of water from the beakers caused a pseudo increase in the dissolved concentration of the elements by a minimum of 12% when there wasn't any removal in the system. This observation justified several increases in the concentration of the elements (that were not removed) in the ball test. Also, considering the similar evaporation impact on the slurry test would unveil the fact that the actual removal efficiencies in the slurry test should be 10-12% higher than the reported numbers and the elements' concentrations were increased due to losing 12% of the water volume.

In both cases, the existence of sodium bicarbonate and its percentage in the reagent formula may influence the availability of magnesium oxide for reaction or the surface area for the adsorption process. The percentage of sodium bicarbonate used in the formulation could be a function of the water quality and potentially the reagent ball diameter.

### Example 4: Evaluation of Combination Treatments

### Test Water

The feed water used in the test originated from a mining tailing pond with existing contamination. To ensure meaningful and measurable outcomes, salts of critical metals in the form of sulphate were added to the solution, increasing the concentration of the targeted contaminants to a tangible and traceable level. The metals added to the original wastewater included aluminum, iron, cadmium, cobalt, chromium, zinc, titanium, and lithium.

Since the pH of the synthetic wastewater closely matched that of the original wastewater (~pH 2), no pH adjustment through the addition of acid or alkalinity was necessary for this test. Table 6 provides the dissolved concentrations of the key elements of concern in the synthetic feed water.

TABLE 6

| Parameter | Feed (mg/L) |
|---|---|
| pH | 2.04 |
| Aluminum, dissolved | 40.5 |
| Cadmium, dissolved | 557 |
| Cobalt, dissolved | 970 |
| Copper, dissolved | 1990 |
| Iron, dissolved | 100 |
| Lead, dissolved | 0.2 |
| Lithium, dissolved | 5.74 |
| Magnesium, dissolved | 31 |
| Manganese, dissolved | 1.15 |
| Nickel, dissolved | 4150 |
| Selenium, dissolved | 0.854 |
| Sulfur, dissolved | 4710 |
| Zinc, dissolved | 449 |

Sulphur exhibited the highest dissolved concentration of contaminants in the water, measuring 4710 mg/L. Nickel and copper followed with dissolved concentrations of 4150 mg/L and 1990 mg/L, respectively. Although sulphur is not typically a primary element of concern, the excessive amount of sulphur (or sulphate, as it is the dominant form in this environment) can react with calcium to form gypsum. The formation of gypsum during the treatment process not only increases the volume of generated sludge but also leads to scaling issues in pipes and treatment equipment. Therefore, the concentration of sulphur in both the liquid and solid phases was measured.

### Method

### Baseline—Sodium Hydroxide or Lime

An objective of the baseline tests was to determine the maximum potential removal efficiency for each metal using traditional lime and sodium hydroxide treatment methods. Additionally, the volume of sludge generated by each process was assessed and its composition analyzed.

For the sodium hydroxide test, 1 L of the feed water was transferred to a 2 L beaker equipped with a magnetic mixer. A sufficient amount of 1N sodium hydroxide solution was added to the beaker to adjust the pH of the solution to 9.0. After reaching the target pH, the solution was mixed for 5 minutes before stopping the mixing. Following the reaction, sufficient settling time was provided to allow a clear layer of treated water to form on top of the beaker. A dissolved metals sample was collected, and after overnight settling, the volume of the sludge was measured. The generated sludge was then separated from the solution using a 20 μm filter paper. The collected sludge was dried overnight, and the total weight of the generated sludge was recorded before being sent to the analytical lab.

The test procedure for lime was similar to the sodium hydroxide test. However, due to the limited reactivity of lime, the reaction time after reaching pH 9 was increased to 60 minutes. Additionally, in the lime test, due to the high settling tendency of the generated sludge, the overnight settling period was reduced to 60 minutes.

### Pretreatment Formulation

The test formulation was composed of 90% magnesium oxide, 9% sodium bicarbonate and 1% chitosan acetate (1% solution in acetic acid). The test formulation is referred to interchangeably throughout this example as the “PMAP reagent”.

Eight beakers, labelled as 2.5, 5, 7.5, 10, 12.5, 15, 17.5, and 20, were each filled with 1.5 L of the feed water. Then, 50 mL of the feed water from each beaker was mixed with the test formulation (PMAP reagent in powder form) according to the values presented in Table 7 to form a slurry. The PMAP reagent slurry was then returned to the respective beaker.

TABLE 7

| | | | | | | | | |
|---|---|---|---|---|---|---|---|---|
| Label | 2.5 | 5 | 7.5 | 10 | 12.5 | 15 | 17.5 | 20 |
| Solid (g) | 3.75 | 7.5 | 11.25 | 15 | 18.75 | 22.5 | 26.25 | 30 |

The pH of the beakers was monitored, and dissolved metal samples were collected from each beaker every 5 days. On the 20th day, after collecting the dissolved samples, 1 L of the overflow from each beaker was transferred to a 2 L beaker. The water was neutralized to pH 9.0 using a 10% lime solution with a 1-hour reaction time in a mixed reactor and a further 1-hour settling time. A sample of water containing dissolved metals was collected from each beaker with the neutralized lime water and submitted to the analytical lab. The generated sludges from the primary neutralization with the PMAP formulation and the secondary neutralization with lime were filtered separately using a 20 μm filter paper. The filtered solids were dried overnight in the oven. After 24 hours, the solids from each test were weighed and submitted to the lab for metal content analysis.

pH

The pH of each solution was measured and recorded at five-day intervals. The recorded pH values during the test, as well as the final pH of the overflow after lime treatment, are presented in Table 8.

The pH of the solutions gradually increased over time, reflecting the ongoing reaction between the test formulation and the acidic water. Moreover, a higher quantity of the test formulation led to a faster increase in pH, resulting in a higher final pH value. However, due to the limited availability of the injected test formulation for the reaction, the pH curves eventually reached a plateau after several days.

TABLE 8

| | | | | | | pH |
|---|---|---|---|---|---|---|
| | pH | pH | pH | pH | pH | Treated |
| Label | Day 0 | Day 5 | Day 10 | Day 15 | Day 20 | overflow |
| 2.5 | 3.6 | 3.71 | 3.86 | 4.05 | 4.2 | 9 |
| 5 | 3.93 | 4.04 | 4.3 | 4.58 | 4.56 | 9 |
| 7.5 | 4.02 | 4.25 | 4.4 | 4.61 | 4.70 | 9 |
| 10 | 4.1 | 4.57 | 4.8 | 5.02 | 5.10 | 9 |
| 12.5 | 4.31 | 4.65 | 4.8 | 5.06 | 5.18 | 9 |
| 15 | 4.44 | 5.23 | 5.6 | 5.75 | 5.77 | 9 |
| 17.5 | 4.27 | 5 | 5.3 | 5.47 | 5.50 | 9 |
| 20 | 4.38 | 5.18 | 5.5 | 5.78 | 5.75 | 9 |

### Reagent Consumption

### Lime Consumption

The lime consumption required to neutralize the generated overflow from the pretreatment is shown in Table 9. The amount of PMAP reagent used in the pretreatment directly influenced the lime consumption during the final neutralization process. However, the rate of decline in lime consumption slowed down when PMAP reagent consumption exceeded 10 g/L, and the reduction in lime consumption remained within the range of 77%±20%. This means that by increasing the pretreatment PMAP reagent from 10 g/L to 20 g/L, the lime consumption decreased from 3.5 to 2.75.

TABLE 9

| | | | | Solid | |
|---|---|---|---|---|---|
| | Final | | Lime (ml)/ | lime g/L | Overflow |
| Label | pH | Sludge (g) | L overflow | overflow (g) | sludge (g) |
| 2.5 | 4.2 | Missing | 85 | 8.50 | 35.12 |
| 5 | 4.56 | 19.6 | 55.0 | 5.50 | 44.95 |
| 7.5 | 4.7 | 25.8 | 43.5 | 4.35 | 26.50 |
| 10 | 5.1 | 28.6 | 35.0 | 3.50 | 20.97 |
| 12.5 | 5.18 | 31.8 | 32.5 | 3.25 | 14.83 |
| 15 | 5.77 | 37.6 | 30.0 | 3.00 | 11.14 |
| 17.5 | 5.5 | 40.2 | 30.0 | 3.00 | 6.01 |
| 20 | 5.75 | 43.0 | 27.5 | 2.75 | 3.77 |
| Lime only | 9 | 0 | 134 | 13.40 | 87.23 |
| NaOH only | 9 | 0 | 272 | 10.88 | 59.66 |

### Overall Reagent Consumption

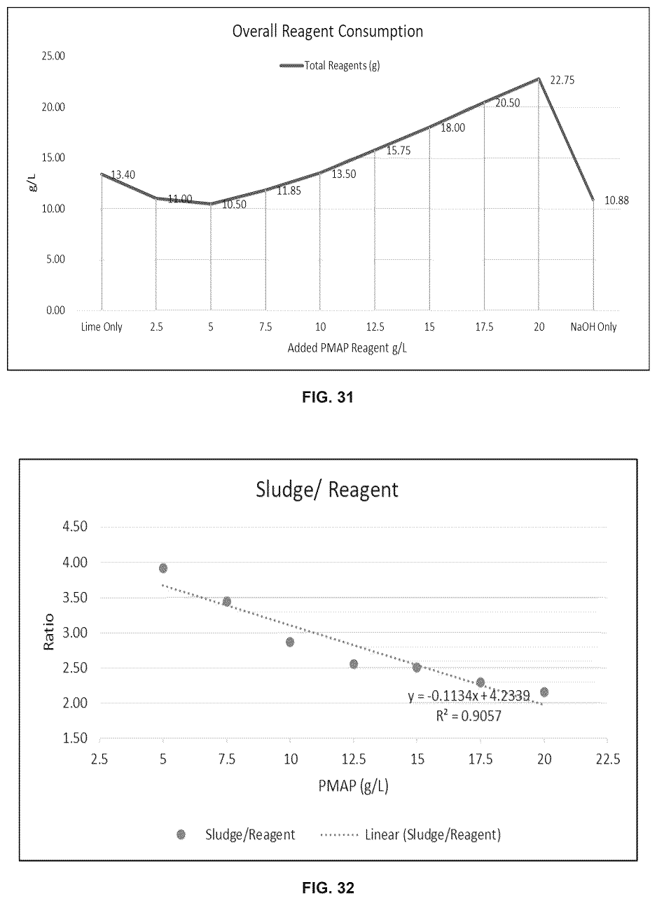

The overall reagent consumption at various dosages of PMAP reagent is shown in FIG. 31, which shows that the optimal reduction in lime consumption does not necessarily align with the optimal total reagent consumption. For instance, when using 10 g/L of pretreatment PMAP reagent, the required lime consumption is reduced to 3.5 g/L, which is nearly the lowest lime consumption possible. However, the total mass of reagents in this case would be 13.5 g/L (10 g/L PMAP+3.5 g/L lime). This reagent consumption is almost equivalent to the lime-only neutralization process where 13.4 g/L of lime is used. It was found that the overall reagent consumption was minimized when 5 g/L of pretreatment formulation was added to the feed water. At this point, despite utilizing 5.5 g/L of lime, which exceeds the minimum lime consumption, the overall reagent consumption remained the lowest among all the conducted tests due to the lower dosage of pretreatment formulation.

### Sludge Generation

As shown in Table 9 above, the generated sludge from the pretreatment process showed a direct correlation with the injected pretreatment formulation amount. However, the sludge-to-reagent ratio decreased from 3.92 to 2.15 as the pretreatment formulation dosage increased. FIG. 32 depicts the decline in the sludge-to-reagent ratio, indicating the negative impact of excessive reagent and the potential increase in unreacted (unutilized) reagent. It was also found that different dosages of injected pretreatment formulation also directly influenced the overall sludge generation rate during the treatment process.

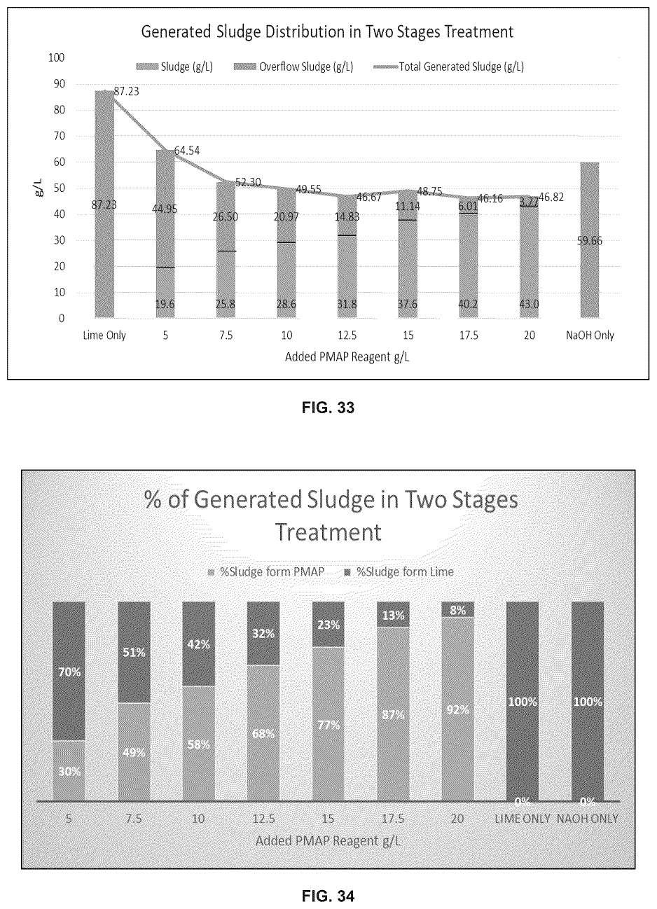

FIG. 33 illustrates the total sludge generation in both treatment steps with varying pretreatment formulation dosages. The highest sludge amount (87.23 g/L) was generated when only lime was used as the neutralization reagent (13.4 g/L lime—see Table 9), and the overall sludge generation decreased with increasing pretreatment formulation dosage. FIG. 33 shows that as the injected pretreatment formulation reagent amount increased, the contribution of lime sludge to the overall generated sludge continuously decreased. However, the overall sludge generation remained nearly constant beyond a pretreatment formulation dosage of 10 g/L. This stability in the overall mass of generated sludge, despite the reduction in lime sludge, may be attributed to the presence of unutilized pretreatment formulation reagent after a certain dosage.

FIG. 34 demonstrates that increasing the pretreatment formulation dosage leads to a decrease in the volume of generated sludge in the active lime treatment.

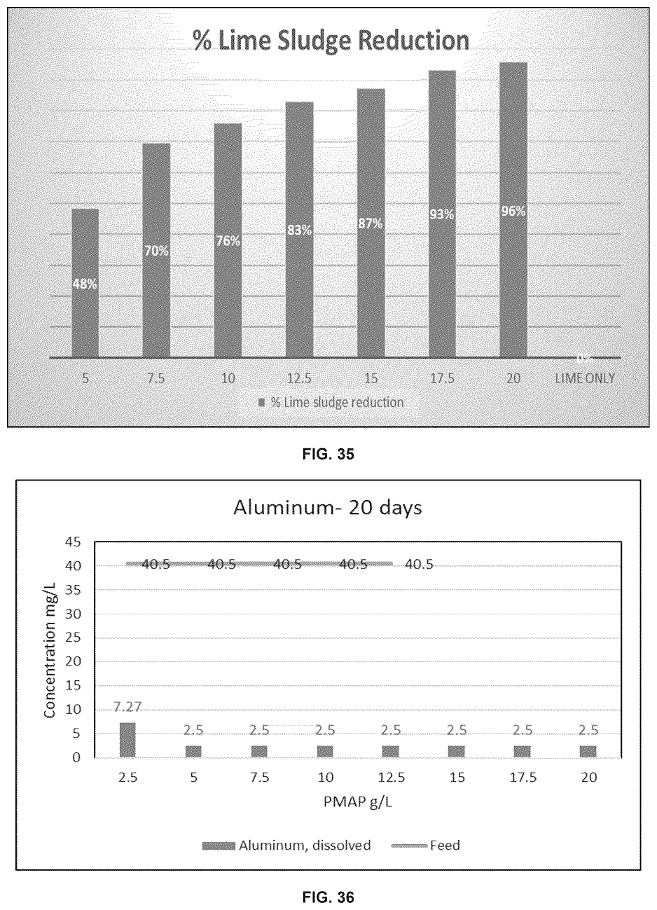

It is important to note that the sludge generated from lime treatment requires immediate handling, impacting the operating cost of the treatment process. On the other hand, the sludge generated from the pretreatment process settles at the bottom of the pond and only affects the financial aspects of the mine operation during pond dewatering or dragging. FIG. 35 illustrates the reduction in lime sludge observed when employing the two-stage process compared to the sludge generated from the lime-only neutralization process.

### Metal Removal Efficiency

Analytical results for each element of concern are presented below to understand the impact of the pretreatment PMAP reagent on each element, both with and without overflow treatment with lime. Sludge composition was also analyzed with a view to determining the potential for generating sludges containing specific percentages of valuable metals. The assessment was conducted for both of the generated sludges in the two-stage treatment process.

### Aluminum

### Liquid Phase

### (a) Effect of Pretreatment Reagent Quantity

FIG. 36 shows concentrations of aluminum in the liquid phase after 20 days at different dosages of the pretreatment neutralization formulation (PMAP reagent). The aluminum concentration in the feed was reduced from 40.5 mg/L to less than 2.5 mg/L for all dosages, except for the test with 2.5 g/L of PMAP reagent. In the test involving 2.5 g/L of PMAP reagent, the final aluminum concentration was lowered to 7.27 mg/L, indicating an aluminum removal efficiency of 82%. In contrast, the other tests demonstrated a minimum removal efficiency of 94%. These findings highlight that the majority of aluminum can be precipitated in the pretreatment process if an adequate retention time is provided.

These results emphasize the effectiveness of the pretreatment process in reducing aluminum concentrations, with the majority of dosages achieving a removal efficiency of over 94%.

### (b) Effect of Pretreatment Duration

FIG. 37 shows the aluminum concentration over time in two separate tests: one with 2.5 g/L (FIG. 37A) and the other with 20 g/L (FIG. 37B) of PMAP reagent. In FIG. 37A, it is evident that the aluminum concentration decreases gradually over time when a small dosage of 2.5 g/L of pretreatment PMAP reagent is employed per litre of the feed water. This indicates that the aluminum concentration in both the water and the resulting sludge can be effectively controlled by injecting a relatively low dosage of PMAP reagent and ensuring an appropriate retention/reaction time. On the other hand, FIG. 37B demonstrates that a significant and rapid reduction in aluminum concentration can be achieved by adding a higher dosage of PMAP reagent at the beginning of the process. This approach enables the quick removal of aluminum within a short period.

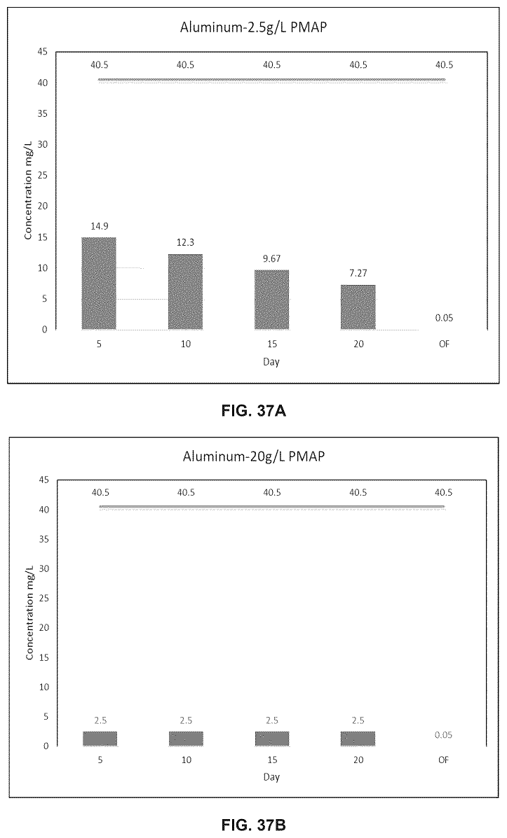

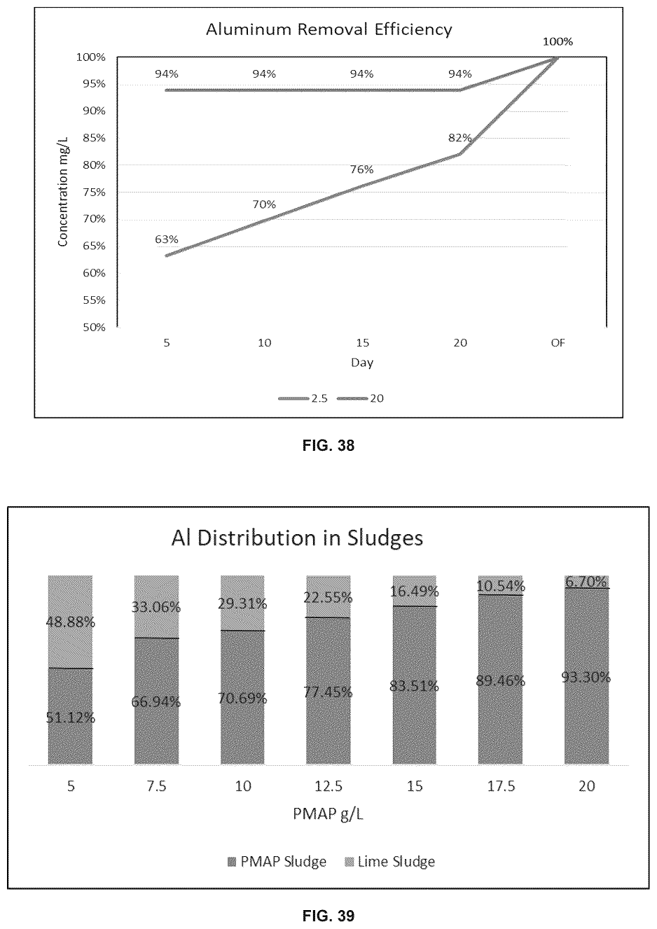

FIG. 38 shows the aluminum removal efficiency in tests conducted with 2.5 g/L and 20 g/L of pretreatment reagent. These dosages were selected as lower and upper boundaries for the test, but similar trends can be observed with other dosages of the pretreatment reagent. As depicted, the removal efficiency of aluminum increased from 63% to 82% between days five and twenty in the test with 2.5 g/L. In contrast, the test with 20 g/L of the reagent exhibited a minimum aluminum removal efficiency of 94% right from the beginning. These findings indicate that higher dosages of the pretreatment reagent can achieve more rapid and efficient aluminum removal, while even a lower dosage of 2.5 g/L can gradually reduce the aluminum concentration over time.

### (c) Effect of Overflow Treatment

As depicted in FIGS. 37A and 37B, irrespective of the dosage of the PMAP reagent used, the aluminum concentration after treating the overflow with lime was consistently found to be less than 0.05 mg/L. The notable distinction arises in the concentration of aluminum in the overflow from the pretreatment process, which is influenced by the dosage of the pretreatment reagent employed. This discrepancy is reflected in the total amount of precipitated aluminum present in the sludge resulting from the lime treatment.

### Solid Phase

The liquid analytical data demonstrated that a combination of the pretreatment neutralization process and lime neutralization effectively removed nearly 100% of the aluminum present in the water. FIG. 39 illustrates the distribution of aluminum between the pretreatment sludge and lime sludge at various dosages of the pretreatment reagent.

Despite maintaining a consistent aluminum concentration (<1,000 mg/Kg) in the sludge generated through the lime neutralization process, the proportion of aluminum mass in the lime sludge decreased. This reduction can be attributed to the decline in the volume of sludge produced as a result of the lime treatment. These findings mirror those observed in the liquid phase, revealing that the distribution of aluminum in the sludges can be regulated by adjusting the dosage of the injected pretreatment reagent.

### (a) Pretreatment Sludge

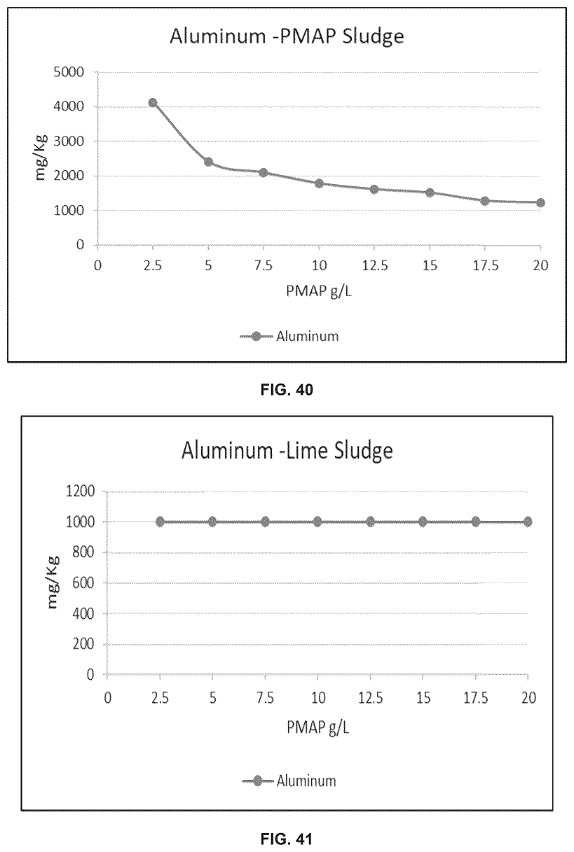

The composition of the generated sludge from the pretreatment process reveals that the precipitated aluminum accounts for only 0.41% or less. FIG. 40 illustrates the change in aluminum concentration within the pretreatment sludge at different dosages of the injected reagent. Despite the pretreatment process consistently removing aluminum from the liquid phase, the aluminum concentration within the pretreatment sludge decreases with an increase in the dosage of the pretreatment reagent. This decline can be attributed to the excessive volume of pretreatment sludge resulting from the unutilized pretreatment reagent.

### (b) Lime Sludge

Similar to the pretreatment sludge, the precipitated aluminum in the generated sludge from the lime neutralization process constitutes less than 0.10% of the overall sludge composition. FIG. 41 illustrates the relationship between the dosage of the injected pretreatment reagent and the aluminum concentration in the lime sludge. However, since the reported aluminum concentration is less than 1,000 mg/Kg, the curve does not indicate any meaningful relationship between the reagent used and the aluminum concentration in the lime sludge.

### Arsenic

### Liquid Phase

### (a) Effect of Pretreatment Reagent Quantity

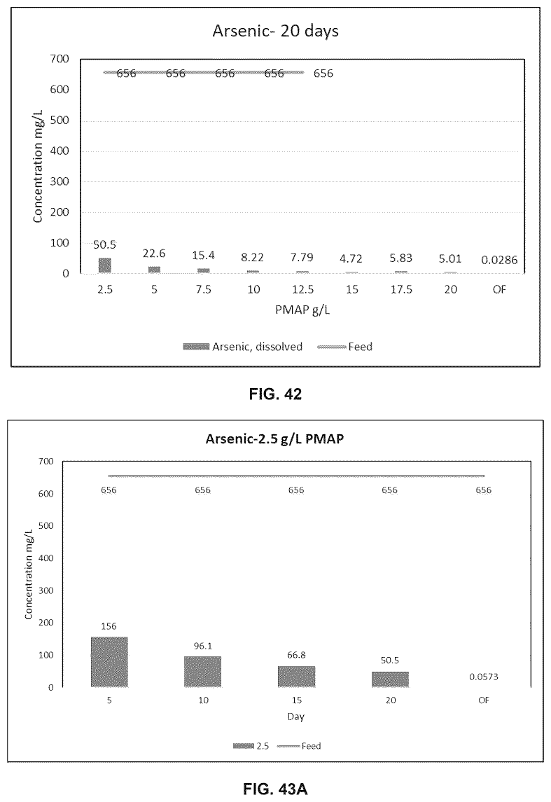

FIG. 42 shows concentrations of arsenic in the liquid phase after 20 days at different dosages of the pretreatment neutralization formulation (PMAP reagent). The initial arsenic concentration in the feed was reduced from 656 mg/L to values ranging between 50.5 mg/L and 5.01 mg/L for varying PMAP dosages. In the test using 2.5 g/L of PMAP reagent, the final arsenic concentration reached 50.5 mg/L, indicating a 92.3% arsenic removal efficiency. On the other hand, the removal efficiency for the solution containing 20 g/L of PMAP reagent was 99.2%. These results reveal that a significant portion of the arsenic can be precipitated in the dual-reagent process, even with a small dosage of the PMAP reagent.

### (b) Effect of Pretreatment Duration

FIG. 43 shows the arsenic concentration over time in tests using 2.5 g/L (left) and 20 g/L (right) of PMAP reagent. As shown in the FIG. 43A, the arsenic concentration decreases gradually over time when only 2.5 g/L of PMAP reagent is used. This implies that the concentration of arsenic in the water (and subsequently in the sludge) can be controlled by injecting a small dosage of PMAP reagent and selecting an appropriate retention/reaction time. On the other hand, by adding a sufficient amount of PMAP reagent at the beginning of the process, rapid removal of arsenic in a short period is achievable (FIG. 43B).

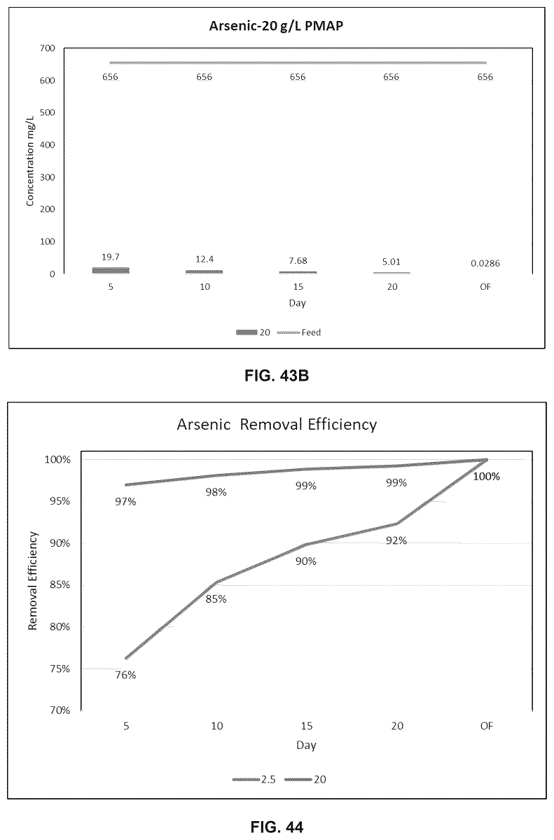

FIG. 44 presents the removal efficiency of arsenic using 2.5 g/L and 20 g/L of PMAP reagent. These values are used as the lower and upper boundaries in the conducted test, but similar curves can be obtained with other dosages of the PMAP reagent. As depicted, the arsenic removal efficiency increases from 76% to 92% from day five to twenty in the test with 2.5 g/L. Meanwhile, when 20 g/L of the reagent is used, the arsenic removal efficiency remains consistently high, with a minimum of 97% from the start of the process.

### (c) Effect of Overflow Treatment

As depicted in FIGS. 43A and 43B, it is evident that the concentration of arsenic in the treated overflow decreases as the dosage of the injected PMAP reagent increases during the initial stage. Comparing the residual arsenic concentrations in the treated overflow, the test with 2.5 g/L of PMAP reagent had a concentration of 0.0573 mg/L, which was nearly twice the concentration of residual arsenic (0.0286 mg/L) in the treated overflow when 20 g/L of PMAP reagent was used. Although the concentration difference between the two tests is small, it can be crucial for water discharge into the environment and meeting discharge requirements.

### Solid Phase

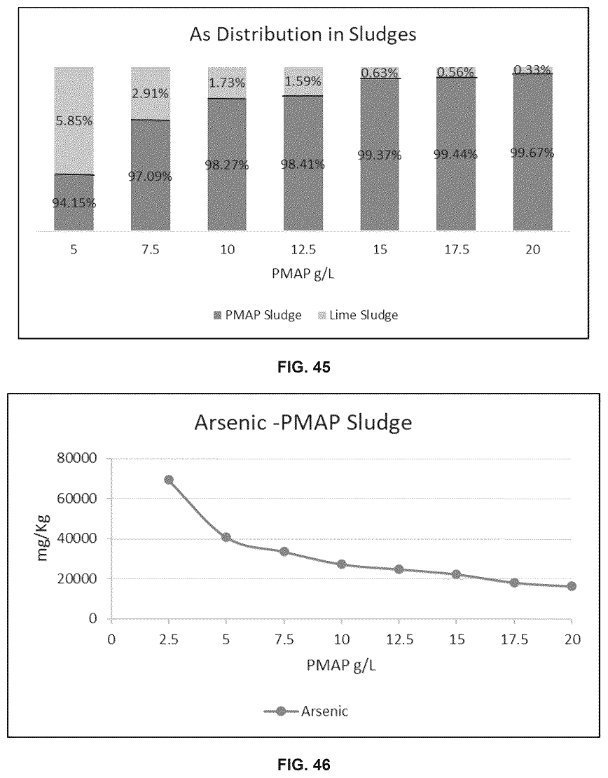

Considering that the liquid analytical data demonstrated the removal of almost 100% of the existing arsenic in the water through the combination of the PMAP process and lime neutralization, it was anticipated that the total mass of arsenic would be observed in the solid phases. FIG. 45 illustrates the distribution of arsenic between PMAP sludge and lime sludge at different dosages of the PMAP reagent. In the case of arsenic, both the concentration of arsenic and the volume of the generated sludge by lime treatment decrease with an increase in the dosage of the injected PMAP during the pretreatment step. Consequently, the percentage of the total mass of arsenic in the lime sludge decreases due to the improved arsenic removal efficiency achieved using PMAP and the reduced volume of sludge generated by lime treatment.

### (a) Pretreatment Sludge

The composition of the generated sludge from the PMAP pretreatment process reveals that the precipitated arsenic accounts for approximately 7% of the sludge composition at a PMAP dosage of 2.5 g/L. However, increasing the dosage of the injected PMAP reagent leads to a decline in this percentage. It can be inferred that the majority of the arsenic mass is precipitated even at lower dosages, and additional PMAP reagent only serves to dilute the concentration of arsenic in the solid phase.

The change in arsenic concentration within the PMAP sludge due to the dosage of the injected reagent is illustrated in FIG. 46. Despite the consistent removal of arsenic from the liquid phase in the PMAP process, the concentration of arsenic in the PMAP sludge decreases with an increase in the PMAP dosage. This decline is primarily attributed to the excessive volume of the PMAP sludge resulting from the unutilized PMAP reagent.

### (b) Lime Sludge

In the case of lime sludge, the precipitated arsenic from the lime neutralization process constitutes less than 0.18% of the overall sludge composition.

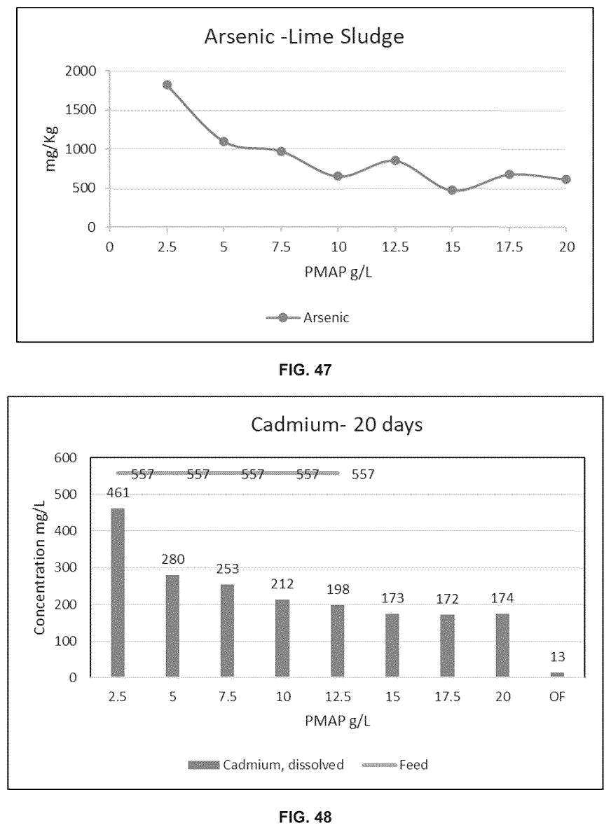

FIG. 47 illustrates the change in arsenic concentration within the lime sludge by the dosage of the injected PMAP reagent. The reduction in arsenic concentration at higher PMAP dosages reveals that increasing the PMAP reagent has a positive impact on arsenic removal through the PMAP process.

### Cadmium

### Liquid Phase

### (a) Effect of Pretreatment Reagent Quantity

FIG. 48 depicts the concentrations of cadmium in the liquid phase after 20 days at different dosages of the pretreatment neutralization formulation (PMAP reagent). The initial cadmium concentration in the feed (557 mg/L) was reduced to values ranging from 461 mg/L to 174 mg/L with varying PMAP dosages.

In the test utilizing 2.5 g/L of PMAP reagent, the final cadmium concentration reached 461 mg/L, indicating a cadmium removal efficiency of 17%. In contrast, the removal efficiency for the solution with 20 g/L of the PMAP reagent was 69%. These results highlight that the majority of cadmium can be precipitated in the PMAP process when a high dosage of the PMAP reagent is employed.

### (b) Effect of Pretreatment Duration

FIG. 49 illustrates the cadmium concentration over time in tests with 2.5 g/L (FIG. 49A) and 20 g/L (FIG. 49B) of PMAP reagent. As shown in the left graph, the concentration of cadmium remained relatively stable over time when only 2.5 g/L of PMAP reagent was used. This indicates that the concentration of cadmium in the water (and subsequently in the sludge) cannot be effectively controlled by injecting a small dosage of PMAP reagent, regardless of the reaction time. On the other hand, rapid removal of cadmium within a short period is possible by adding a sufficient amount of PMAP reagent at the beginning of the process. In the case of high-dosage injection, the reaction time can have a discernible impact on the cadmium concentration in the treated water.

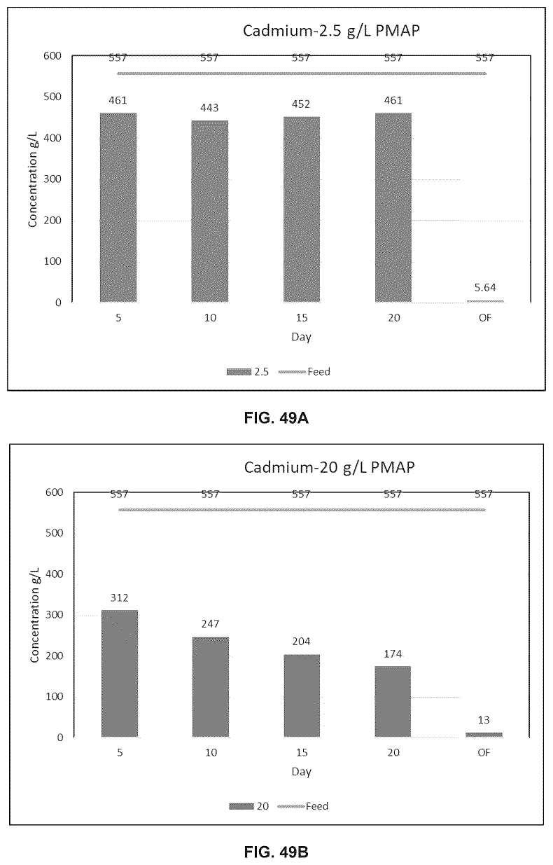

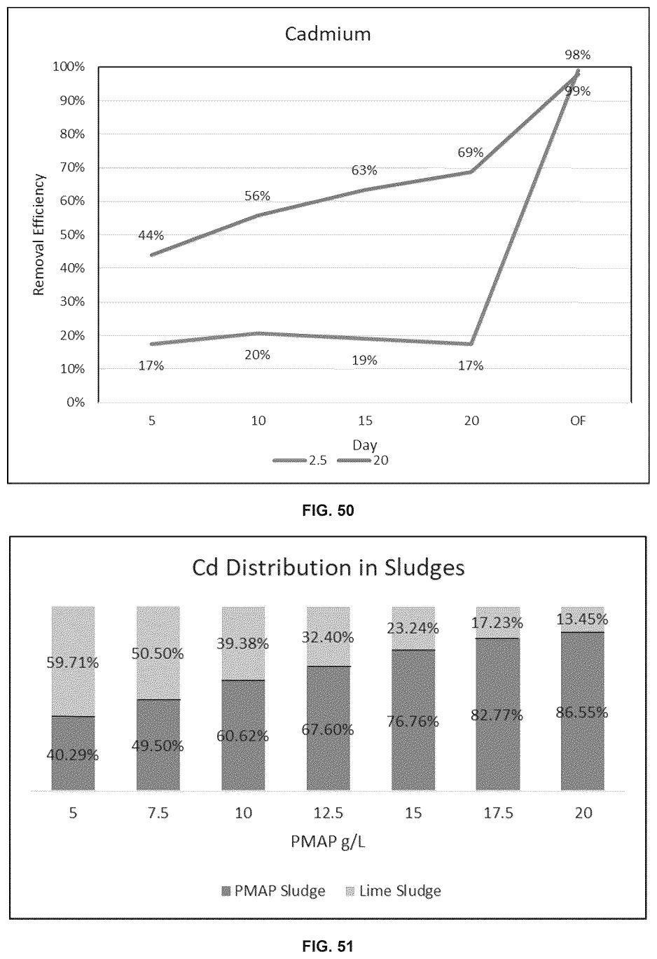

FIG. 50 illustrates the removal efficiency of cadmium with 2.5 g/L and 20 g/L of PMAP reagent. These values serve as the lower and upper boundaries in the conducted test, and similar curves can be generated for other dosages of the PMAP reagent. As shown, the removal efficiency of cadmium remains relatively constant over time when utilizing 2.5 g/L of PMAP reagent. In contrast, the cadmium removal efficiency increased from 44% to 69% when 20 g/L of the reagent was used.

### (c) Effect of Overflow Treatment

Both FIGS. 49A and 49B demonstrate that the concentration of cadmium in the treated overflow is significantly lower than the concentration in the treated water with the PMAP reagent. However, the residual cadmium concentration in the overflow after injecting 2.5 g/L of PMAP reagent (5.6 mg/L) is lower than the concentration after injecting 20 g/L of PMAP reagent (13 mg/L). This indicates a potential negative impact of excessive PMAP reagent on the overall performance of the two-stage treatment process. Although the concentration difference between the two tests is small, it could be crucial for water discharge into the environment and compliance with discharge requirements.

### Solid Phase

FIG. 51 illustrates the distribution of cadmium between the PMAP sludge and lime sludge at different dosages of the PMAP reagent. In the case of cadmium, both the concentrations of cadmium and the volume of sludge generated through lime treatment decreased with an increase in the dosage of the injected PMAP during the pre-treatment step. Consequently, the percentage of the total mass of cadmium in the lime sludge decreased due to improved cadmium removal efficiency with PMAP and the lower volume of sludge generated through lime treatment. Thus, by selecting the dosage of PMAP reagent, cadmium could be collected in the lime sludge (e.g. 2.5 g/L PMAP) or in the PMAP sludge (e.g. <10 g/L PMAP).

### (a) Pretreatment Sludge

The precipitated cadmium in the generated sludge through the PMAP process accounts for approximately 1.21% of the composition of the sludge when 2.5 g/L of PMAP reagent is used. However, as the dosage of injected PMAP reagent increases, this percentage decreases to 0.8% or lower. Considering the change in cadmium removal efficiency with an increase in the injected PMAP reagent, it can be inferred that the additional PMAP reagent enhances the removal efficiency, while the unused reagent dilutes the concentration of cadmium in the generated sludge from the PMAP process.

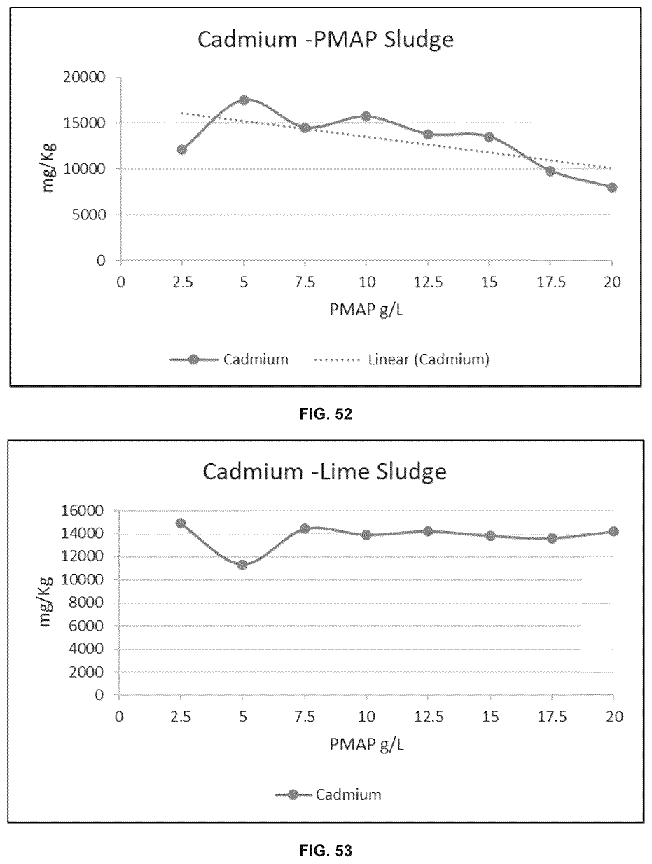

The change in cadmium concentration in the PMAP sludge with varying dosages of the injected reagent is illustrated in FIG. 52. Despite the increasing cadmium removal efficiency from the liquid phase in the PMAP process, the concentration of cadmium in the PMAP sludge decreases with an increase in the PMAP dosage. This decrease in cadmium concentration is primarily due to the excessive volume of PMAP sludge caused by the unused PMAP reagent.

### (b) Lime Sludge

The precipitated cadmium in the generated sludge through the lime neutralization process constitutes less than 1.5% of the composition of the sludge.

The change in cadmium concentration in the lime sludge with varying dosages of the injected PMAP reagent is shown in FIG. 53. The cadmium concentration (and percentage) in the lime sludge remains almost independent of the dosage of the injected PMAP reagent during the pre-treatment stage. However, despite the consistent cadmium concentration in the lime sludge, the overall mass of collected cadmium in the lime process is reduced as the PMAP dosage increases during the pre-treatment stage, owing to the reduction in the volume of lime sludge.

### Cobalt

### Liquid Phase

### (a) Effect of Pretreatment Reagent Quantity

FIG. 54 depicts the concentrations of cobalt in the liquid phase after 20 days at different dosages of pretreatment neutralization formulation (PMAP reagent). The cobalt concentration in the initial feed decreased from 970 mg/L to a range between 860 mg/L and 347 mg/L with varying dosages of PMAP reagent.

In the test using 2.5 g/L of PMAP reagent, the final cobalt concentration was reduced to 860 mg/L, indicating an 11% cobalt removal efficiency. In contrast, the removal efficiency reached 64% for the solution with 20 g/L of PMAP reagent. These results reveal that the majority of cobalt can be precipitated in the PMAP process when a higher dosage of PMAP reagent is employed.

### (b) Effect of Pretreatment Duration

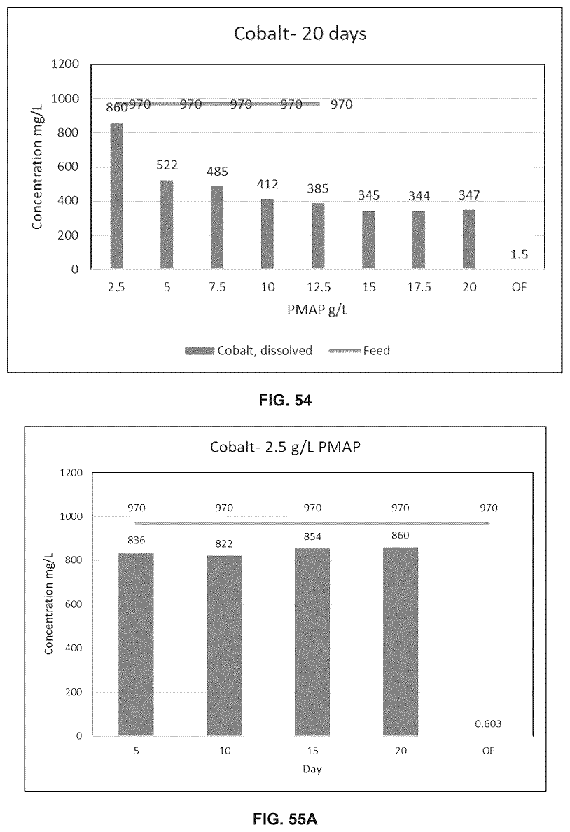

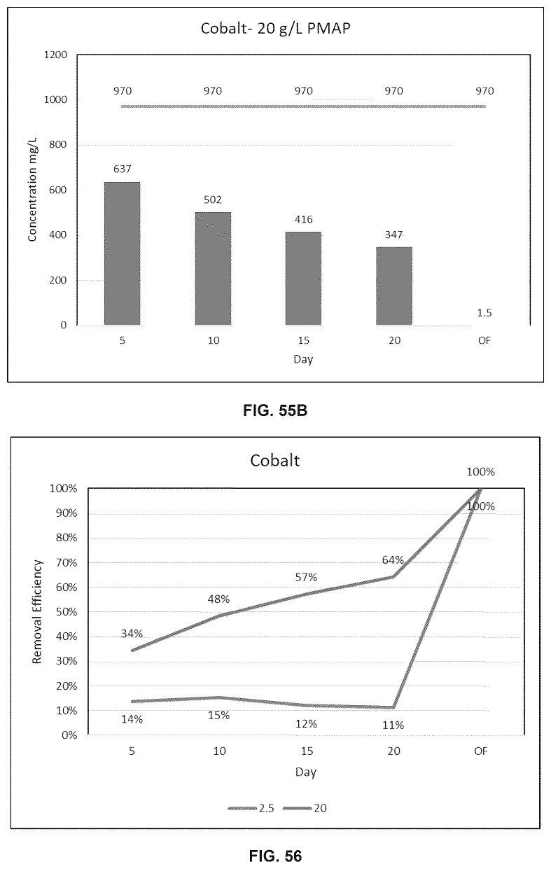

FIG. 55 illustrates the cobalt concentration over time in the tests with 2.5 g/L (FIG. 55A) and 20 g/L (FIG. 55B) of PMAP reagent. As shown in FIG. 55A, the concentration of cobalt did not change significantly over time when only 2.5 g/L of the PMAP formula was used. This indicates that the concentration of cobalt in the water (and subsequently in the sludge) cannot be effectively controlled by injecting a small dosage of PMAP reagent, regardless of the reaction time. However, when a sufficient amount of PMAP reagent is added at the beginning of the process, quick removal of cobalt within a short period becomes possible. In the case of high-dosage injection, the reaction time can have a tangible impact on the cobalt concentration in the treated water.

FIG. 56 presents the removal efficiency of cobalt using 2.5 g/L and 20 g/L of PMAP formula. These values serve as lower and upper boundaries in the conducted test, and similar curves can be produced by employing other dosages of the PMAP reagent. As shown, the removal efficiency of cobalt using 2.5 g/L of the PMAP reagent remains almost constant over time (or even declines). In contrast, the cobalt removal efficiency increases from 34% to 64% when 20 g/L of the reagent is used.

### (c) Effect of Overflow Treatment

As illustrated in FIGS. 55A and 55B, the concentration of cobalt in the treated overflow (after lime treatment) is significantly lower than the cobalt concentration in the treated water with the PMAP reagent. However, the residual cobalt concentration in the overflow following lime treatment after injecting 2.5 g/L of the PMAP reagent (0.603 mg/L) is lower than the similar concentration observed after injecting 20 g/L of the PMAP reagent (1.5 mg/L). This could indicate the negative impact of excessive PMAP reagent on the overall performance of the two-stage treatment process. Although the concentration difference between the two tests is small, it could be critical for water discharge into the environment and meeting discharge requirements.

### Solid Phase

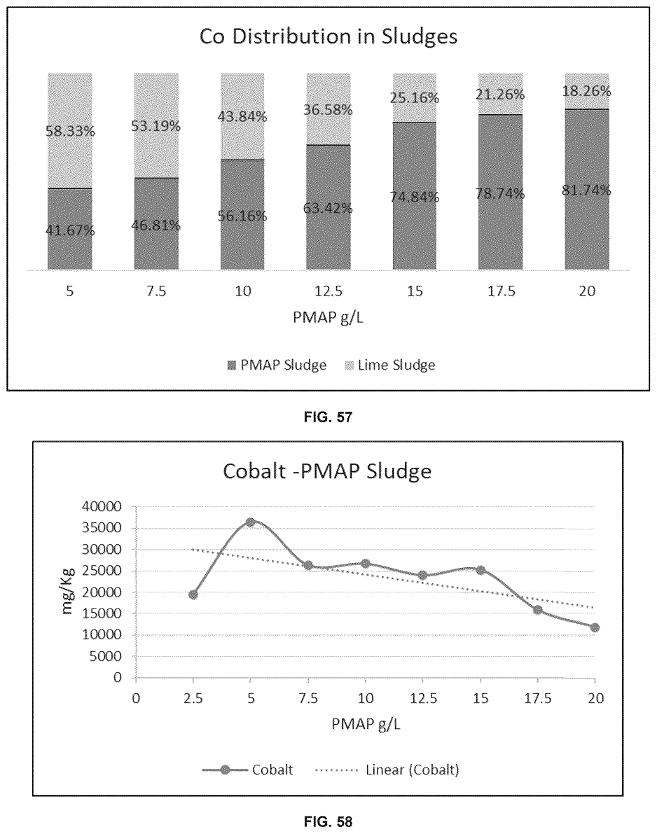

Since the liquid analytical data indicated that a minimum of 99% of the existing cobalt in the water was removed through the combined PMAP process and lime neutralization, it was expected to observe the total mass of cobalt in the solid phases. FIG. 57 illustrates the distribution of cobalt between PMAP sludge and lime sludge at different dosages of the PMAP reagent. In the case of cobalt, both the concentration of cobalt and the volume of sludge generated by lime treatment decreased with an increase in the dosage of the injected PMAP reagent during the pre-treatment step. Consequently, the percentage of the total mass of cobalt in the lime sludge declined due to the cobalt removal efficiency by the PMAP reagent and the low volume of sludge generated by lime treatment.

### (a) Pretreatment Sludge

The precipitated cobalt in the generated sludge by the PMAP process accounts for a minimum of 1.9% of the composition of the generated sludge at 2.5 g/L PMAP reagent. However, with an increase in the dosage of injected PMAP reagent, the percentage of cobalt shows a maximum of 3.64% at 5 g/L of the PMAP reagent before starting to decline. Considering the change in cobalt removal efficiency with the increasing dosage of PMAP reagent, it can be interpreted that the additional PMAP reagent enhances the removal efficiency while the unused reagent dilutes the concentration of cobalt in the generated sludge from the PMAP process. These two phenomena lead to a maximum cobalt concentration in the PMAP sludge before the dilution occurs due to an unutilized PMAP reagent.

The change in cobalt concentration in the PMAP sludge with varying dosages of injected reagent is illustrated in FIG. 58. Despite the increase in cobalt removal efficiency from the liquid phase in the PMAP process, the concentration of cobalt in the PMAP sludge decreases with an increase in the PMAP dosage. This decline in cobalt concentration is mainly due to the excessive volume of the PMAP sludge caused by unutilized PMAP reagents.

### (b) Lime Sludge

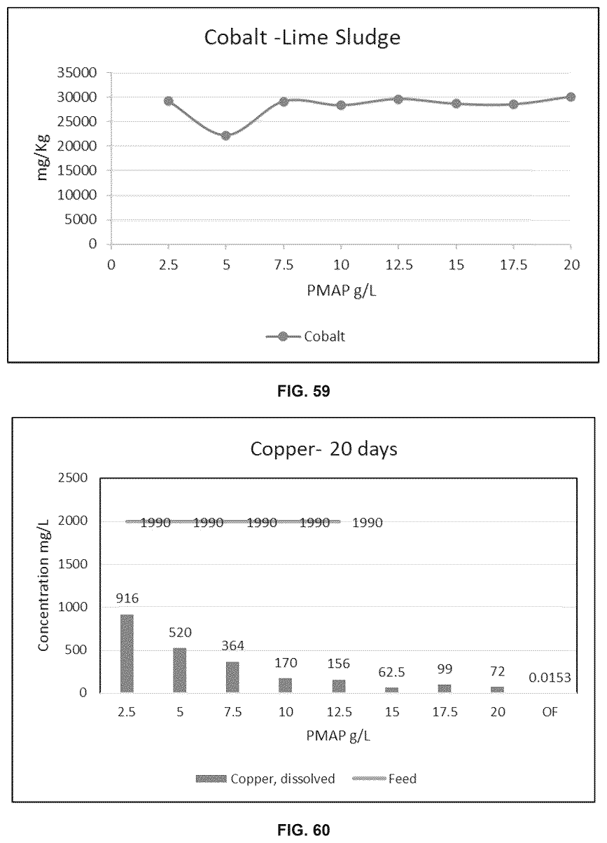

The precipitated cobalt in the generated sludge by the lime neutralization process constitutes approximately 2% to 3% of the composition of the generated sludge. The change in cobalt concentration in the lime sludge with varying dosages of injected PMAP reagent is illustrated in FIG. 59. The cobalt concentration (and percentage) in the lime sludge remains almost unaffected by the dosage of the injected PMAP reagent during the pre-treatment stage. However, despite the consistent concentration of cobalt in the lime sludge, the overall mass of collected cobalt in the lime process decreases as the PMAP dosage is increased in the pre-treatment stage due to the reduction in the volume of the lime sludge.

### Copper

### Liquid Phase

### (a) Effect of Pretreatment Reagent Quantity

FIG. 60 illustrates the concentrations of copper in the liquid phase after 20 days at different PMAP dosages. The copper concentration in the feed was reduced from 1990 mg/L to a range between 916 mg/L and 72 mg/L for different PMAP dosages. In the test with 2.5 g/L of PMAP reagent, the final copper concentration was reduced to 916 mg/L, indicating a 54% copper removal efficiency. Meanwhile, the removal efficiency for the solution with 20 g/L of PMAP reagent was 96%. These results revealed that more copper could be precipitated in the PMAP process when a high dosage of the PMAP reagent was used.

### (b) Effect of Pretreatment Duration

FIG. 61 illustrates the copper concentration over time in the tests with 2.5 g/L (FIG. 61A) and 20 g/L (FIG. 61B) of PMAP reagent. In the left graph, the copper concentration dropped from 1430 mg/L to 916 mg/L over time when only 2.5 g/L of the PMAP formula was used. This indicates that the concentration of copper in the water (and subsequently in the sludge) could be controlled by injecting a small dosage of PMAP reagent and managing the reaction time. On the other hand, quick removal of copper in a short period is possible by adding a sufficient amount of PMAP reagent at the beginning of the process. In the case of high-dosage injection, the reaction time would have less impact on the concentration of copper in the treated water.

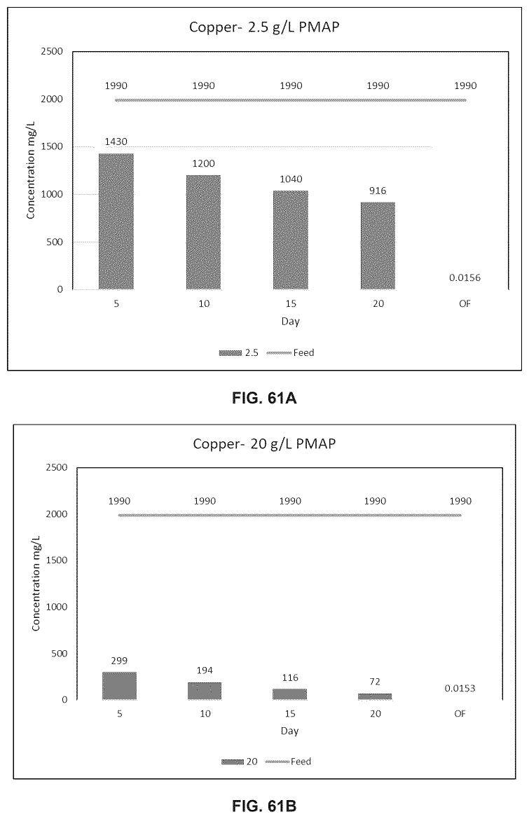

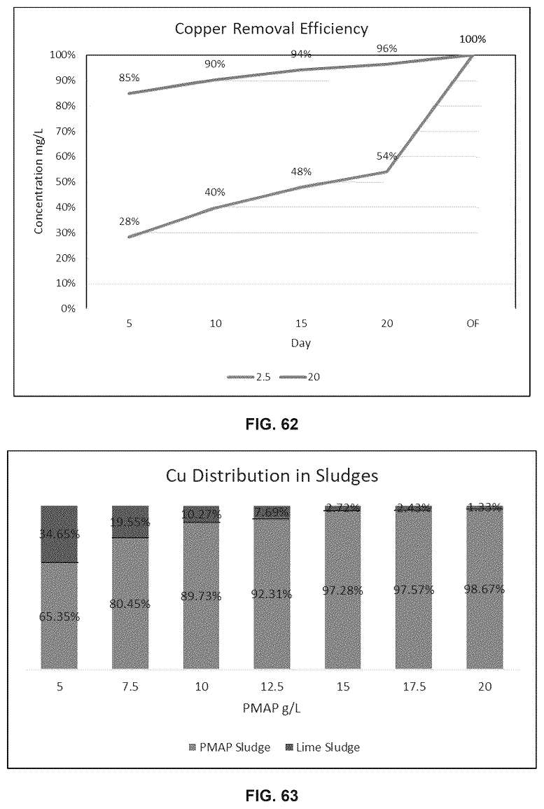

FIG. 62 illustrates the removal efficiency of copper with 2.5 g/L and 20 g/L of PMAP formula. These numbers are used as lower and upper boundaries in the conducted test, but similar curves could be produced by other dosages of the PMAP reagent. As presented, the removal efficiency of copper increased from 28% to 54% over time when 2.5 g/L of the PMAP reagent was used. Meanwhile, the copper removal efficiency increased from 85% to 96% when 20 g/L of the reagent was used.

### (c) Effect of Overflow Treatment

As presented in FIG. 61A and FIG. 61B, the concentration of copper in the treated overflow was significantly lower than the copper concentration in the treated water with the PMAP reagent. The concentrations of residual copper in the overflow after injecting 2.5 g/L of the PMAP reagent and after injecting 20 g/L of the PMAP reagent were identical. This means that regardless of the concentration of copper in the feed water, the lime treatment at pH 9 could efficiently remove copper from the overflow.

### Solid Phase

Since the liquid analytical data showed that a minimum of 99% of the existing copper in the water was removed by a combination of the PMAP process and lime neutralization, it was expected to observe the total mass of copper in the solid phases. FIG. 63 illustrates the copper distribution between PMAP sludge and lime sludge at different dosages of the PMAP reagent. In the case of copper, both the concentrations of copper and the volume of generated sludge by lime treatment declined by increasing the dosage of the injected PMAP at the pre-treatment step. Therefore, the percentage of the total mass of copper in the lime sludge declined with increasing the copper removal efficiency by PMAP and the low volume of generated sludge by lime treatment. Thus, by selecting the dosage of PMAP reagent, copper could be collected in the lime sludge (e.g. 2.5 g/L PMAP) or in the PMAP sludge (e.g. <10 g/L PMAP).

### (a) Pretreatment Sludge

The precipitated copper in the generated sludge by the PMAP process forms a minimum of 10% of the composition of the generated sludge at 2.5 g/L PMAP reagent. However, by increasing the dosage of the injected PMAP reagent, the percentage of copper showed a decline from 10% to 4.16% when using 20 g/L of the PMAP reagent. Considering the change in the removal efficiency of copper by increasing the injected PMAP reagent, it could be interpreted that the additional PMAP reagent increased the removal efficiency, while the unused reagent diluted the concentration of copper in the generated sludge by the PMAP process.

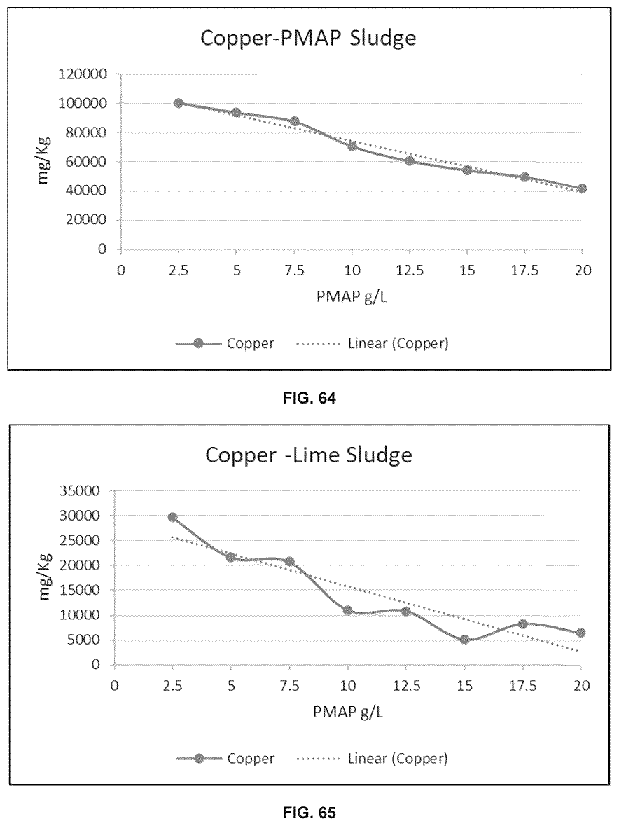

The change in copper concentration in the PMAP sludge by the dosage of the injected reagent is illustrated in FIG. 64. Despite the increase in copper removal efficiency from the liquid phase in the PMAP process, the concentration of copper in the PMAP sludge declined with the increasing PMAP dosage. The decline in the copper concentration with the PMAP dosage is mainly due to the excessive volume of the PMAP sludge caused by the unutilized PMAP reagent.

### (b) Lime Sludge

The precipitated copper in the generated sludge by the lime neutralization process forms 2.97% to 0.64% of the composition of the generated sludge.

The change in copper concentration in the lime sludge by the dosage of the injected PMAP reagent is illustrated in FIG. 65. The copper concentration (and percentage) in lime sludge declined with increases in the dosage of the injected PMAP reagent at the pre-treatment stage. The higher dosage of the PMAP reagent improved copper removal efficiency in the pre-treatment and reduced the concentration of the residual copper in the overflow. As a result, the concentration of precipitated copper in the lime sludge declined with the increase in the dosage of the injected PMAP reagent.

### Iron

### Liquid Phase

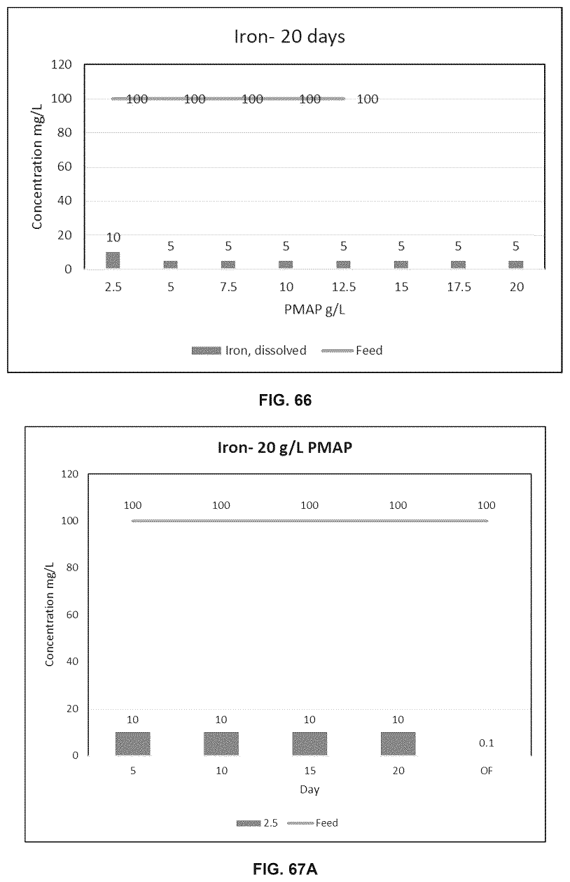

FIG. 66 illustrates the concentrations of iron in the liquid phase after 20 days at different PMAP dosages. The iron concentration in the feed was reduced from 100 mg/L to a number between 10 mg/L and less than 5 mg/L (detection limit) for different dosages of the PMAP.

The test with 2.5 g/L of PMAP reagent resulted in a final iron concentration of 10 mg/L, indicating 90% iron removal efficiency. The removal efficiency for the solution with 20 g/L of PMAP reagent was at a minimum of 95%. These results revealed that more iron may be precipitated in the PMAP process when a high dosage of the PMAP reagent is injected.

### (b) Effect of Treatment Duration

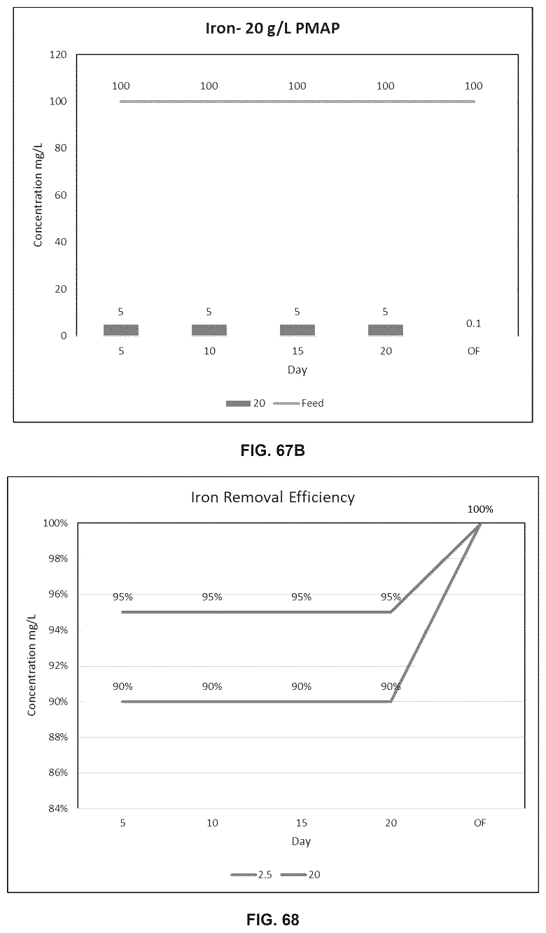

FIG. 67 illustrates the iron concentration in the test with 2.5 g/L (FIG. 67A) and 20 g/L (FIG. 67B) PMAP reagent over time. In FIG. 67A, the concentration of iron dropped from 100 mg/L to 10 mg/L over time when only 2.5 g/L of PMAP formula was used. This indicates that the concentration of iron in the water (and subsequently in the sludge) could be controlled by injecting a small dosage of PMAP reagent and managing the reaction time. On the other hand, quick removal of the iron in a short period is possible by adding a sufficient amount of PMAP reagent at the beginning of the process. In the case of high-dosage injection, the reaction time would have less impact on the concentration of iron in the treated water.

FIG. 68 illustrates the removal efficiency of iron with 2.5 g/L and 20 g/L of PMAP formula. These numbers are used as lower and upper boundaries in the conducted test, and similar curves could be produced by other dosages of the used PMAP reagent in the test. Due to the detection limit restraints, it is not possible to see the change in the removal efficiency over time since all reported concentrations are less than the detection limits.

### (c) Effect of Overflow Treatment

As presented in FIGS. 67A and 67B, the concentration of iron in the treated overflow was significantly lower than the iron concentration in the treated water with the PMAP reagent. The concentrations of residual iron in the overflow after injecting 2.5 g/L of the PMAP reagent and after injecting 20 g/L of the PMAP reagent were identical. This means that regardless of the concentration of iron in the feed water, the lime treatment at pH 9 could efficiently remove the iron from the overflow.

### Solid Phase

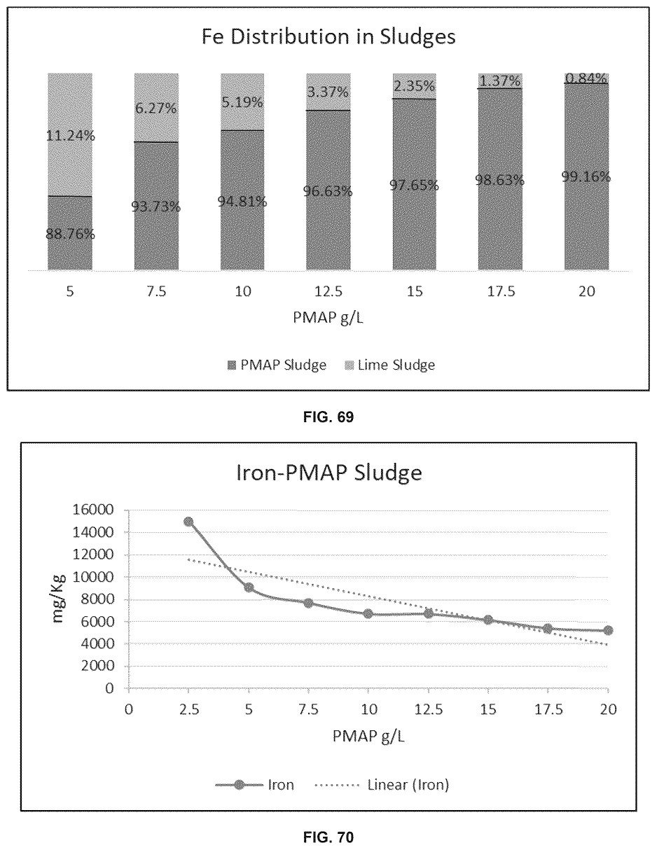

Since the liquid analytical data showed that a minimum of 99% of the existing iron in the water was removed by a combination of the PMAP process and lime neutralization, it was expected to observe the total mass of the iron in the solid phases. FIG. 69 illustrates the iron distribution between PMAP sludge and lime sludge at different dosages of the PMAP reagent. In the case of iron, both the concentrations of the iron and the volume of generated sludge by lime treatment declined by increasing the dosage of the injected PMAP at the pre-treatment step. Therefore, the percentage of the total mass of iron in the lime sludge declined due to both the iron removal efficiency by PMAP and the low volume of generated sludge by lime treatment.

### (a) Pretreatment Sludge

The precipitated iron in the generated sludge by the PMAP process forms a minimum of 1.5% of the composition of the generated sludge at 2.5 g/L PMAP reagent. However, by increasing the dosage of the injected PMAP reagent, the percentage of iron showed a decline from 1.5% to 0.52% when using 20 g/L of the PMAP reagent. Considering the change in the removal efficiency of the iron by increasing the injected PMAP reagent, it could be interpreted that the additional PMAP reagent increased the removal efficiency, while the unused reagent diluted the concentration of the iron in the generated sludge by the PMAP process.

The change in iron concentration in the PMAP sludge by the dosage of the injected reagent is illustrated in FIG. 70. Despite the ascent of iron removal efficiency from the liquid phase in the PMAP process, the concentration of iron in the PMAP sludge declined by increasing the PMAP dosage. The decline in the iron concentration by the increase in the PMAP dosage is mainly due to the excessive volume of the PMAP sludge caused by the unutilized PMAP reagent.

### (b) Lime Sludge

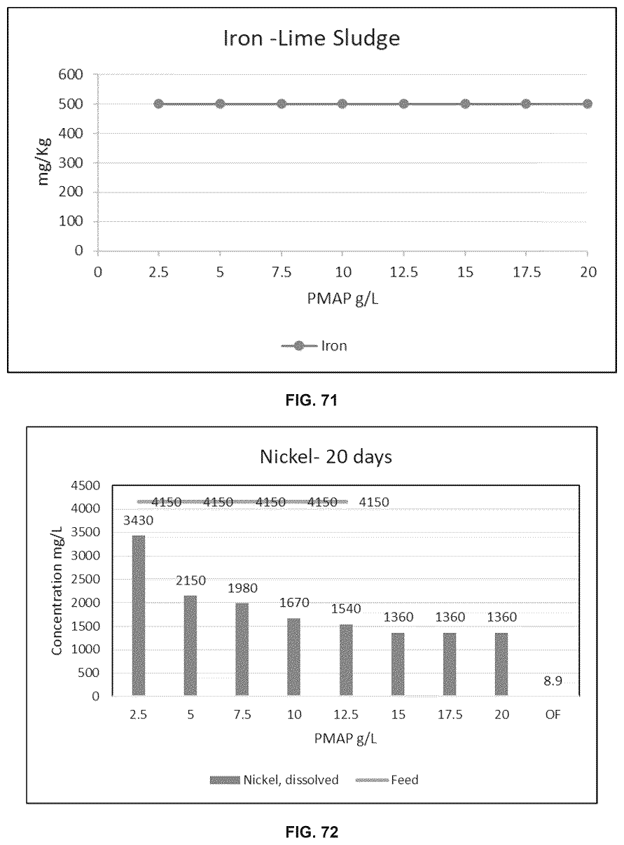

The precipitated iron in the generated sludge by the lime neutralization process remains constant at 0.05% of the composition of the generated sludge. The change in iron concentration in the lime sludge by the dosage of the injected PMAP reagent is illustrated in FIG. 71. The iron concentration (and percentage) in lime sludge remains constant with increases in the dosage of the injected PMAP reagent at the pre-treatment stage. This constant number is due to the detection limit's restrictions; therefore, making any conclusions about the iron percentage in the lime sludge was not possible.

### Nickel

### Liquid Phase

### (a) Effect of Pretreatment Quantity

FIG. 72 illustrates the concentrations of nickel in the liquid phase after 20 days at different PMAP dosages. The nickel concentration in the feed was reduced from 4150 mg/L to a range between 3430 mg/L and 1360 mg/L for different dosages of the PMAP.

### (b) Effect of Pretreatment Duration

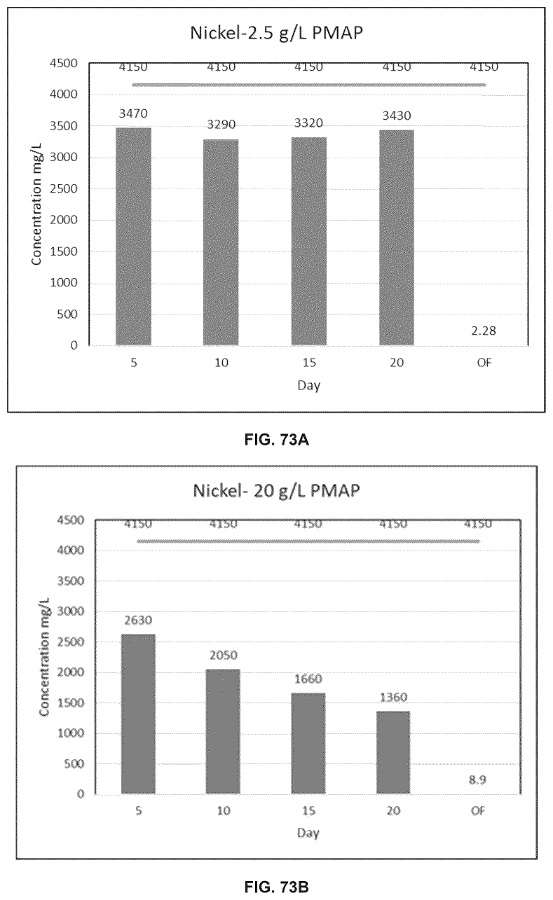

FIG. 73 illustrates the nickel concentration in the test with 2.5 g/L (FIG. 73A) and 20 g/L (FIG. 73B) PMAP reagent over time. In FIG. 73A, the concentration of nickel dropped from 4150 mg/L to 3470 mg/L over time when only 2.5 g/L of PMAP formula was used. On the other hand, quick removal of nickel within a short period was possible by adding a sufficient amount of PMAP reagent at the beginning of the process. In the case of high-dosage injection, the reaction time has a tangible impact on the concentration of nickel in the treated water.

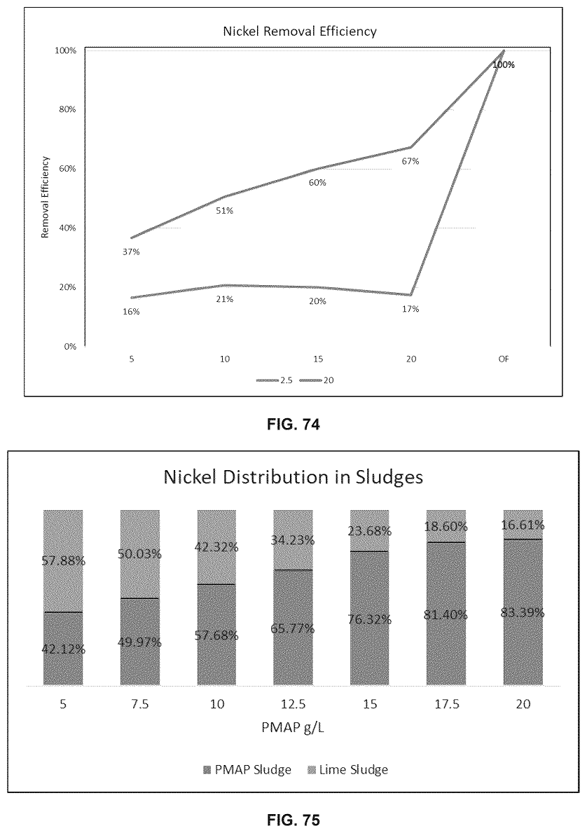

FIG. 74 illustrates the removal efficiency of nickel with 2.5 g/L and 20 g/L of the PMAP formula. These values serve as lower and upper boundaries in the conducted test, and similar curves could be obtained with other dosages of the PMAP reagent. As shown, the removal efficiency of nickel (16%) did not change significantly over time when using 2.5 g/L of the PMAP reagent, while the nickel removal efficiency increased from 17% to 67% when 20 g/L of the reagent was used.

### (c) Effect of Overflow Treatment

As shown in FIGS. 73A and 73B, the concentration of nickel in the treated overflow was significantly lower than the nickel concentration in the treated water with the PMAP reagent. The concentration of residual nickel in the overflow after injecting 2.5 g/L of the PMAP reagent was 2.28 mg/L, and after injecting 20 g/L of the PMAP reagent, it was 8.9 mg/L. This means that regardless of the initial concentration of nickel in the feed water, the lime treatment at pH 9 efficiently removes nickel from the overflow.

### Solid Phase

Since the liquid analytical data showed that at least 99% of the existing nickel in the water was removed by a combination of the PMAP process and lime neutralization, it was expected to observe the total mass of nickel in the solid phases. FIG. 75 illustrates the nickel distribution between PMAP sludge and lime sludge at different dosages of the PMAP reagent. In the case of nickel, both the nickel concentrations and the volume of generated sludge by lime treatment declined with increasing dosage of the injected PMAP at the pre-treatment step. Therefore, the percentage of the total mass of nickel in the lime sludge declined due to both the nickel removal efficiency by PMAP and the low volume of generated sludge by lime treatment. Thus, by selecting the dosage of PMAP reagent, nickel could be collected in the lime sludge (e.g. 2.5 g/L PMAP) or in the PMAP sludge (e.g. <10 g/L PMAP).

### (a) Pretreatment Sludge

The precipitated nickel in the generated sludge by the PMAP process constituted a minimum of 9.21% of the composition of the generated sludge at 2.5 g/L PMAP reagent. However, as the dosage of the injected PMAP reagent increased to 20 g/L, the percentage of nickel decreased from 9.21% to 5.19%. This decline is attributed to the dilution of the nickel concentration in the generated sludge by the PMAP process due to the excessive volume of unused PMAP reagent.

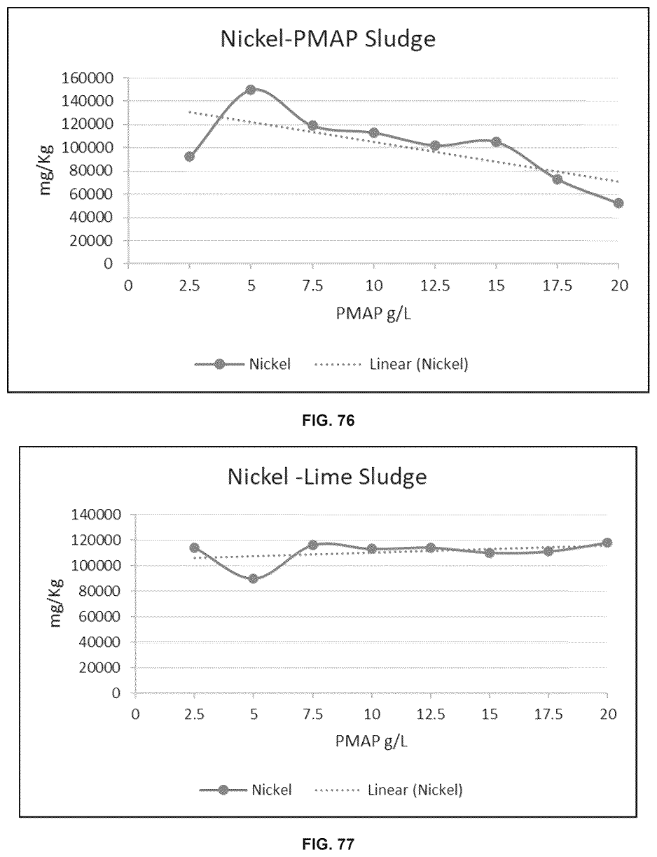

The change in nickel concentration in the PMAP sludge with varying dosages of injected PMAP reagent is illustrated in FIG. 76. Despite the increase in nickel removal efficiency from the liquid phase in the PMAP process, the concentration of nickel in the PMAP sludge, after reaching a peak, declined with higher PMAP dosages. This decline is mainly due to the excessive volume of PMAP sludge caused by the unutilized PMAP reagent.

### (b) Lime Sludge

The precipitated nickel in the generated sludge by the lime neutralization process constituted 11.8% to 8.98% of the composition of the generated sludge.

The change in nickel concentration in the lime sludge with varying dosages of injected PMAP reagent is illustrated in FIG. 77. The nickel concentration (and percentage) in the lime sludge remains almost constant with increasing dosages of the injected PMAP reagent at the pre-treatment stage, except for 5 g/L of injected PMAP. The higher dosage of the PMAP reagent improves nickel removal efficiency in the pre-treatment stage and reduces the concentration of residual nickel in the overflow. As a result, the concentration of precipitated nickel in the lime sludge decreases with an increase in the dosage of the injected PMAP reagent. However, the decrease in the volume of lime sludge compensates for the lower concentration of nickel, and the percentage of nickel in the lime sludge remains the same.

### Magnesium

### Liquid Phase

Magnesium was included in the PMAP formula as magnesium oxide, which converted to magnesium hydroxide in the solution, releasing hydroxide ions. These hydroxide ions reacted with heavy metals in the water, forming insoluble metal hydroxides that precipitated out of the solution. The remaining magnesium in the liquid phase formed a chemical bond with existing sulphate in the water as magnesium sulphate, which is highly soluble. The concentration of magnesium ions released through the reaction between magnesium hydroxide and heavy metal sulphates could be observed in the liquid phase. Therefore, changes in magnesium concentration after adding the PMAP reagent can be used as an indicator of magnesium oxide utilization in the PMAP formula.

### (a) Effect of Pretreatment Reagent Quantity

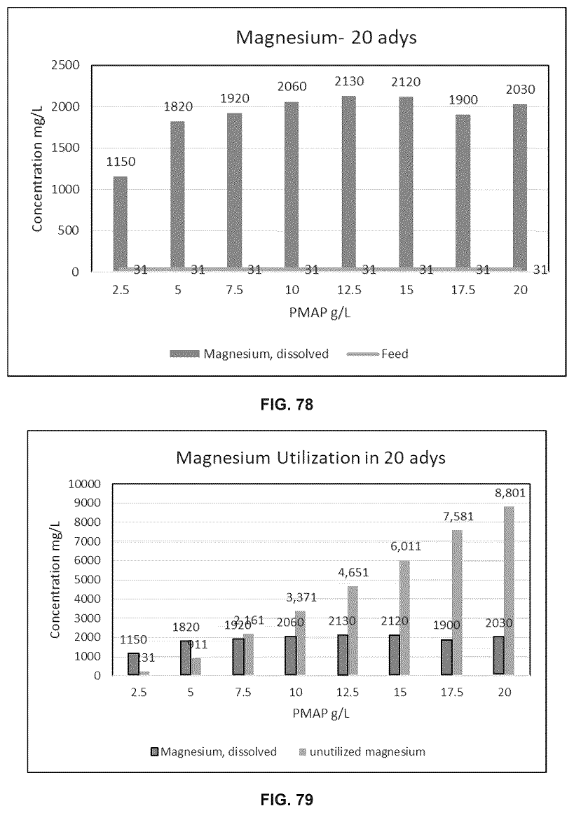

FIG. 78 presents the concentrations of magnesium in the liquid phase after the 20-day PMAP process at different PMAP dosages. The magnesium concentration in the feed, which was 31 mg/L, increased to a range between 1150 mg/L and 2030 mg/L for different dosages of the PMAP reagent.

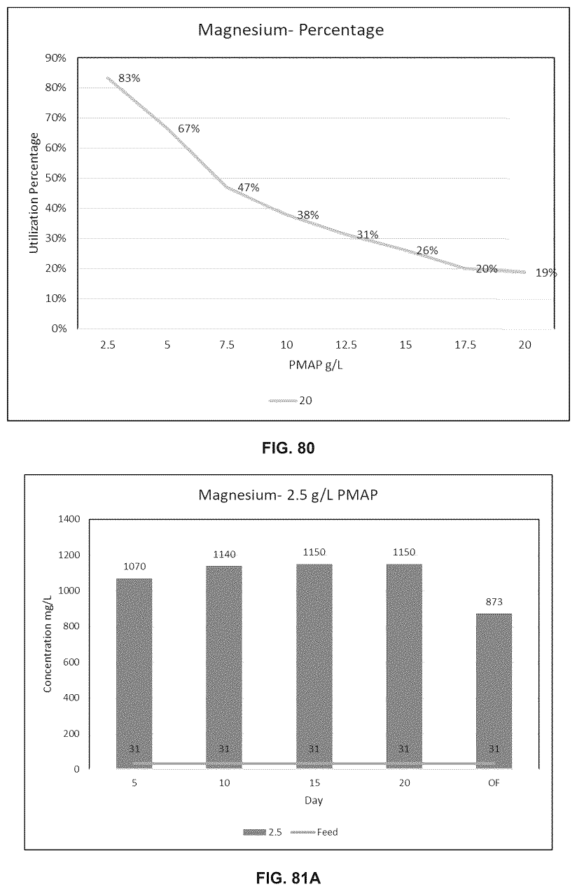

The relatively small change in the concentration of dissolved magnesium in the treated water (880 mg/L) compared to the amount of added magnesium through the PMAP reagent (9,450 mg/L) indicates that a significant amount of magnesium at higher dosages of PMAP injection was not utilized for the metal precipitation process. FIG. 79 illustrates the utilized and unutilized magnesium at different dosages of PMAP injection after 20 days. FIG. 80 presents the utilization percentage of magnesium at the end of the 20-day PMAP process at different dosages. The decline in magnesium utilization emphasizes that using a high amount of the PMAP reagent at the beginning of the process may not be the most efficient approach, and stagewise injection of the reagent could improve its utilization.

### (b) Effect of Pretreatment Duration

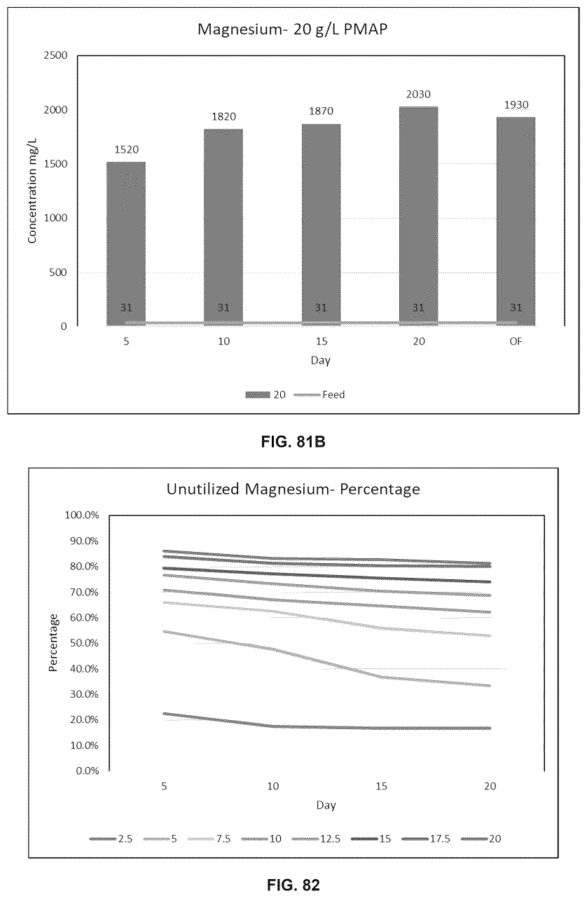

FIG. 81 illustrates the change in magnesium concentration over time in tests with 2.5 g/L (FIG. 81A) and 20 g/L (FIG. 81B) of the PMAP reagent. In the test with 2.5 g/L of PMAP, the concentration of magnesium increased from 1070 mg/L to 1150 mg/L over time, indicating that the concentration remained relatively constant, and the utilization of the PMAP reagent did not improve over time. In contrast, when using 20 g/L of the PMAP reagent, the concentration of magnesium increased from 1520 mg/L to 2030 mg/L over time, representing approximately a 33% increase in PMAP reagent utilization. However, achieving this additional utilization required an eight-fold increase in PMAP reagent consumption.

FIG. 82 illustrates the percentage of unutilized magnesium over time with different dosages of the PMAP reagent. While small dosages of the PMAP reagent showed marginal improvement in utilization, the percentage of unutilized magnesium remained almost constant over time for higher dosages.

### (c) Effect of Overflow Treatment

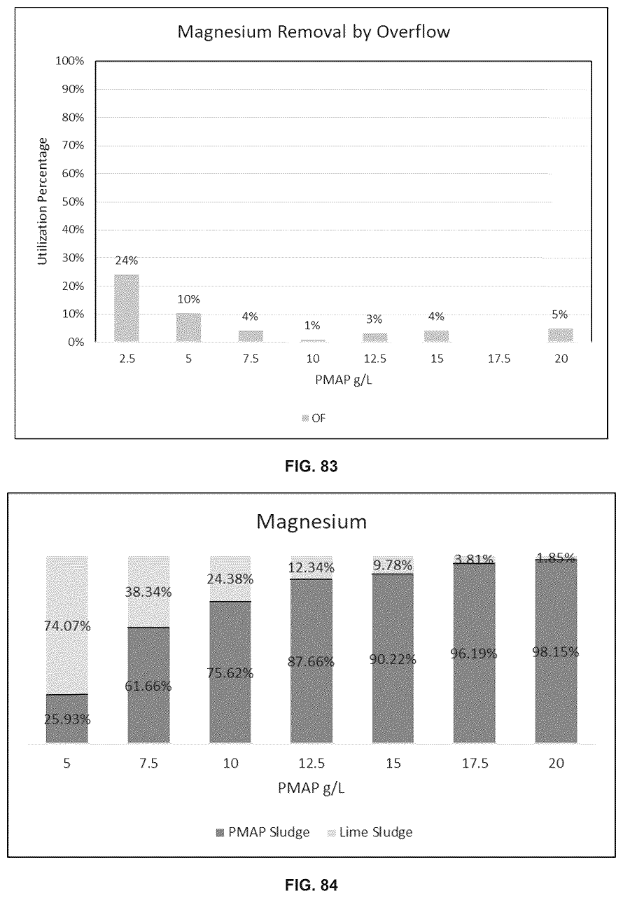

FIG. 83 illustrates the percentage of magnesium removal from the overflow of the PMAP treatment at different dosages of the reagent. In general, lime treatment did not have a significant impact on reducing the magnesium concentration in the overflow. If the concentration of magnesium in the treated water is a concern, using lime treatment alone cannot be considered a viable option, and an additional polishing process would be required.

### Solid Phase

Since the liquid analytical data showed minimal changes in the concentration of dissolved magnesium in the tests with different dosages of the PMAP, a high percentage of magnesium in the sludge generated by the PMAP reagent was expected. FIG. 84 illustrates the distribution of magnesium between PMAP sludge and lime sludge at different dosages of the PMAP reagent. Except for the test with 2.5 g/L of PMAP, the majority of the magnesium in the PMAP reagent settled in the PMAP sludge, and the percentage of settled magnesium increased with higher usage of the PMAP reagent.

### (a) Pretreatment Sludge

The precipitated magnesium in the generated sludge by the PMAP process constituted a minimum of 2.14% of the composition of the generated sludge at 2.5 g/L PMAP reagent. However, with an increased dosage of injected PMAP to 20 g/L, the percentage of magnesium significantly increased from 2.14% to 24.3%. This significant change indicates that increasing the injected PMAP reagent does not result in better utilization of magnesium in the reaction. The excessive magnesium in the PMAP reagent transfers to the sludge as unutilized magnesium, diluting the concentration of valuable metals in the PMAP sludge.

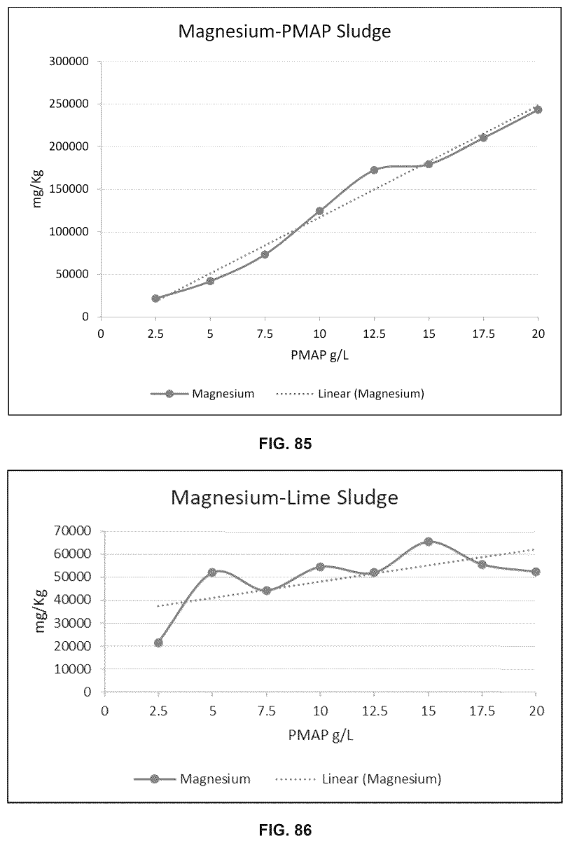

The change in magnesium concentration in the PMAP sludge with varying dosages of injected reagent is illustrated in FIG. 85. The concentration of magnesium in the PMAP sludge increased from 21,400 to 243,000 mg/Kg, indicating a significant increase in unutilized magnesium. This unutilized magnesium could also be one of the main reasons for the additional volume of the sludge at higher dosages of the PMAP.

### (b) Lime Sludge

The precipitated magnesium in the generated sludge by the lime neutralization process constituted 2.14% of the composition of the generated sludge.

The change in magnesium concentration in the lime sludge with varying dosages of injected PMAP reagent is illustrated in FIG. 86. The magnesium concentration (and percentage) in the lime sludge showed minor fluctuations compared to the PMAP sludge with increasing dosages of the injected PMAP at the pre-treatment stage. However, a higher dosage of the PMAP reagent increased the concentration of magnesium in the lime sludge by 100%. This change could be partially attributed to the reduction in the use of lime and the volume of the generated sludge by the lime treatment.

### Conclusion

The conducted tests revealed a wide range of possibilities achievable by combining the PMAP reagent as a pretreatment method and lime neutralization as an existing treatment approach. The results demonstrated that the utilization of the PMAP reagent could yield positive effects on lime consumption, sludge generation rate, and overall reagent consumption. Although it was found that the reduction in lime consumption exhibited a linear correlation with the dosage of the PMAP reagent, the reduction in lime consumption did not directly correspond to the overall reagent consumption, as beyond a certain point, despite the lower lime consumption, the overall reagent consumption would become significantly higher.

The results have confirmed that the application of the PMAP reagent as a pretreatment before existing lime treatment offers a wide range of options and additional benefits for the overall treatment process, regardless of the types of contaminants of concern. In particular, the use of the PMAP reagent as a pretreatment demonstrated tangible positive effects on the concentration of metals, while also providing opportunities to collect a high percentage of the selected metals in the desired sludge. Two key parameters, namely the quantity of the injected PMAP reagent and the reaction time, were investigated to assess the feasibility of collecting the target metals in the desired sludge. The metals examined in this study (aluminum, arsenic, cadmium, cobalt, chromium, copper, and nickel) can be grouped into three major categories: a) metals that precipitated in the pretreatment sludge regardless of the quantity and reaction time, b) metals that precipitated in the lime sludge regardless of the quantity and reaction time, and c) metals where distribution in the sludges can be controlled by adjusting the quantity of the reagent or the duration of the reaction.

The test results revealed that a significant portion of metals, such as aluminum and arsenic, will precipitate in the sludge generated during the pretreatment process. These metals belong to group a) and will be effectively removed from the lime sludge through the use of the pretreatment technology as described herein. Contrarily, a significant amount of cobalt precipitated in the lime sludge, and increasing the dosage of the injected neutralization reagent or prolonging the pretreatment duration did not enhance the cobalt concentration in the sludge generated during the process. Regarding the metals in group c), their concentration can be controlled by adjusting the quantity of PMAP reagent, with or without considering the duration of the reaction. For instance, a small dosage of the PMAP reagent was found to effectively capture the majority of cadmium in the lime sludge within a short period. Conversely, a high dosage of the PMAP reagent, combined with an extended reaction time, was found to lead to a significant portion of cadmium being collected in the pretreatment sludge. This type of behavior was observed for several metals such as copper, nickel, and zinc.

Furthermore, it was observed that the unused PMAP reagent during the pretreatment may affect both the volume of the resulting sludge and the concentration of valuable metals within it. On the other hand, the dosage of the PMAP reagent appeared to have no or limited impact on the concentration of valuable metals in the lime sludge. Consequently, a suitable treatment strategy taking into account factors such as feed water quality, treatment objectives, and stakeholder preferences may be chosen, by determining dosage, reaction durations, injection procedure and frequency.

As used herein, the terms “comprising,” “having,” “including” and “containing,” and grammatical variations thereof, are inclusive or open-ended and do not exclude additional, un-recited elements and/or method steps. The term “consisting essentially of” when used herein in connection with a use or method, denotes that additional elements and/or method steps may be present, but that these additions do not materially affect the manner in which the recited method or use functions. The term “consisting of” when used herein in connection with a use or method, excludes the presence of additional elements and/or method steps. A use or method described herein as comprising certain elements and/or steps may also, in certain embodiments consist essentially of those elements and/or steps, and in other embodiments consist of those elements and/or steps, whether or not these embodiments are specifically referred to. In addition, the use of the singular includes the plural, and “or” means “and/or” unless otherwise stated. The term “plurality” as used herein means more than one, for example, two or more, three or more, four or more, and the like. Unless otherwise defined herein, all technical and scientific terms used herein have the same meaning as commonly understood by one of ordinary skill in the art. As used herein, the term “about” refers to an approximately +/−10% variation from a given value. It is to be understood that such a variation is always included in any given value provided herein, whether or not it is specifically referred to. The use of the word “a” or “an” when used herein in conjunction with the term “comprising” may mean “one,” but it is also consistent with the meaning of “one or more,” “at least one” and “one or more than one”.

The present invention has been described with regard to one or more embodiments. However, it will be apparent to persons skilled in the art that a number of variations and modifications can be made without departing from the scope of the invention as defined in the claims. The scope of the claims should not be limited by the preferred embodiments set forth in the examples, but should be given the broadest interpretation consistent with the description as a whole.

What is claimed is:

1. A solid formulation for neutralizing an acidic tailings pond, the formulation comprising at least 55 wt % magnesium oxide (MgO) and at least 0.5 wt % chitosan salt.

2. The formulation of claim 1, comprising:
between about 55 wt % to about 99.5 wt % MgO; and
between about 0.5 wt % to about 3 wt % chitosan salt;
wherein the balance is made up of one or more fillers, additives and/or additional neutralizing agents.

3. The solid formulation of claim 1 or claim 2, wherein the formulation further comprises between about 5 wt % to about 15 wt % of a carbonate salt.

4. The solid formulation of claim 2 or claim 3, wherein the additional neutralizing agent comprises calcium hydroxide (lime) and/or sodium hydroxide.

5. The solid formulation of any one of claims 2 to 4, wherein the one or more fillers comprises diatomaceous earth (diatomite).

6. The solid formulation of any one of claims 1 to 5, comprising:
about 99 wt % MgO; and
about 1 wt % chitosan salt.

7. The solid formulation of any one of claims 3 to 6, comprising:
about 90 wt % MgO;
about 9 wt % carbonate salt; and
about 1 wt % chitosan acetate.

8. The solid formulation of any one of claims 1 to 7, wherein the chitosan salt is chitosan lactate or chitosan acetate.

9. The solid formulation of any one of claims 3 to 8, wherein the carbonate salt comprises sodium carbonate, sodium bicarbonate, magnesium carbonate and/or potassium carbonate.

10. The solid formulation of claim 9, wherein the carbonate salt is sodium bicarbonate.

11. The solid formulation of any one of claims 1 to 10, wherein the formulation is in the form of a free powder, a compressed powder or a tablet or a ball.

12. A method of neutralizing water in a tailings pond, the method comprising:
(i) providing a solid formulation comprising at least 55 wt % magnesium oxide and at least 0.5 wt % of a chitosan salt,
(ii) mixing the solid formulation with a predetermined volume of water to form a suspension;
(iii) adding the suspension to the tailings pond; and
(iv) allowing neutralization to occur in the tailings pond.

13. The method of claim 12, wherein the starting pH of the tailings pond is 2.5 or less.

14. The method of claim 12 or 13, wherein the solid formulation in step (i) is the solid formulation as defined in any one of claims 1-11.

15. The method of any one of claims 12 to 14, wherein after the step of adding (iii), the concentration of MgO in the tailings pond is up to about 25 g/L and the concentration of chitosan salt is up to about 0.3 g/L.

16. The method of any one of claims 12 to 15, wherein the solid formulation further comprises at least 5% of a carbonate salt and wherein after the step of addition (iii), the concentration of the carbonate salt in the tailings pond is up to about 20 g/L.

17. The method of any one of claim 12 to 16, wherein the method does not comprise the steps of mixing, stirring, agitating or heating the tailings pond.

18. The method of any one of claims 12 to 17, wherein the suspension is a slurry.

19. The method of any one of claims 12 to 18, wherein the predetermined volume of water in step (ii) is water from the tailings pond.

20. The method of any one of claims 12 to 19, wherein step (iv) is a time period of at least 5 days.

21. The method of any one of claims 12 to 20, wherein the final pH of the tailings pond is about 6.5 or above.

22. The method of any one of claims 12 to 21, wherein the method steps (ii)-(iv) are carried out in situ at the tailings pond.

23. The method of any one of claims 12 to 22, further comprising:
(v) discharging the neutralized water from the tailings pond.

24. The method of claim 23, wherein step (v) is carried out by pumping or by gravitational discharge.

25. The method of any one of claims 12 to 24, further comprising:
(vi) recovering sludge from the bottom of the tailings pond.

26. The method of claim 25, wherein the sludge comprises one or more precipitated metals, wherein the one or more precipitated metals are selected from the group consisting of aluminum, arsenic, chromium, cobalt, manganese, nickel, copper and iron.

27. The method of any one of claims 12 to 26, wherein the method removes more than 80 wt % of one or more contaminant metals from the water, wherein the one or more contaminant metals are selected from the group consisting of aluminum, arsenic, chromium, cobalt, manganese, nickel, copper, and iron.

28. The method of any one of claims 12 to 27, wherein the method removes less than 20 wt % of sulphur from the water.

29. A method of neutralizing water in a tailings pond, the method comprising:
(a) a first neutralization stage comprising the method according to any one of claims 12 to 28 to provide a pre-treated water, wherein the solid formulation in part (i) is a first neutralization reagent; followed by
(b) a second neutralization stage comprising adding a second neutralization reagent to the pre-treated water and allowing neutralization to occur to provide a final treated water.

30. The method of claim 29, wherein the dosage of the first neutralization reagent is up to 20 g/L.

31. The method of claim 29 or 30, wherein the second neutralization reagent comprises lime.

32. The method of any one of claims 29 to 31, wherein the dosage of the second neutralization agent is between about 1 g/L and about 15 g/L or between about 2.5 g/L and about 9 g/L.

33. The method of any one of claims 29 to 32, wherein a first sludge is generated in the first neutralization stage and a second sludge is generated in the second neutralization stage.

34. A method of selectively precipitating one or more metals dissolved in water in a tailings pond, the method comprising:
(a) a first neutralization stage comprising the method according to any one of claims 12 to 28 to provide a pre-treated water, wherein the solid formulation in part (i) is a first neutralization reagent; followed by
(b) a second neutralization stage comprising adding a second neutralization reagent to the pre-treated water and allowing neutralization to occur to provide a final treated water,
wherein the quantity of the first neutralization reagent is selected to selectively precipitate the one or more dissolved metals into a first sludge generated in the first neutralization stage or a second sludge generated in the second neutralization stage.

35. The method of claim 34, wherein the second neutralization reagent comprises lime.
